(19) United States
(12) Patent Application Publication
(10) Pub. No.: US 2003/0001816 A1
(43) Pub. Date: Jan. 2, 2003

(54) Display and manoeuvring system and method

(76) Inventor: Ziad Badarneh, Oslo (NO)

Correspondence Address: Rodman & Rodman, 7 South Broadway, White Plains, NY, 10601, US

(21) Appl. No.: 10/149,097

(22) PCT Filed: Dec. 5, 2000
(86) PCT No.: PCT/NO00/00412

(30) Foreign Application Priority Data
Dec. 6, 1999 (NO) 19996001
Sep. 1, 2000 (NO) 20004375

(51) Int. Cl. G09G 5/00

(52) U.S. Cl. 345/156; 345/863

(57) ABSTRACT

A system and method for displaying and assisting manipulative movements when operating an operating device for a piece of functional equipment, for example, a telephone, a mobile telephone, a remote control unit, a text and/or character transmitter, a calculator, an electronic planner, a portable, hand-held or stationary computer (e.g., PC or mini-PC), a music center, a camera, game equipment, alarm equipment, admission control equipment, control equipment or the like, where the operating device is actuatable by an operator's finger to execute at least two function commands. Displayed on the display panel are at least three discrete fields and/or sub-fields of selectively optional functions and/or designation and/or characters, the operating device thus being able to actuate at least three options. At least one further manipulation of the operating device will cause at least one successive selection to be made on the basis of or starting from a preceding selection of said functions and/or designations and/or characters. The selections made are displayed and used in or by the functional equipment.

The present invention relates to a system for displaying and assisting manipulative movements when operating an operating device for a piece of functional equipment, as disclosed in the preamble in the independent patent claims below.

Today's mobile telephones incorporate a great number of functions in addition to the usual telephone functions, and they are equipped with a memory like that of small computers. This means that a user can build up information, for example, telephone numbers and address lists. Technological advance has reached mobile telephones which are being developed as complete communicators for text, pictures and speech by using, among things, the Internet as used on a personal computer (PC). A new format for this application is called WAP and is a standard for Internet services used on GSM telephones. All these new services and functions will require simpler, logical and efficient methods for handling all the information, entering data and navigation.

To illustrate the prior art reference is made to U.S. Pat. Nos. 5,808,602, 6,016,142 and 6,031,471.

The present invention has been developed for use in various electronic apparatus, preferably mobile telephones, to allow simple, logical, reliable and efficient operation of the apparatus through functions and menus, and also in simple operations, as may be required, for example, when operating a mobile telephone to dial a number.

The invention described will be programmable as software in hardware that is used today in computers and other electronic apparatus. Therefore, such programming is not described in detail, as anyone with a knowledge of such technology will understand how the invention can be implemented via software.

Although the following description will relate primarily to the use of the invention with mobile telephones, this should by no means be understood as limiting for the present invention, as it could just as easily be used with, for example, ordinary telephones, remote control units, text and/or character transmitters, calculators, electronic planners, portable, hand-held or stationary computer equipment (e.g., PCs, mini-PCs), music centres, cameras, games equipment, alarm equipment, admittance control equipment, control equipment or the like.

However, an essential feature of the invention is that the operating device should be actuatable by an operator's finger to be able to execute at least two function commands.

The characteristic features of the invention will be apparent from the patent claims below and also from the following description with reference to the attached drawings.

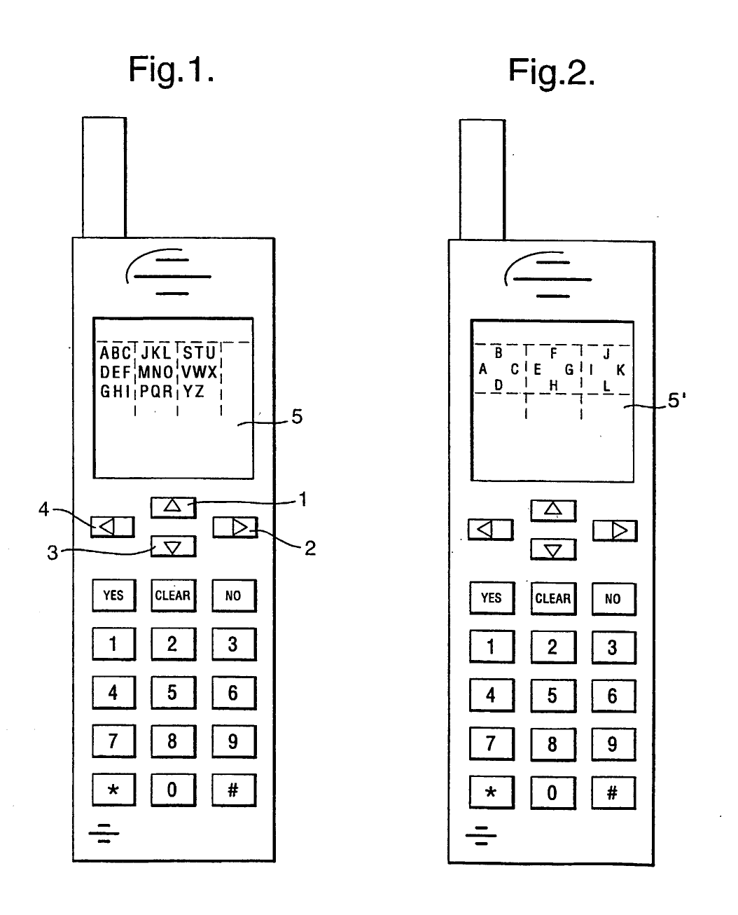

FIGS. 1 and 2 show typical known embodiments of mobile telephones with operating keys in the form of separate arrow keys.

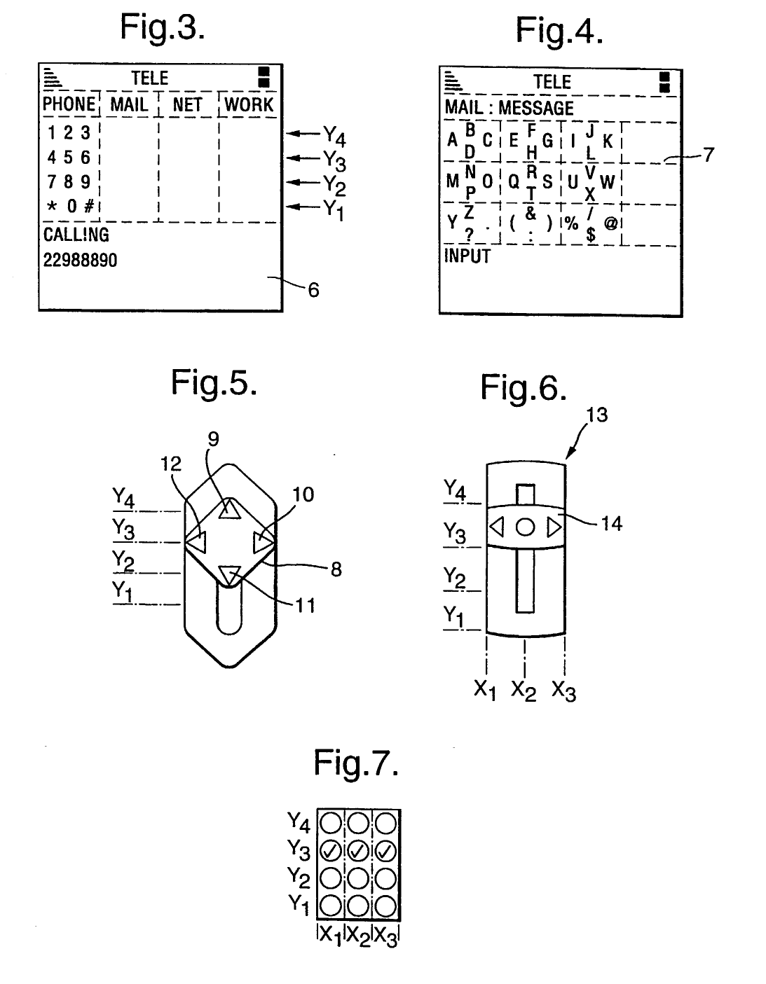

FIGS. 3 and 4 together with FIG. 5 provide a detailed illustration of the use of the invention.

FIGS. 6-10 provide a further explanation of the use of the invention.

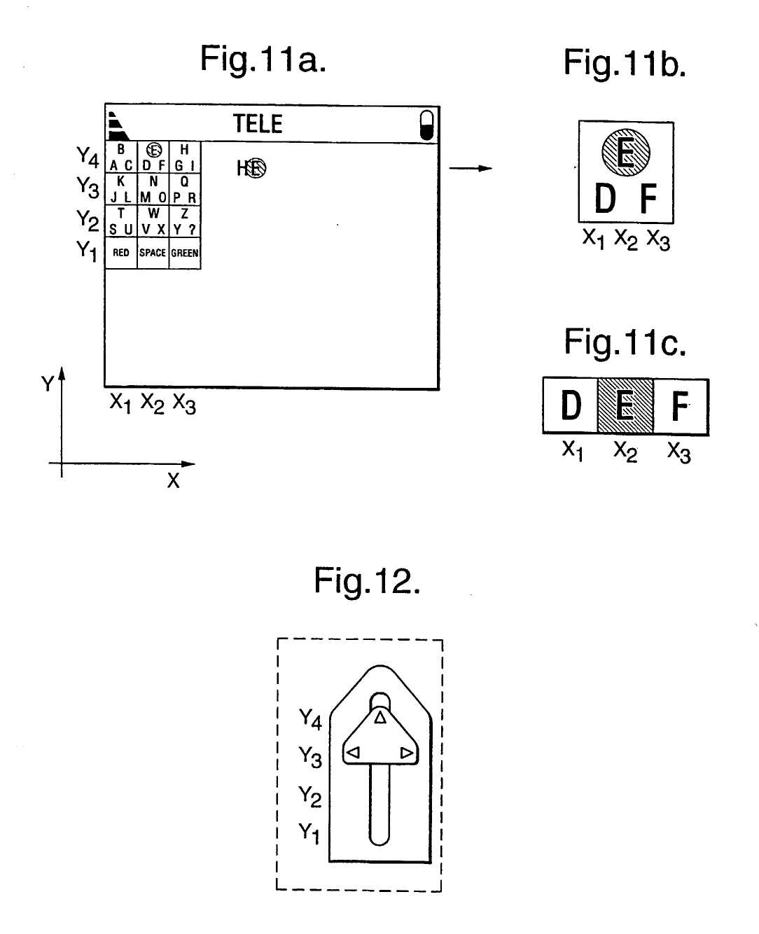

FIG. 11 is a supplementary figure to illustrate the use of the invention.

FIG. 12 shows a typical operating device having a stepwise slidable control element for the use of the invention.

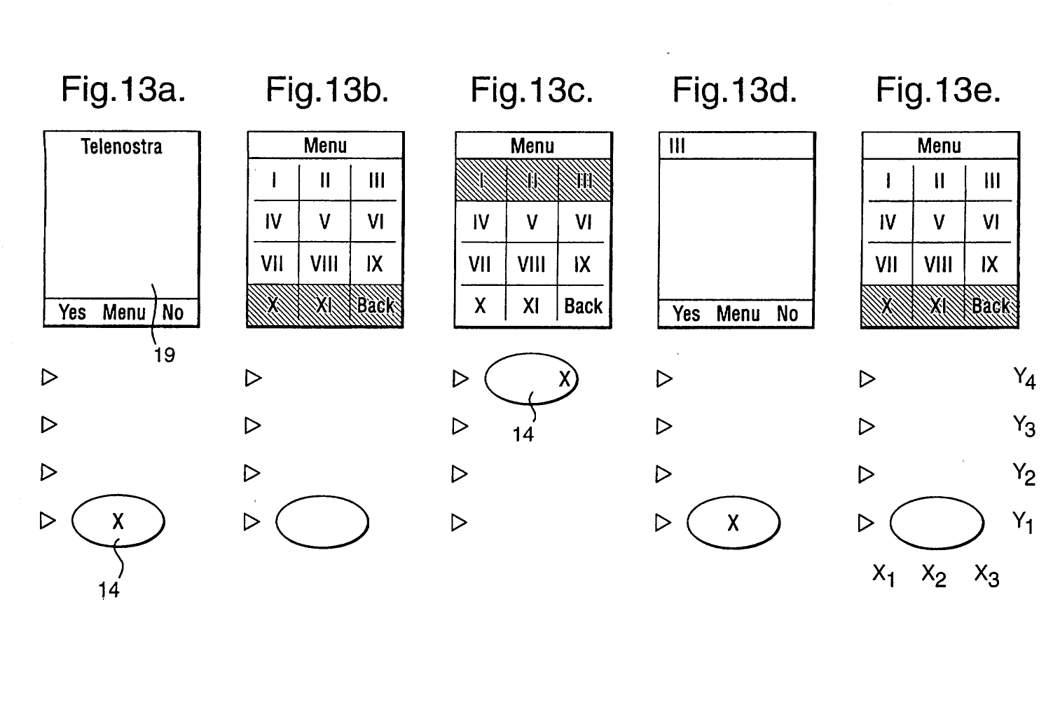

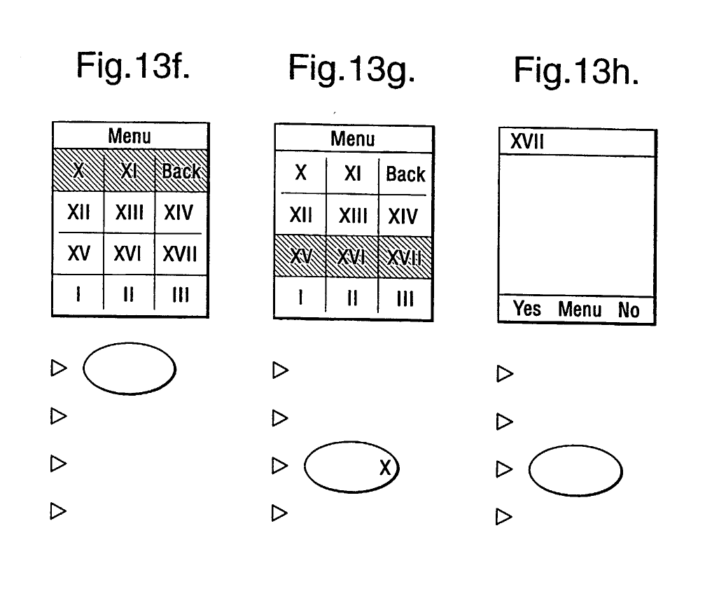

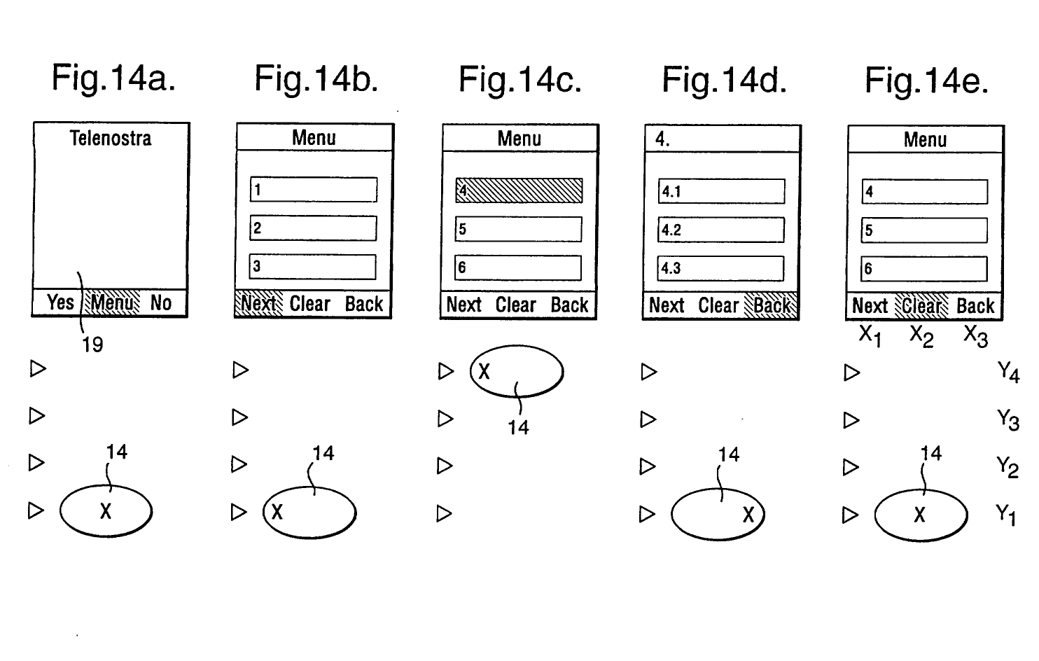

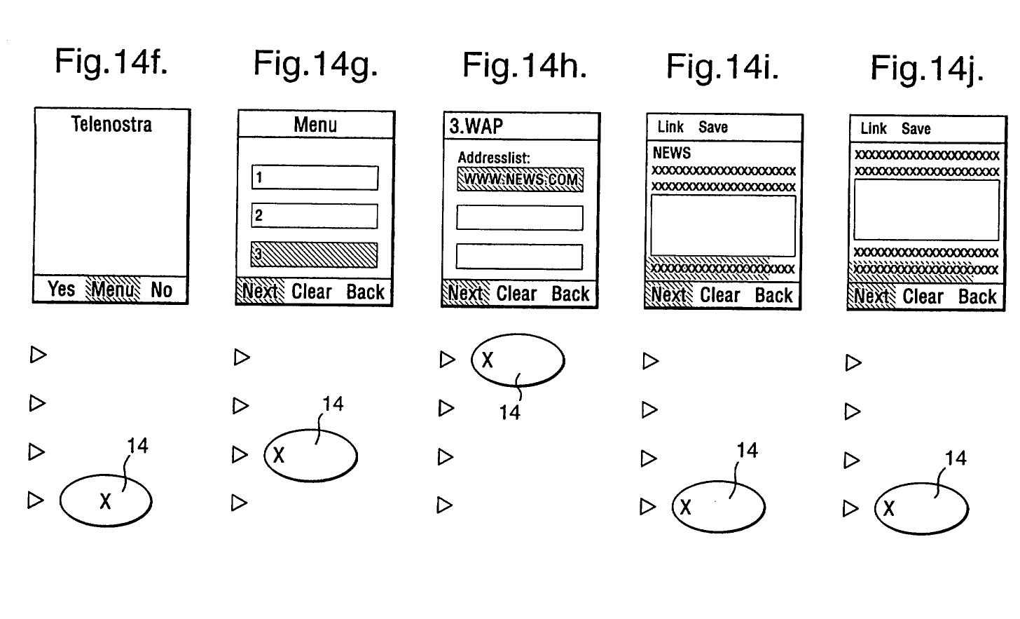

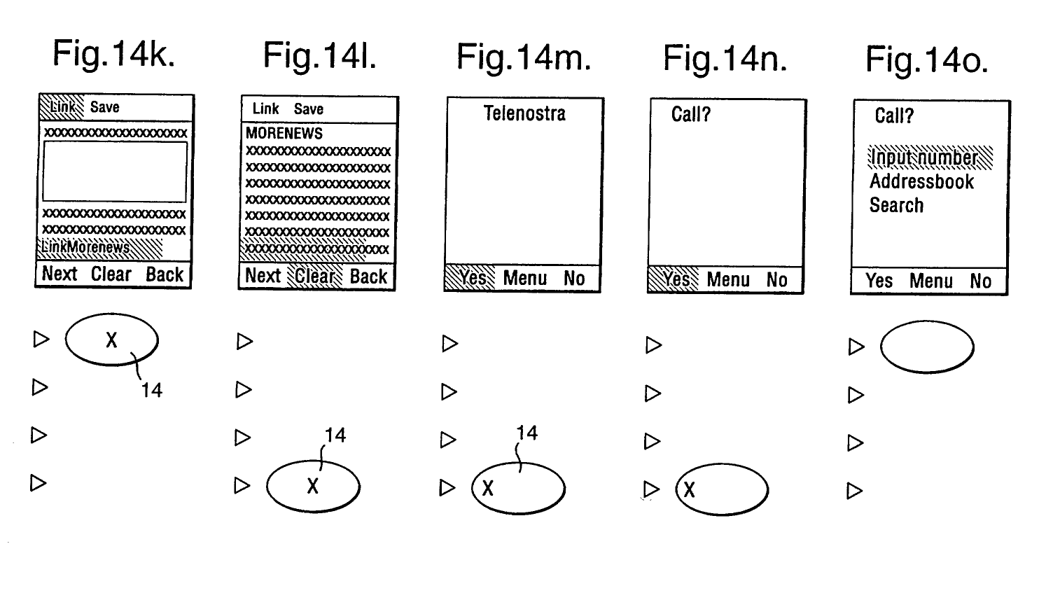

FIGS. 13 and 14 show the use of the invention in connection with an operating device having a control element that is movable along a path and tiltable or depressible in stepwise positions.

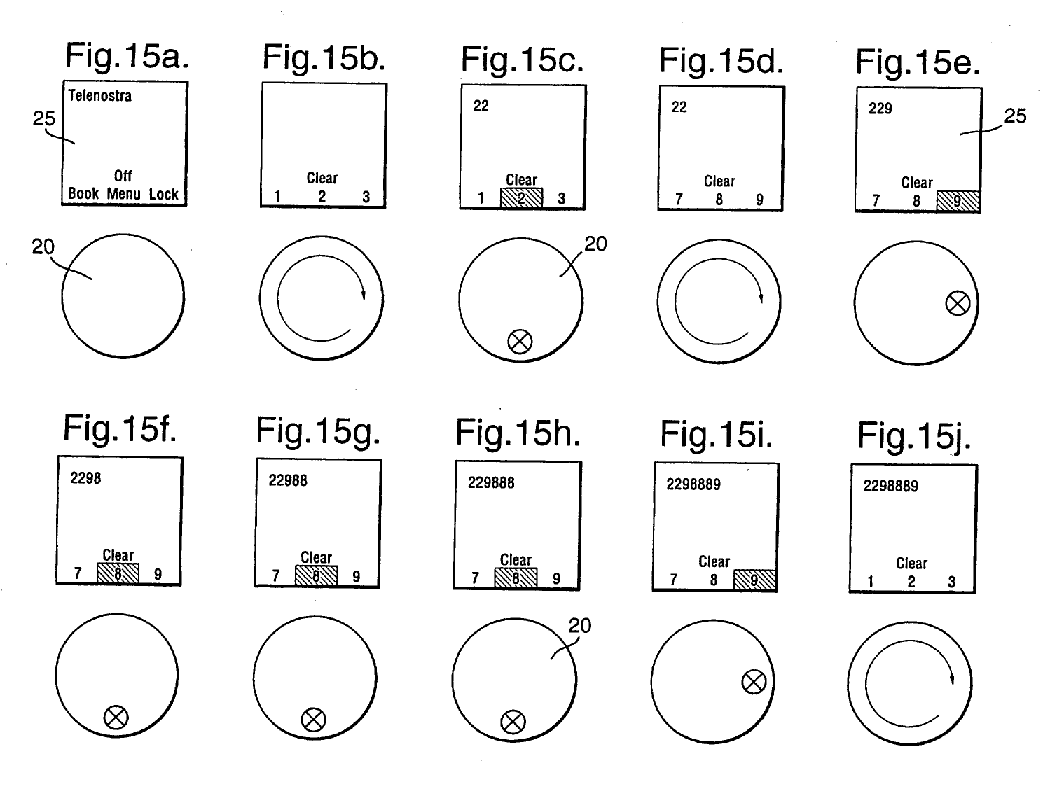

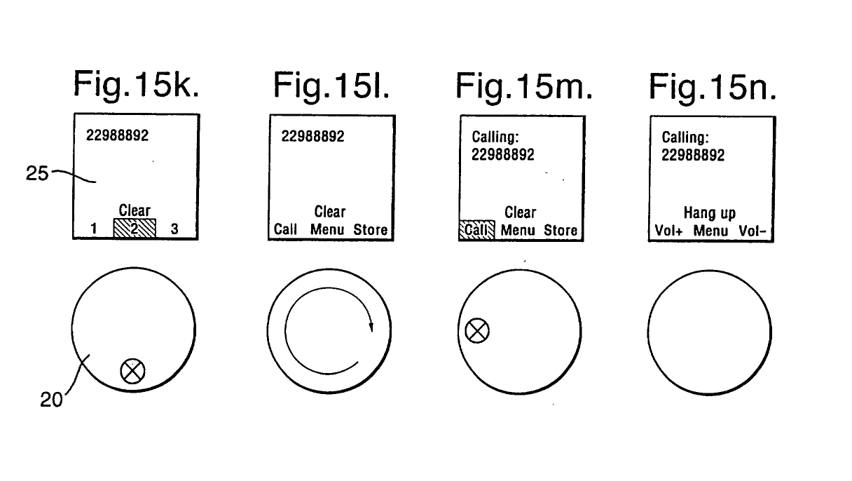

FIGS. 15, 16, 17 and 18 show the use of the invention in connection with an operating device which uses a stepwise, 360°-rotatable control element, and where the control element is tiltable in certain directions.

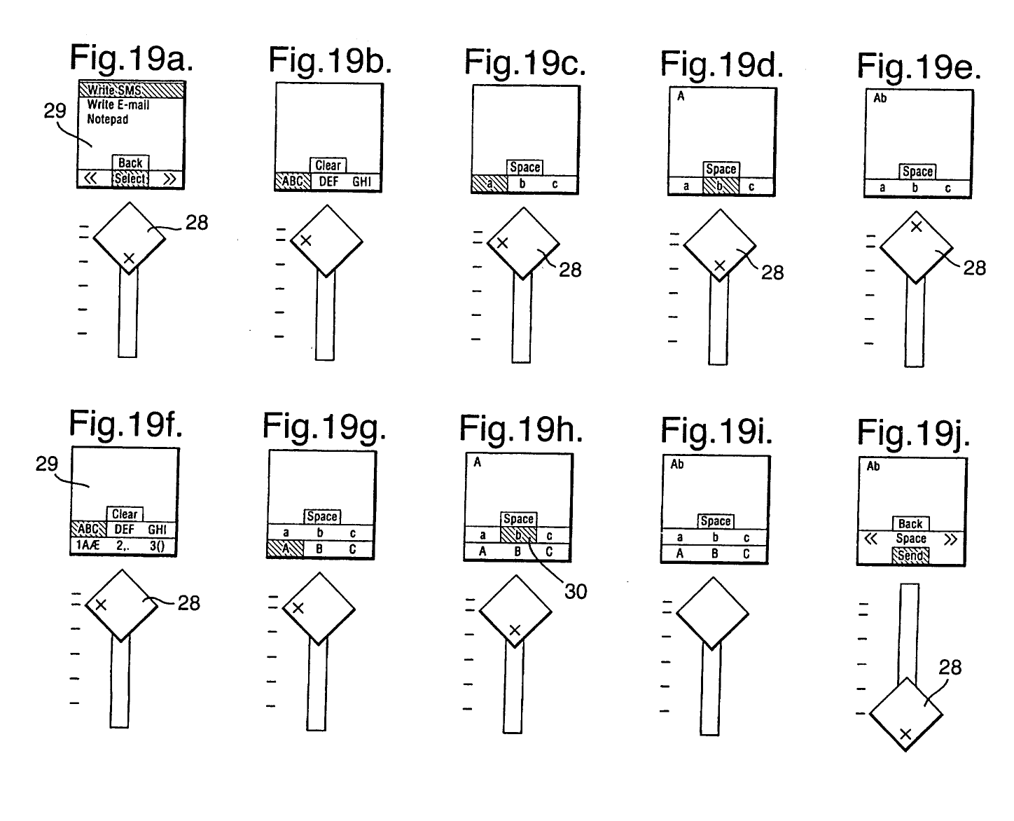

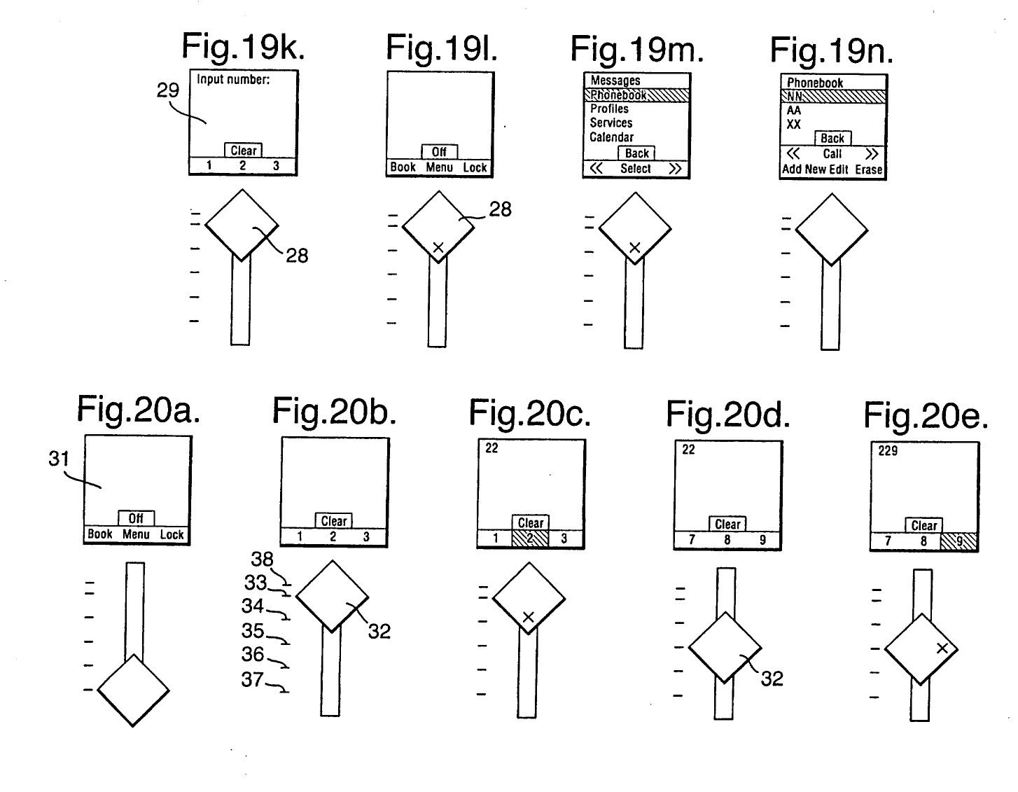

FIG. 19 shows a further use of the invention in connection with, by way of example, an operating device which makes use a control element that is movable along a path and in stepwise positions is tiltable.

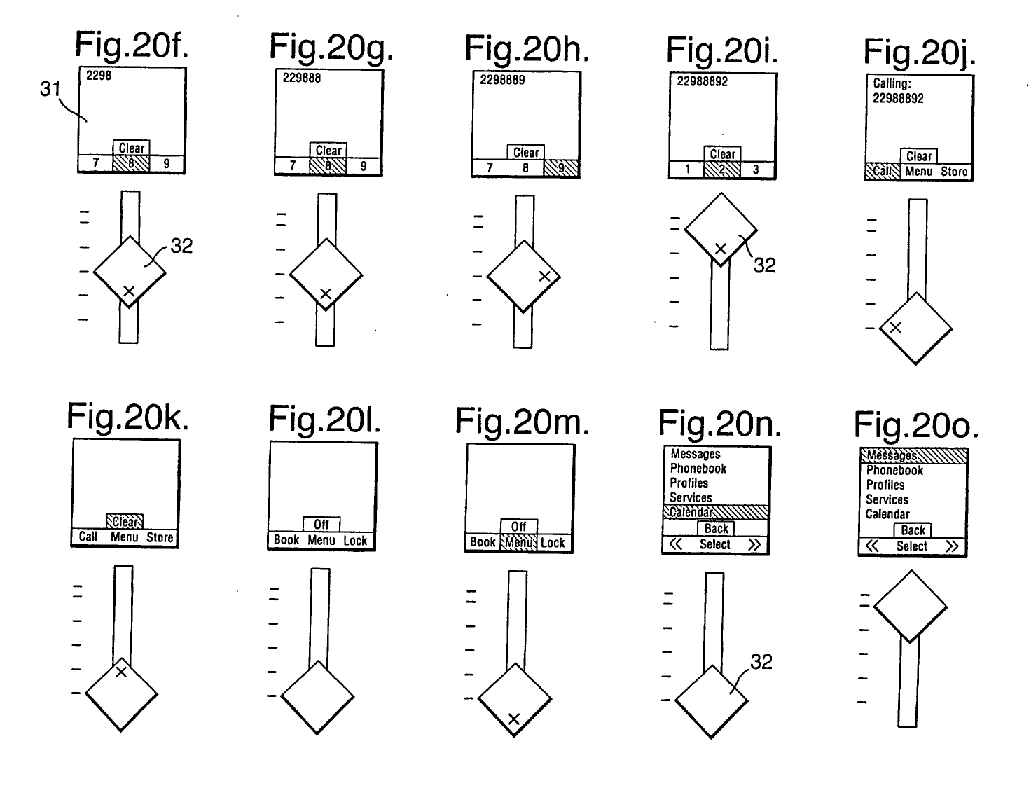

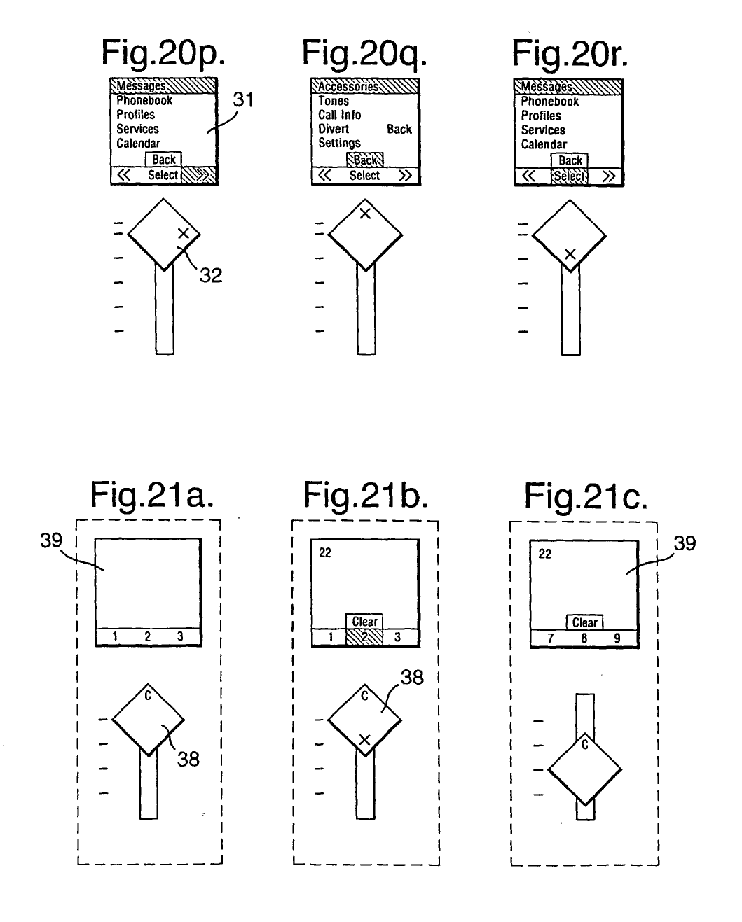

FIG. 20 shows a further use of the invention in connection with that shown and described in connection with FIG. 19.

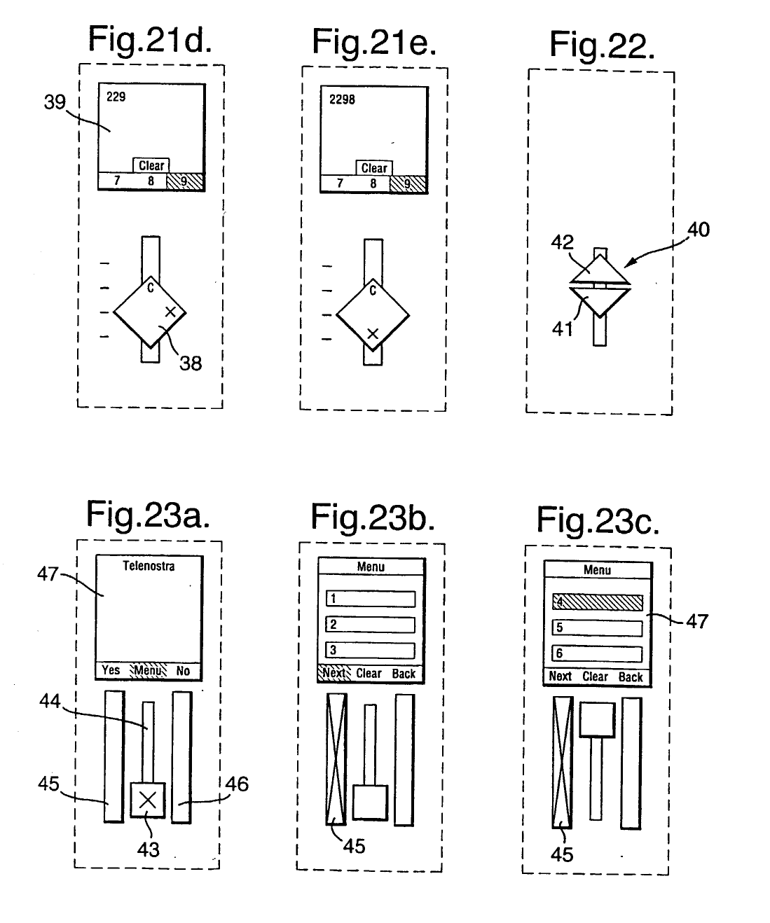

FIG. 21 shows a further example of the use of a control element that is movable along a path and in stepwise positions is tiltable.

FIG. 22 shows a variant of a control element as shown in FIGS. 19-21.

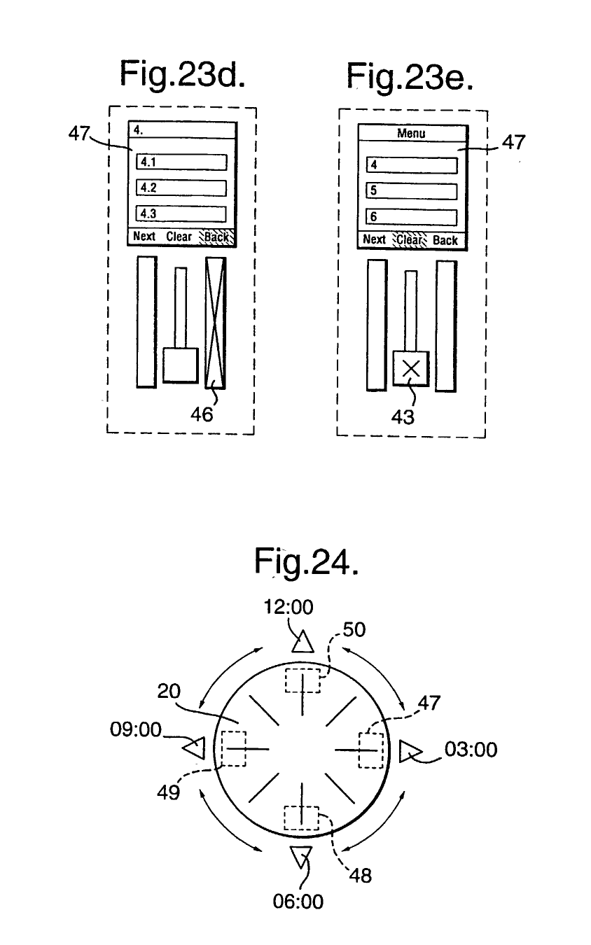

FIG. 23 shows a further use of the invention when using a control element that is movable along a path and in stepwise positions is depressible, and with auxiliary keys placed on either side thereof

FIGS. 24, 25 and 26 show two variants of an operating device for use with the embodiment shown in FIGS. 15-18.

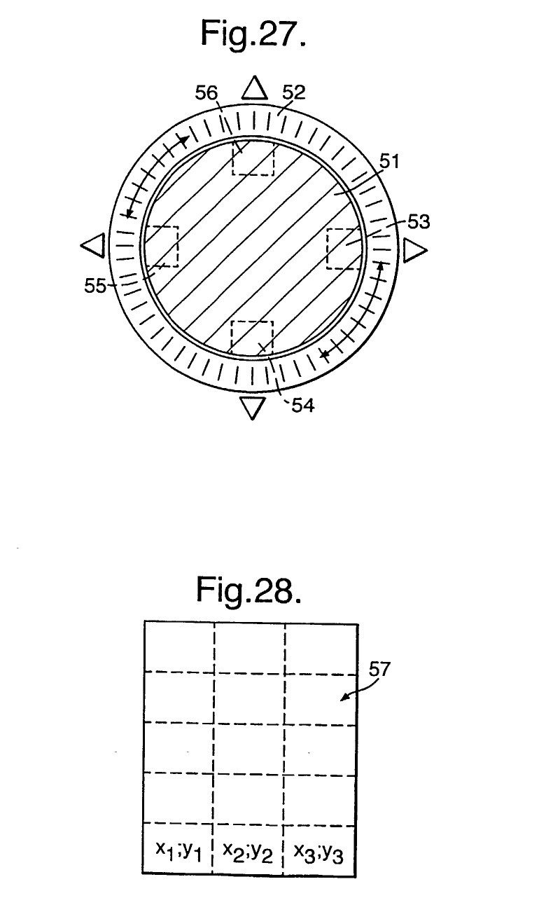

FIG. 27 shows a variant of the operating device shown in FIGS. 24-26.

FIG. 28 shows another operating device of a type that is known per se.

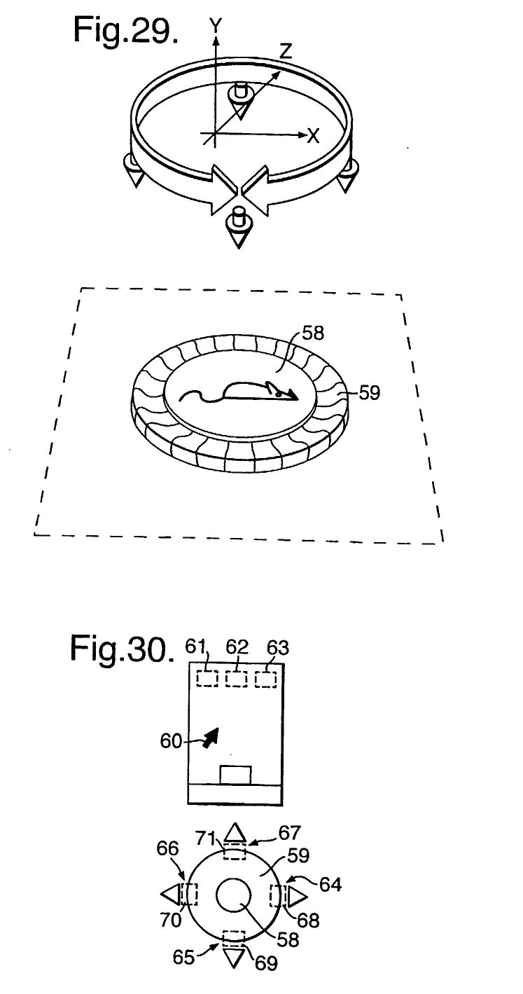

FIG. 29 shows yet another operating device with means for cursor control, as indicated in FIG. 30.

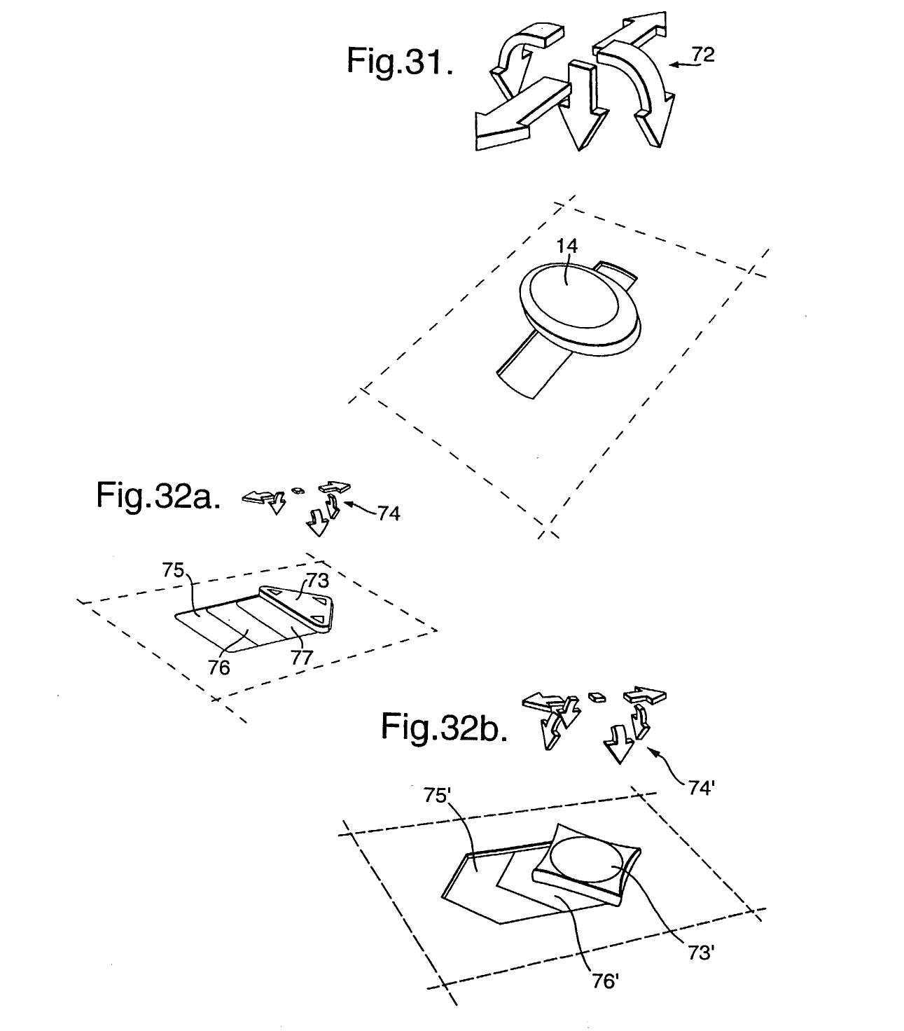

FIG. 31 illustrates an operating device of the type shown and described in connection with FIGS. 13 and 14.

FIGS. 32a and 32b show further variants of an operating device.

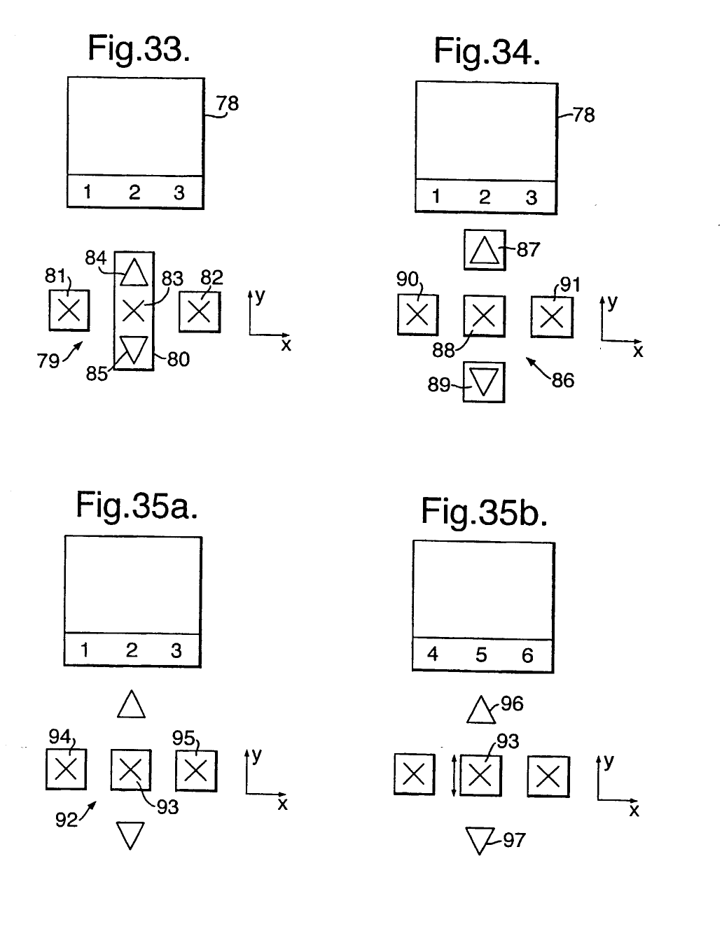

FIG. 33 shows yet another embodiment, and FIGS. 34 and 35 show variants thereof.

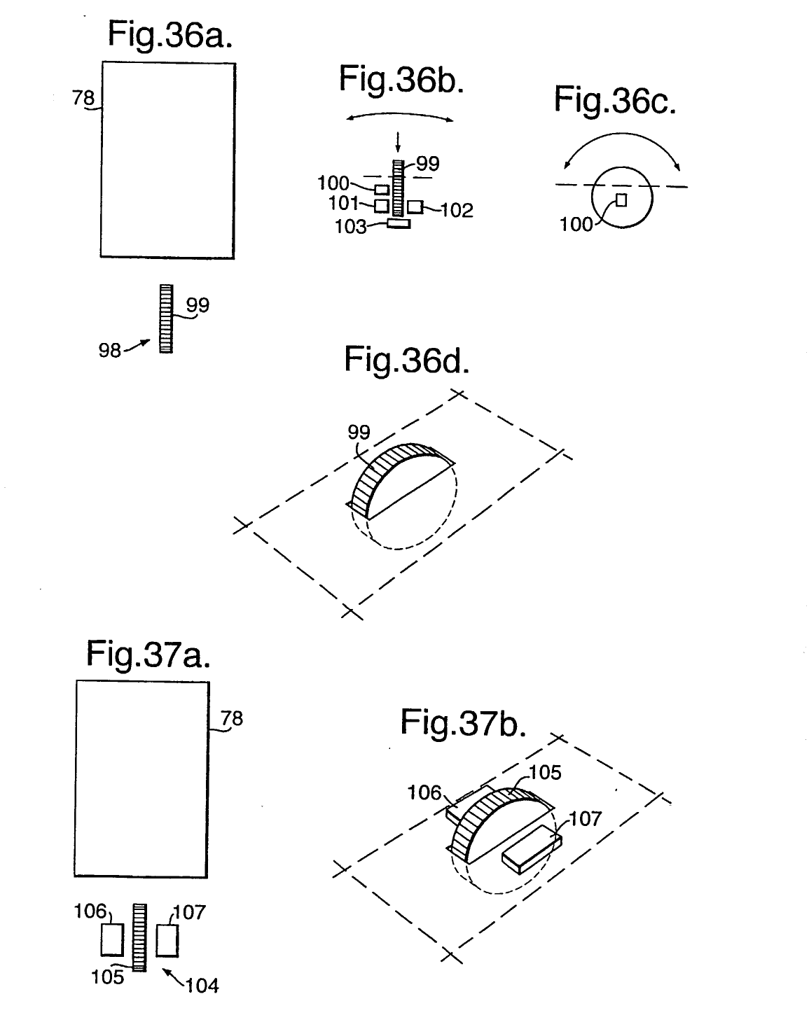

FIG. 36 shows another additional embodiment of the operating device, and FIG. 37 shows a variant thereof

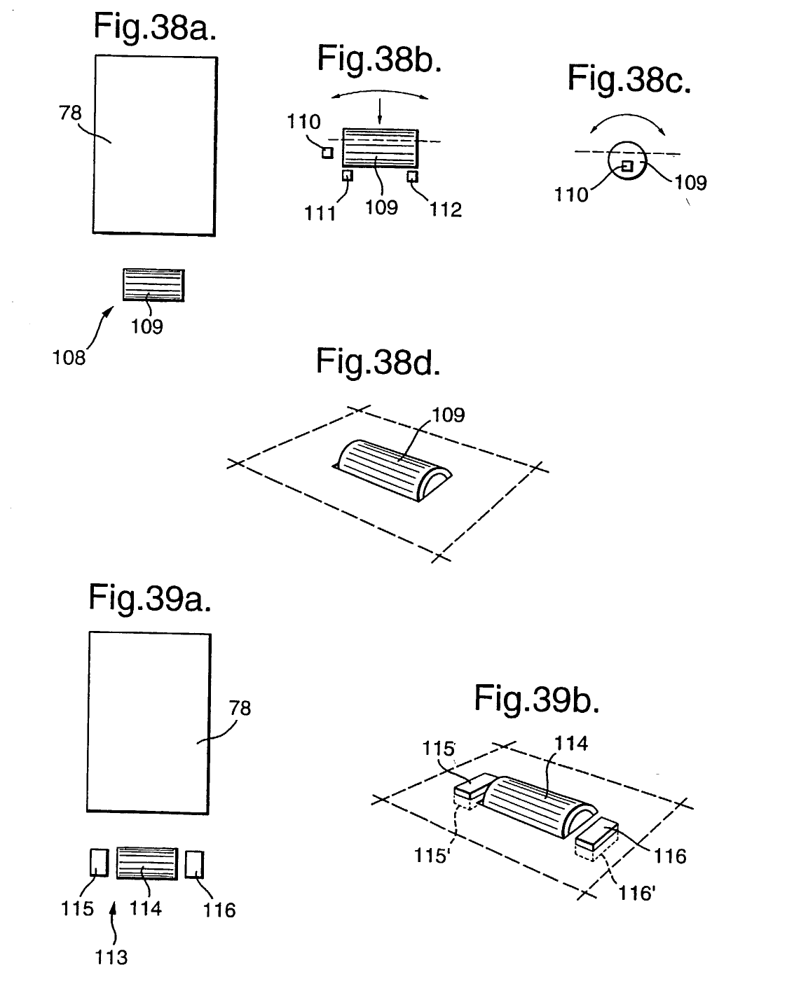

FIG. 38 shows a variant of the operating device shown in FIG. 36, and

FIG. 39 shows a variant of the operating device shown in FIG. 37. FIGS. 38 and 39 also show variants of each other.

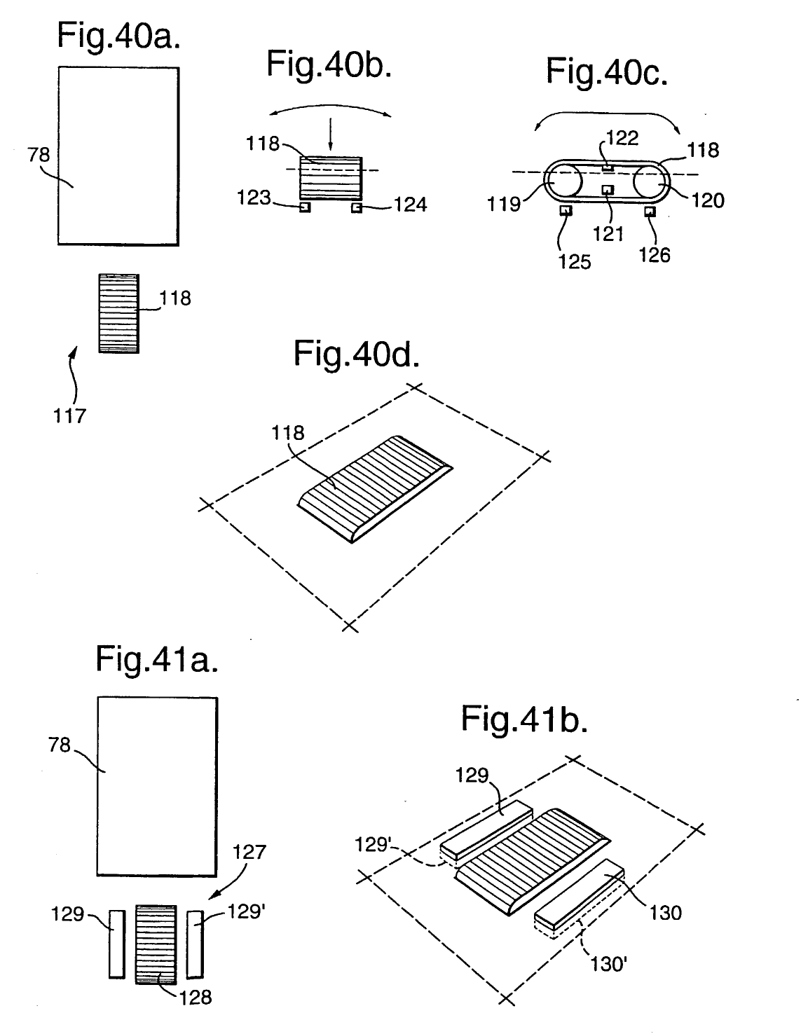

Another embodiment of the operating device is shown in FIG. 40, and FIG. 41 shows a variant thereof

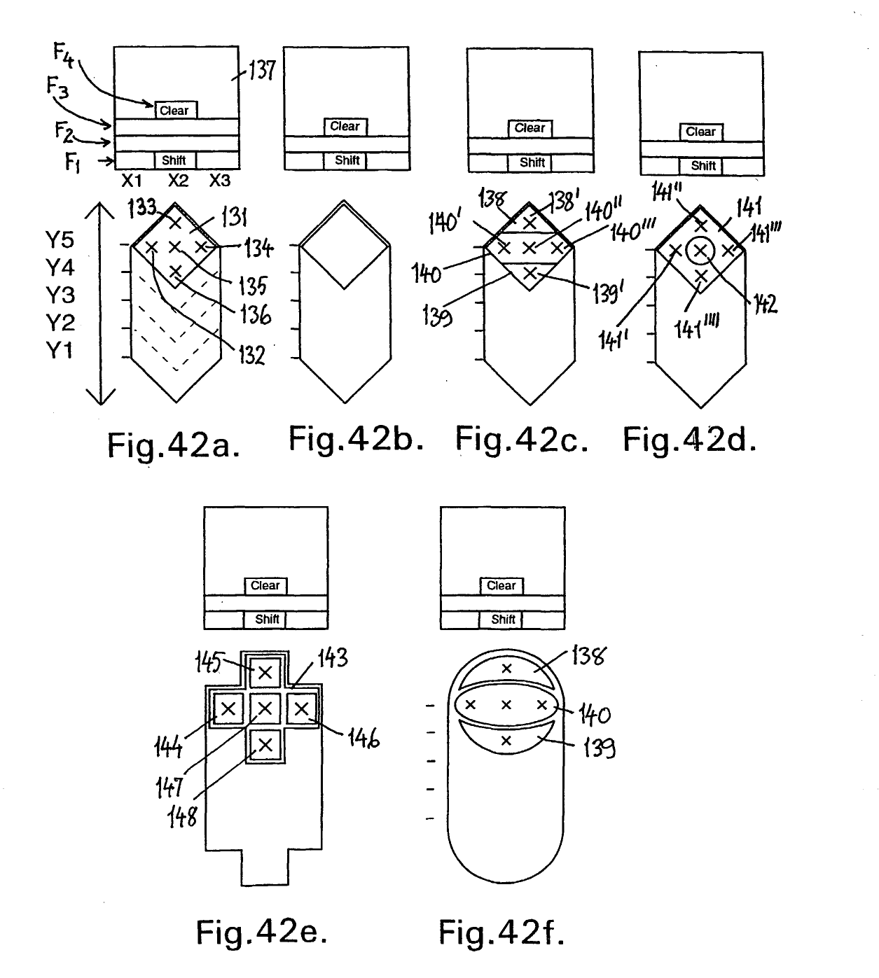

FIGS. 42a-42f show the use of an operating device that has a plurality of sliding positions and tilting/pressing positions in connection with menu handling.

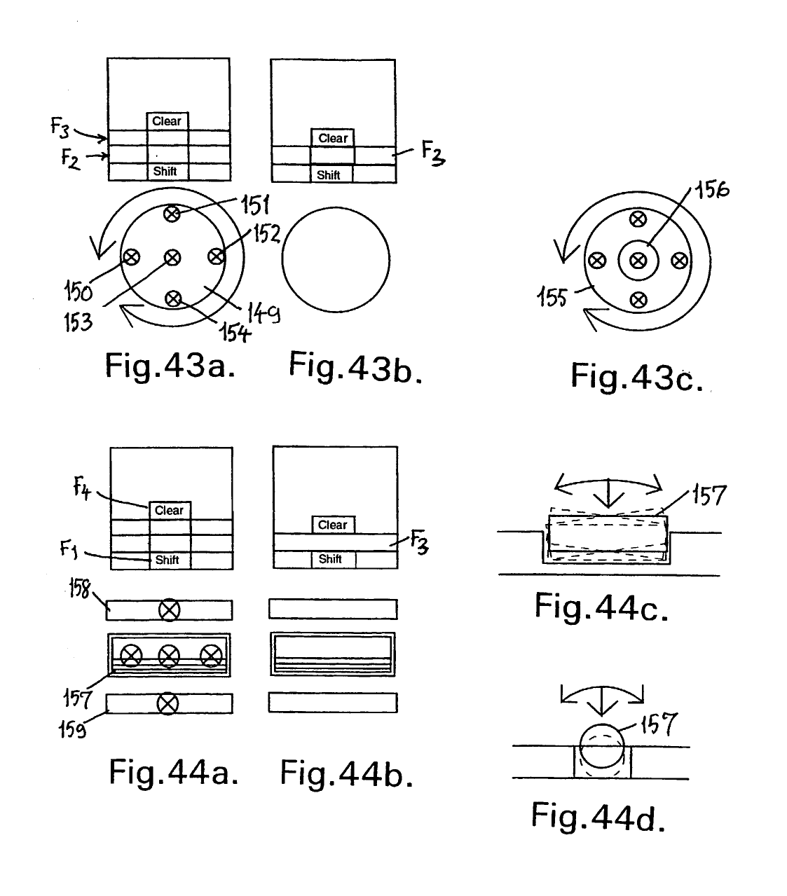

FIGS. 43a-43c show a variant of the solution in FIG. 42 where the operating device is in the form of an rotatable switch.

FIGS. 44a-44d show menu handling in connection with a switch that is rotatable and is cylindrical in shape, and is depressible and tiltable, and capable of interacting with separate pressure switches.

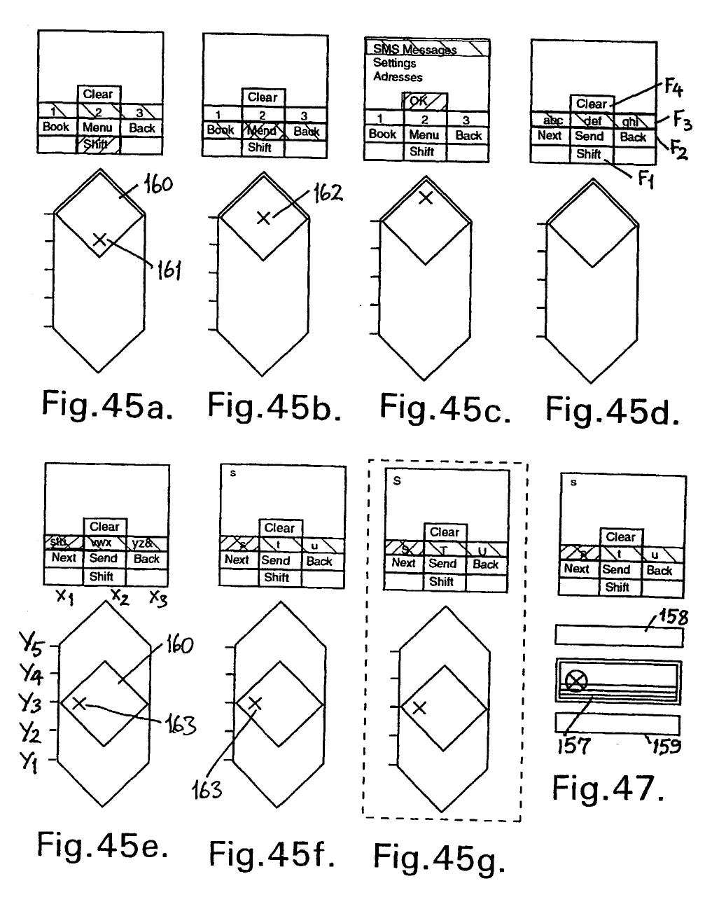

FIGS. 45a-45g show an operating device in the form of a stepwise slidable and tiltable switch for handling a menu.

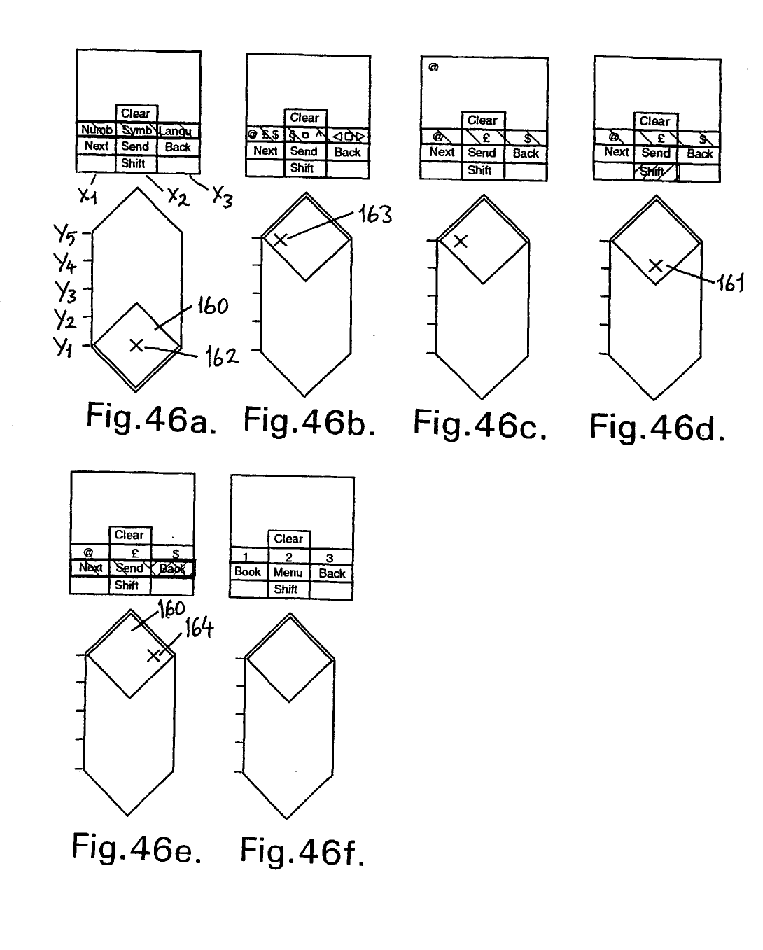

FIG. 46 shows how additional letters and symbols can be generated in a menu by using an operating device as shown in FIG. 42.

FIG. 47 is a simplified block diagram of the system according to the invention.

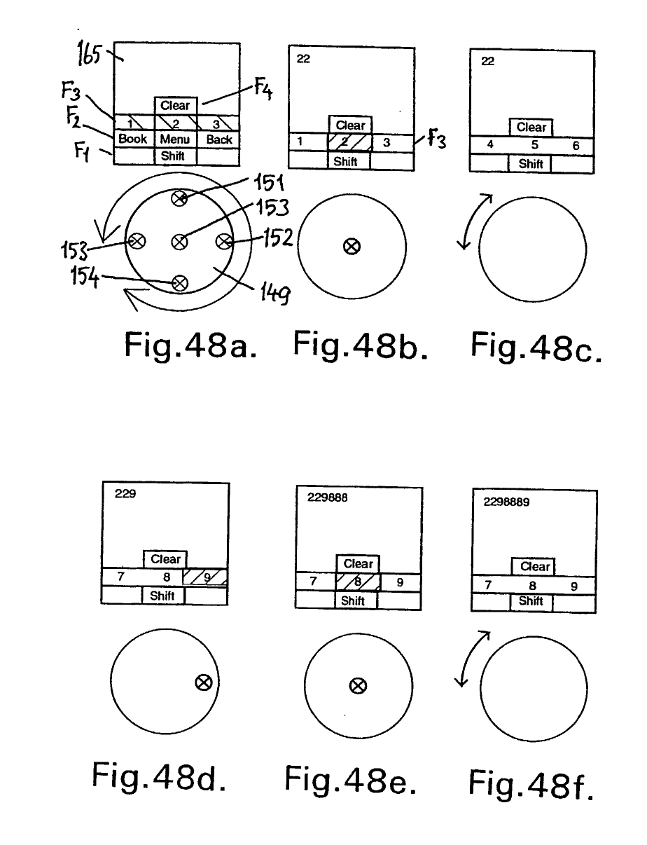

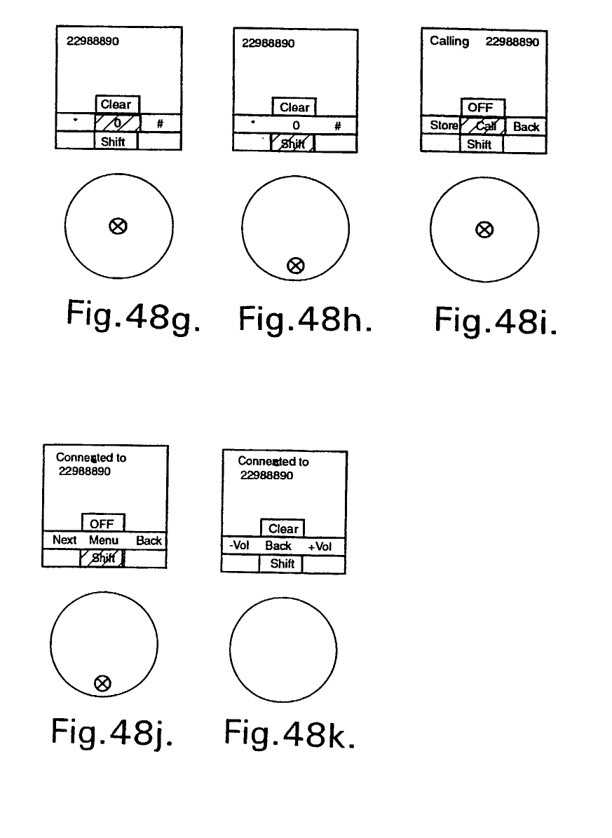

FIGS. 48a-48k show menu handling in connection with a rotatable switch that has five depression points.

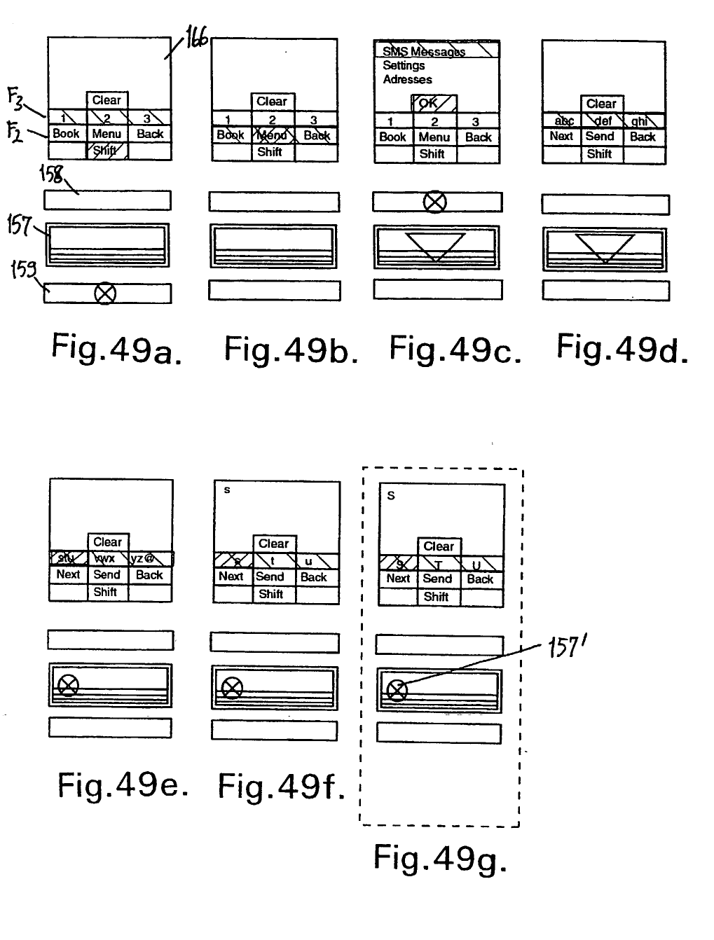

FIGS. 49a-49g show a menu handling system with an operating device in the form of a rotatable cylinder that is depressible and tiltable, assisted by two pressure switches.

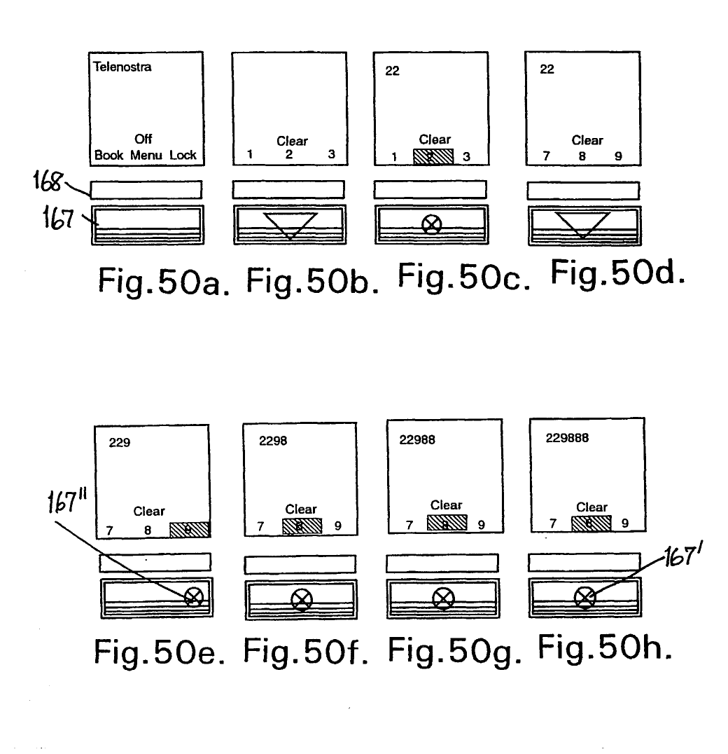

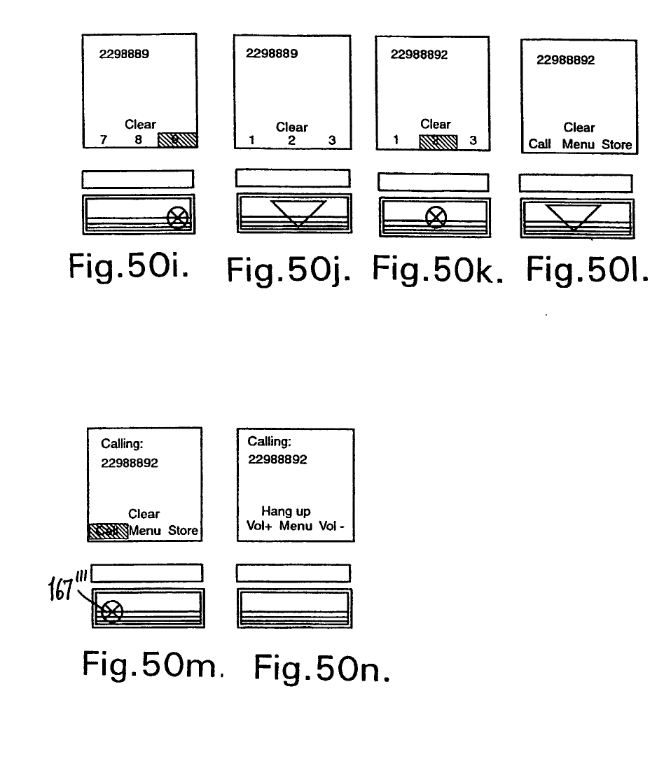

FIGS. 50a-50n show a simplified form of the embodiment shown in FIG. 49.

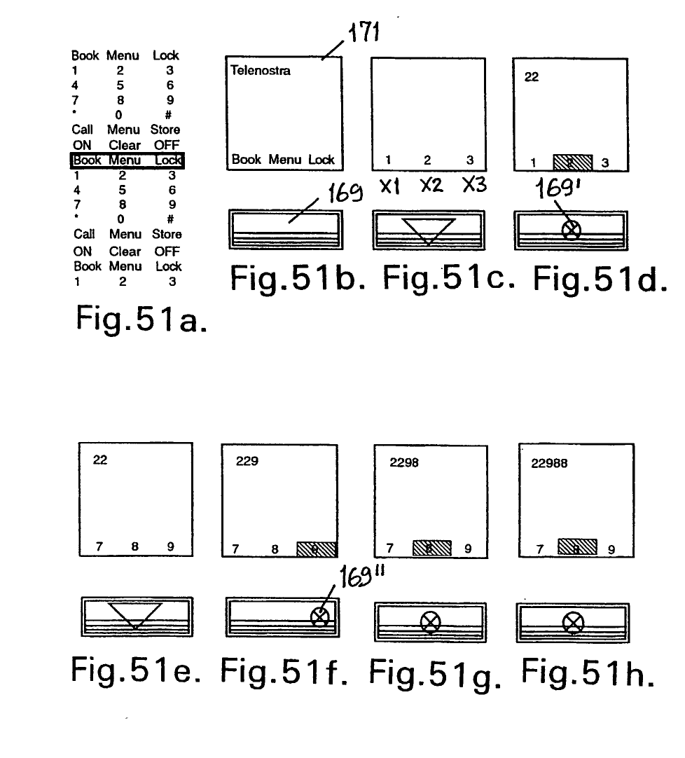

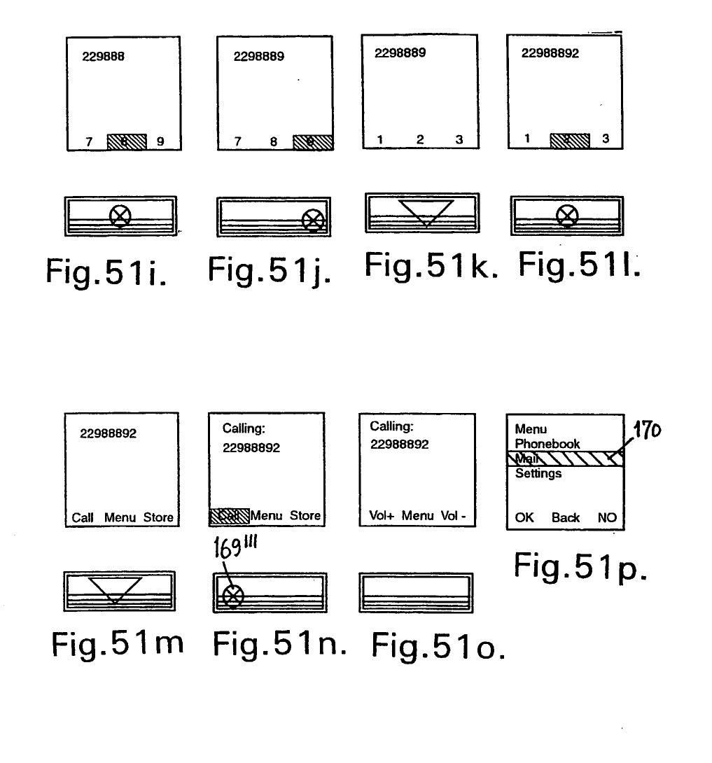

FIGS. 51a-51p show yet another simplified version of the embodiment shown in FIG. 49.

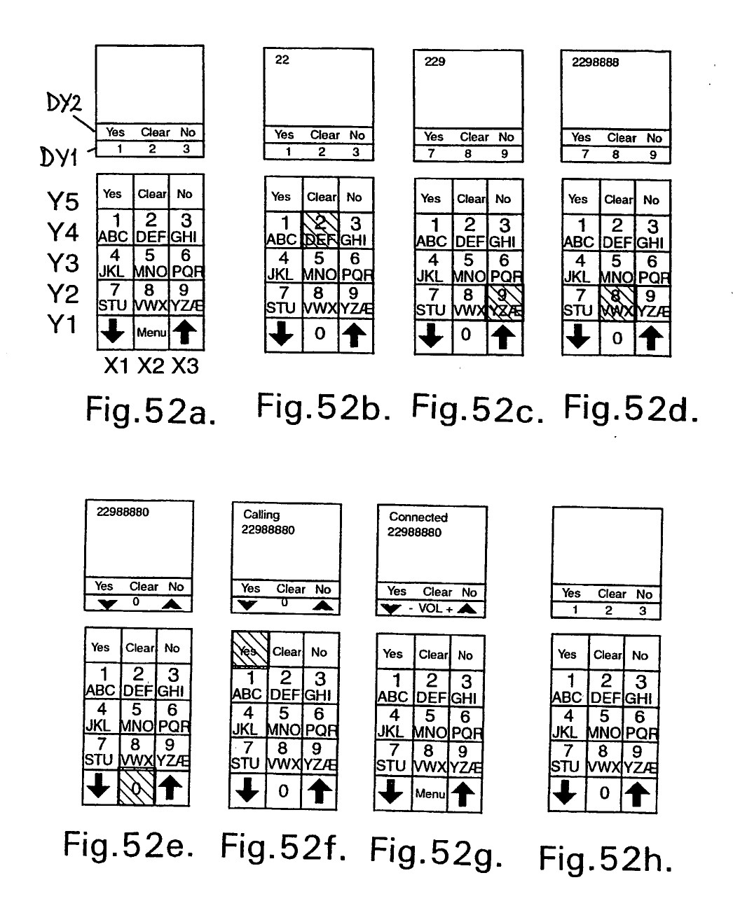

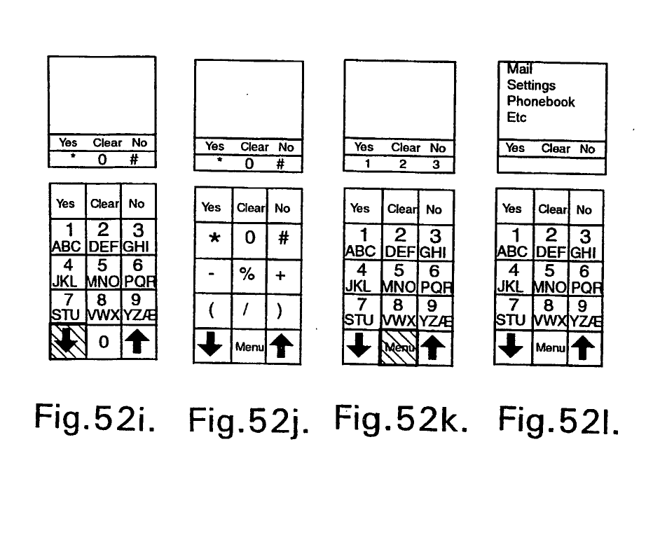

FIGS. 52a-52l show the use of a traditional telephone keypad for performing tasks as shown in connection with the use of a sliding switch or a rotary switch.

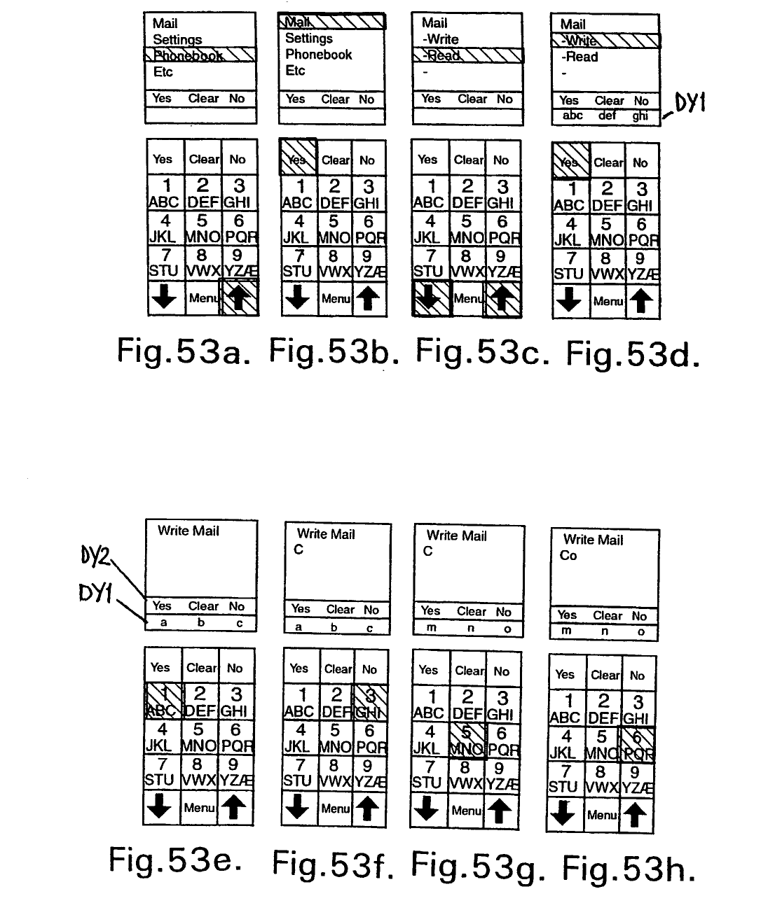

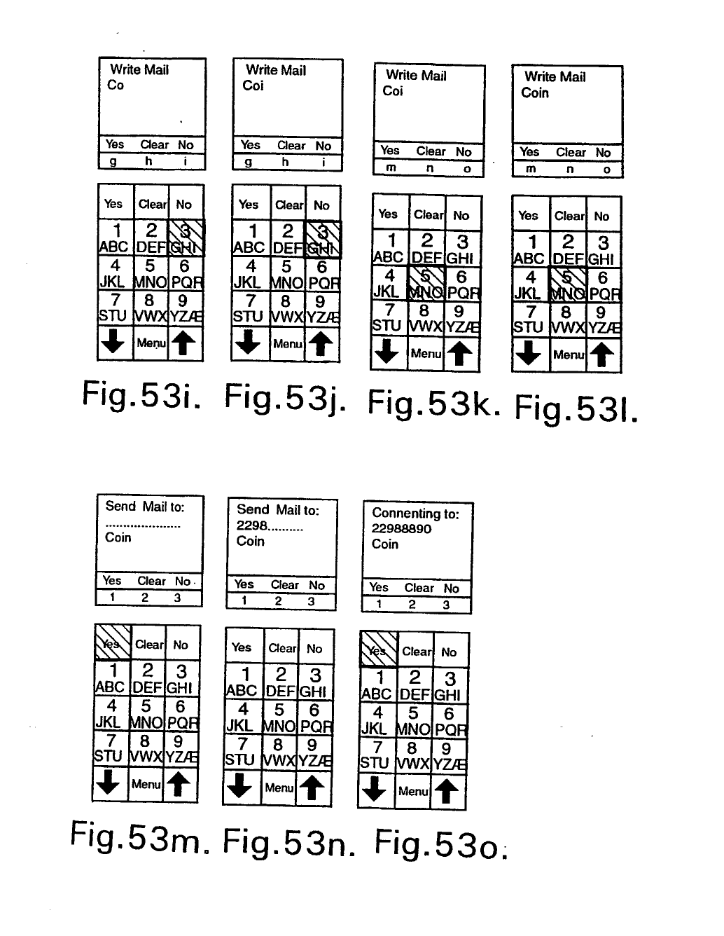

FIGS. 53a-53o show the keying-in of letters when sending a text message.

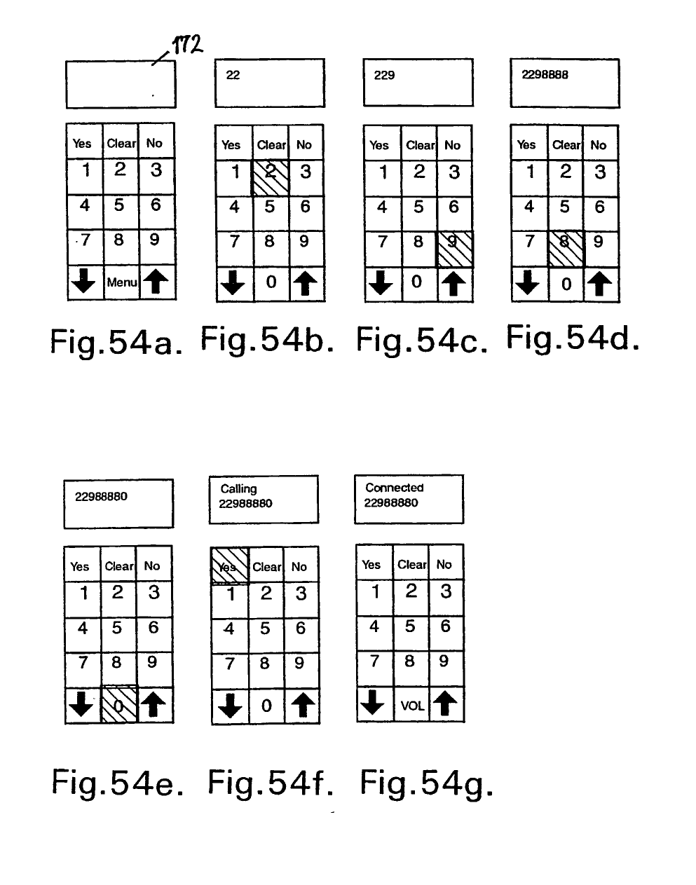

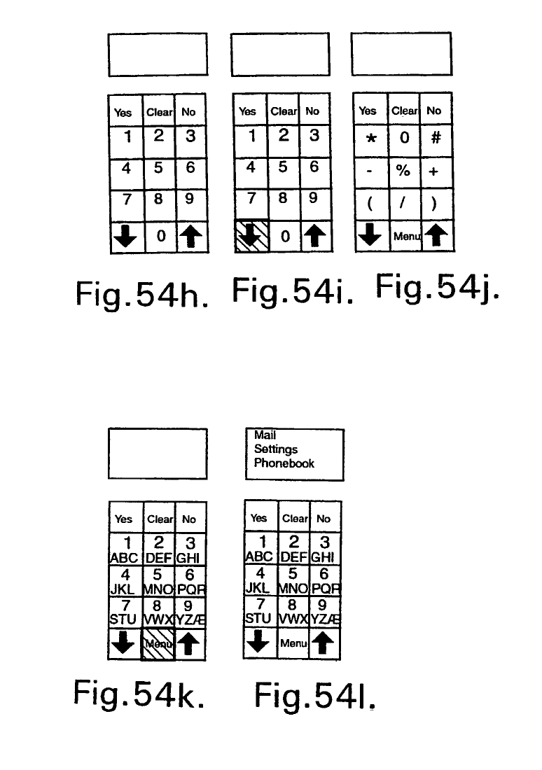

FIGS. 54a-54l shows the use of a keypad system that changes characters/symbols depending on tasks set.

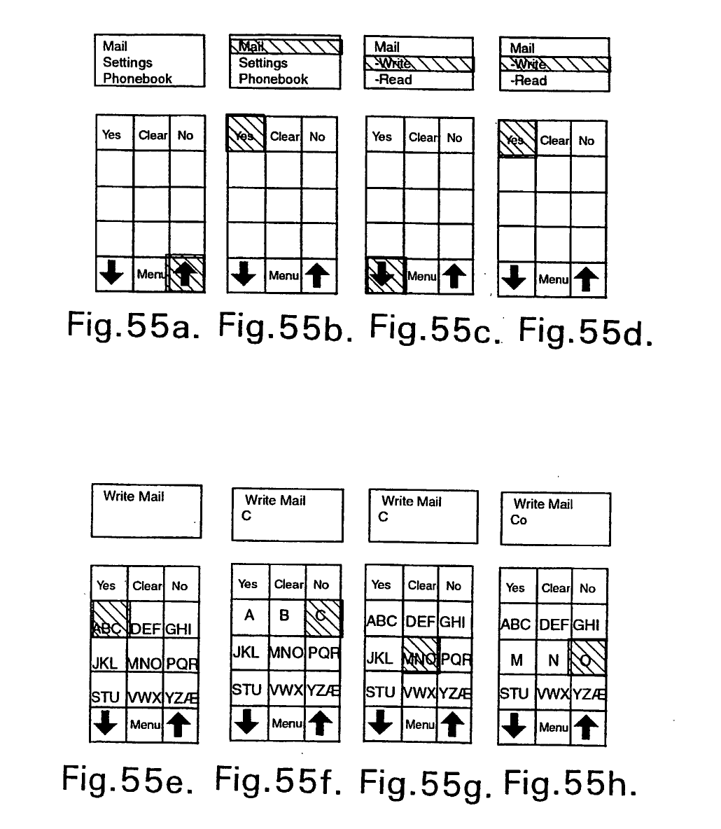

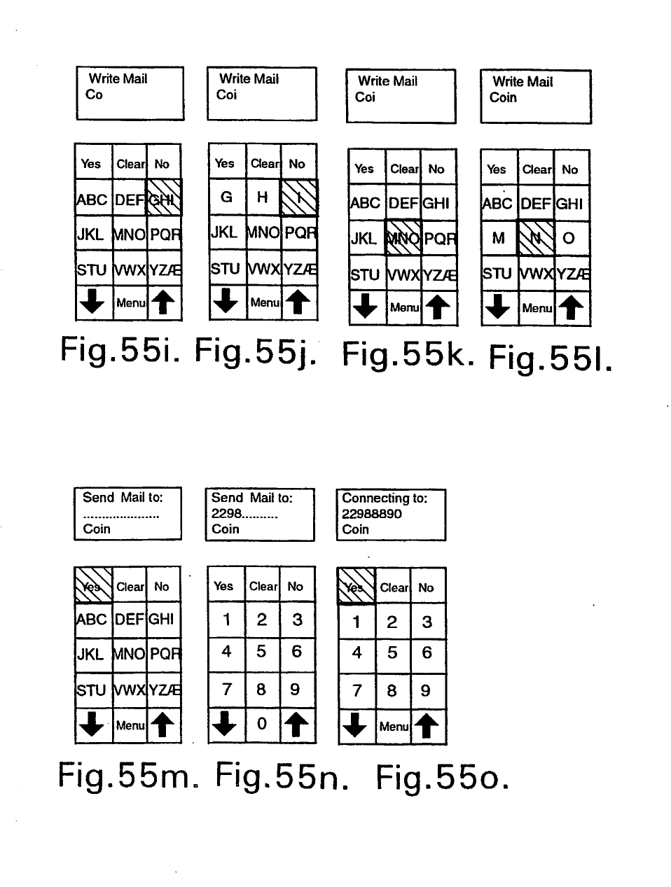

FIGS. 55a-55o show a variant of that shown in FIG. 54.

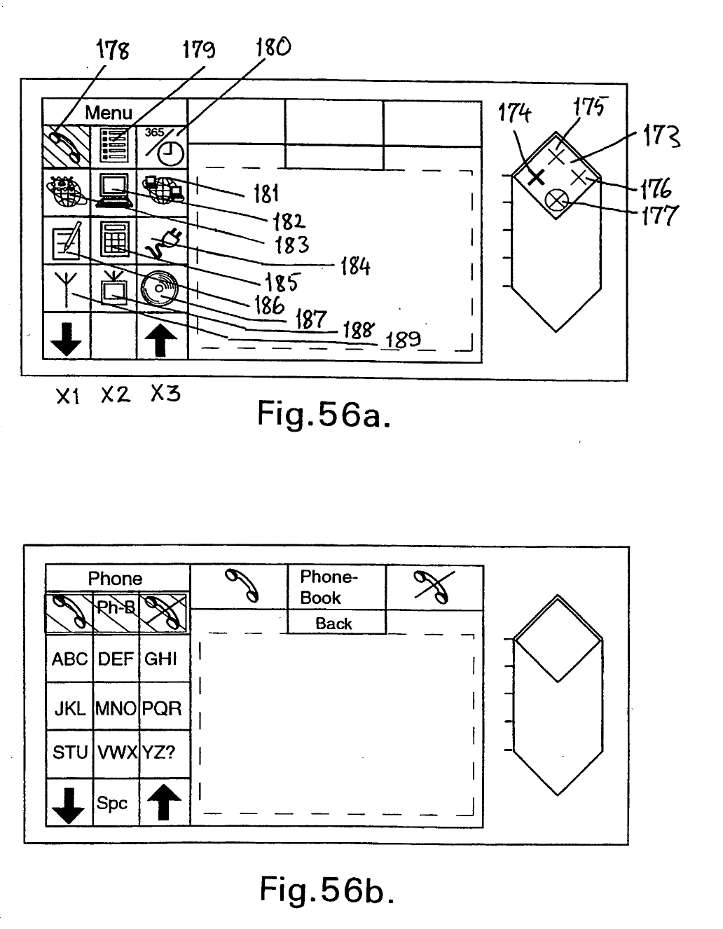

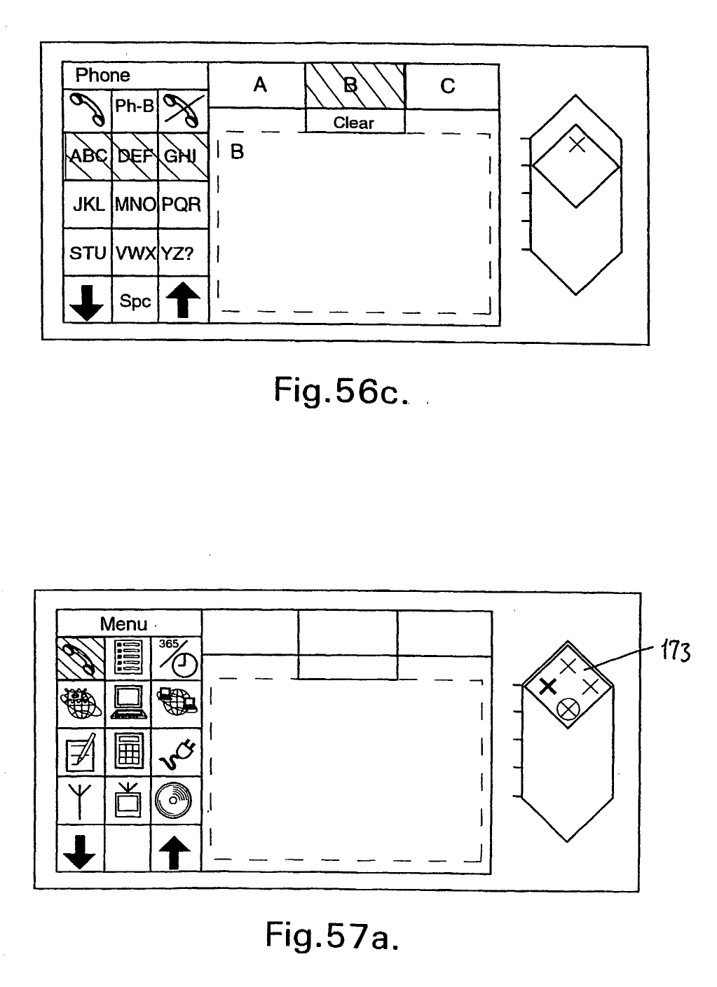

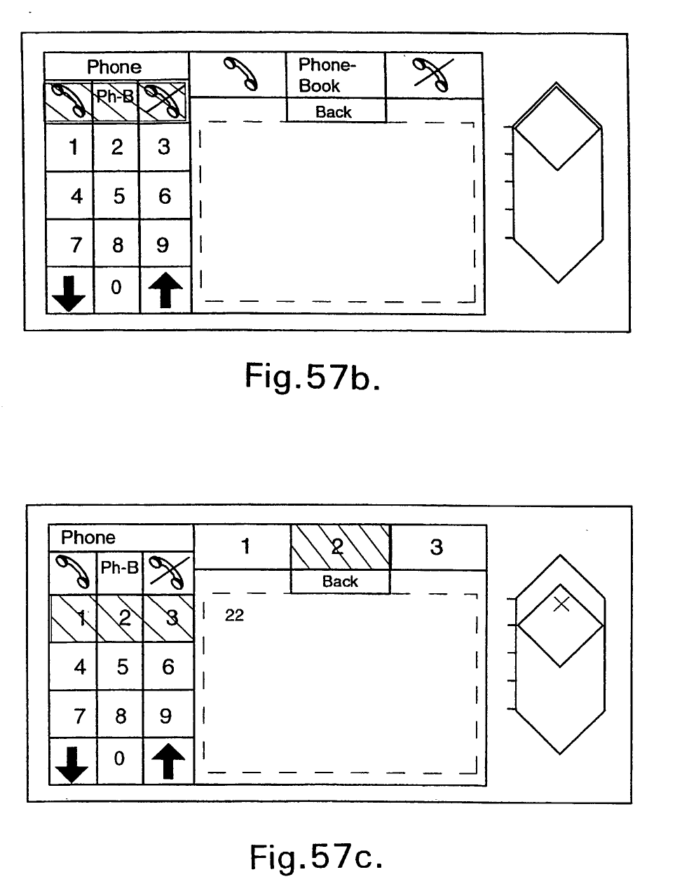

FIGS. 56a-56c and FIGS. 57a-57c show the control of a menu on a mini-PC/PDA, optionally with mobile telephone functions, by using a sliding switch as control element.

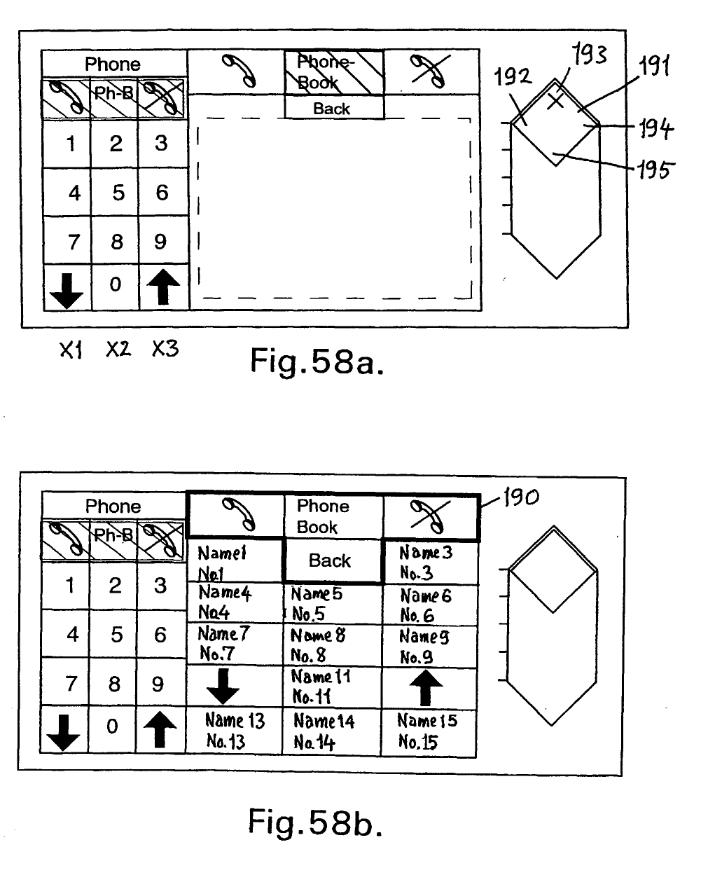

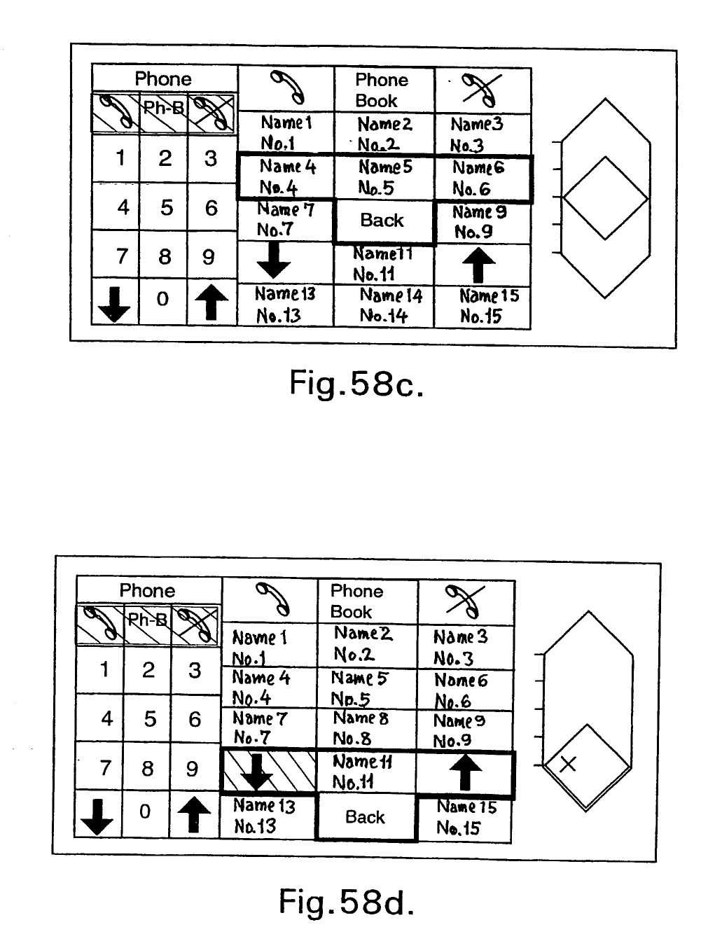

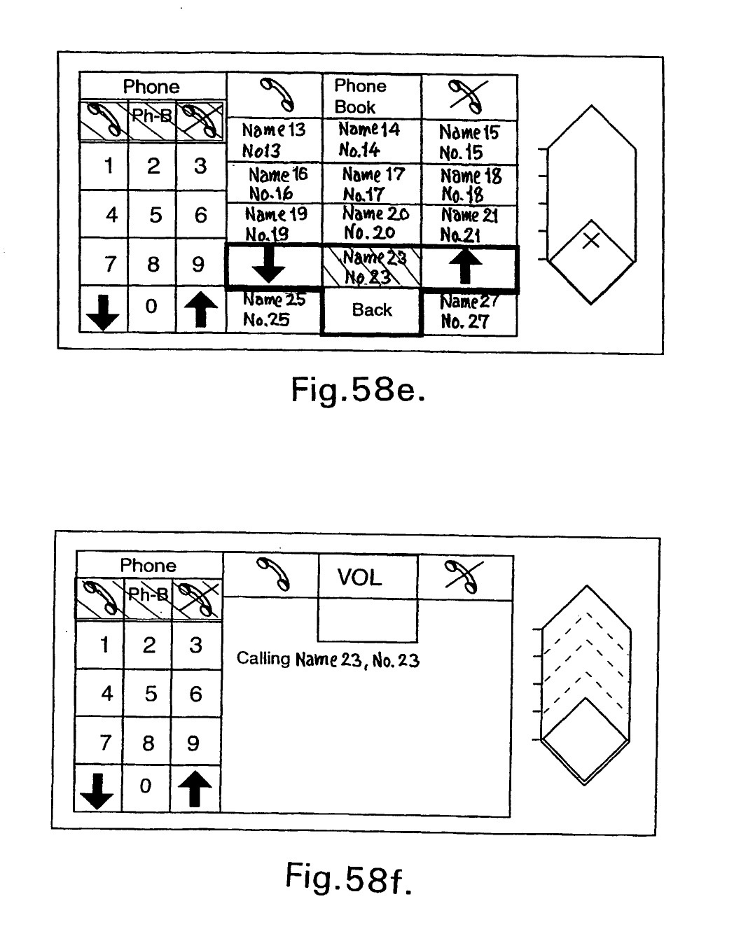

FIGS. 58a-58f show how the system according to the invention functions when the user looks thoug a telephone list whilst an apparatus is in telephone mode.

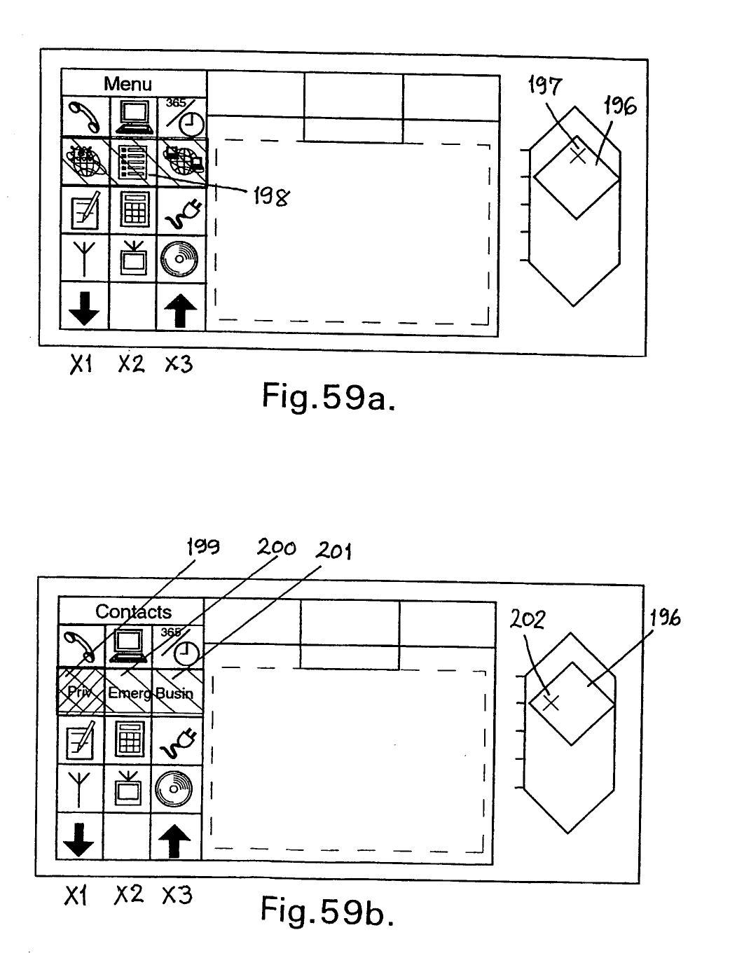

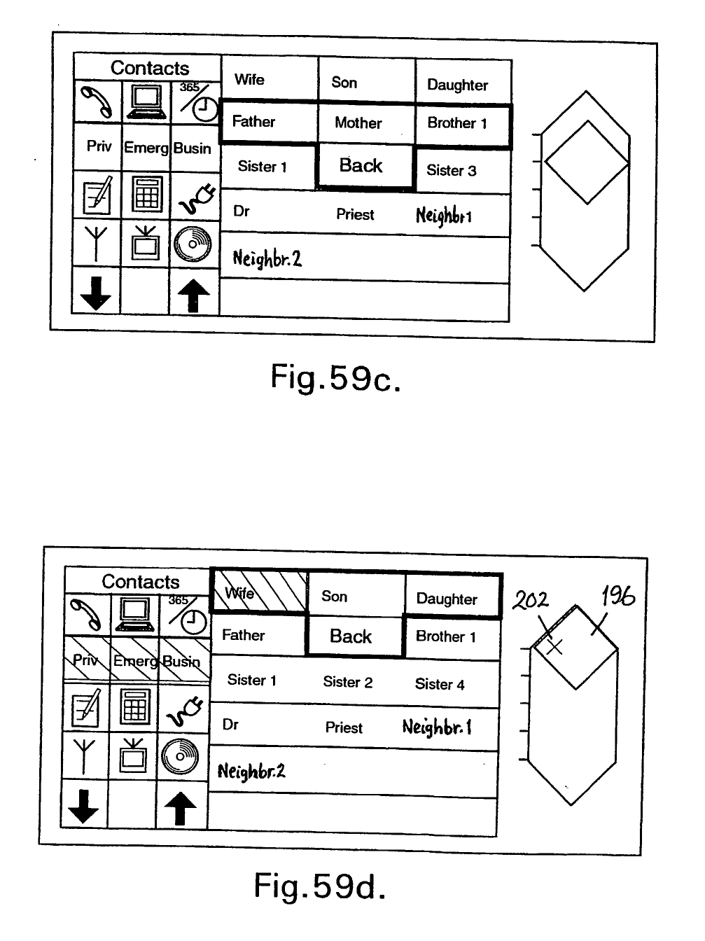

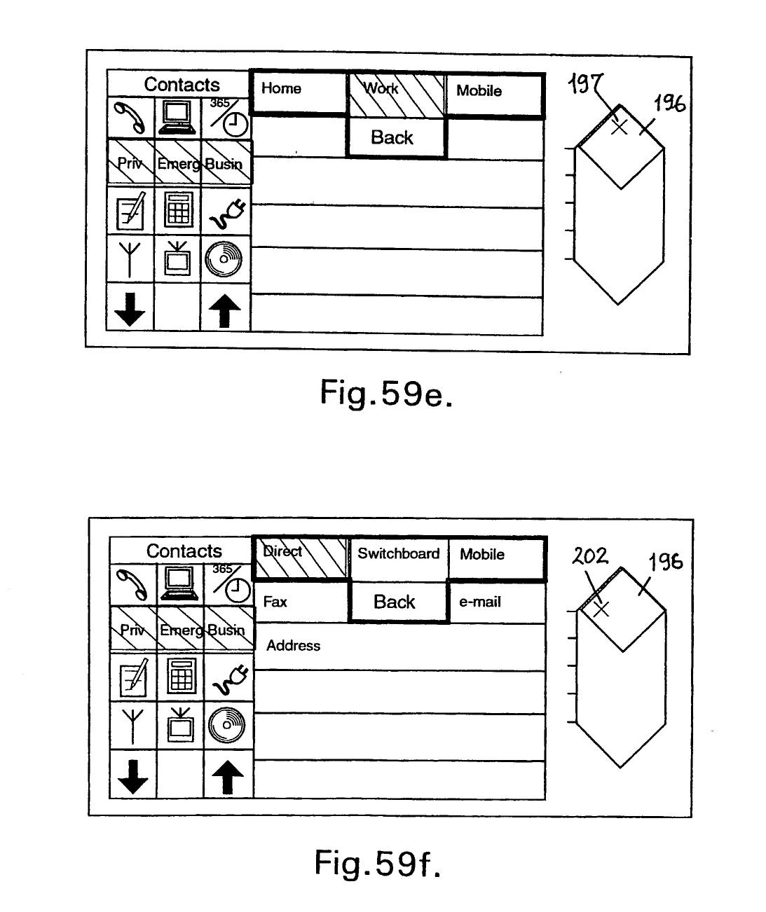

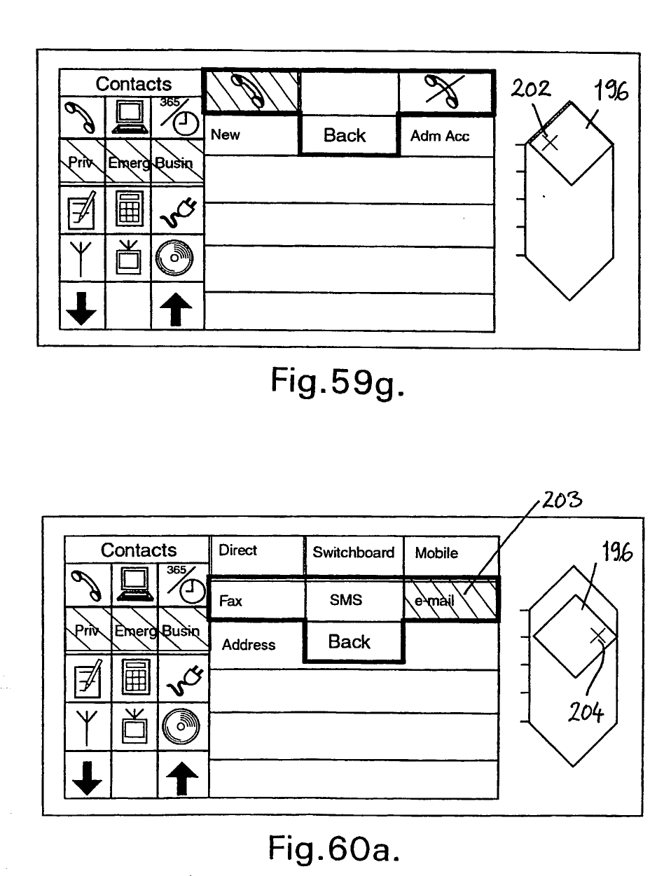

FIGS. 59a-59g show how a system according to the invention can be set up to include lists of the user's personal or business contacts.

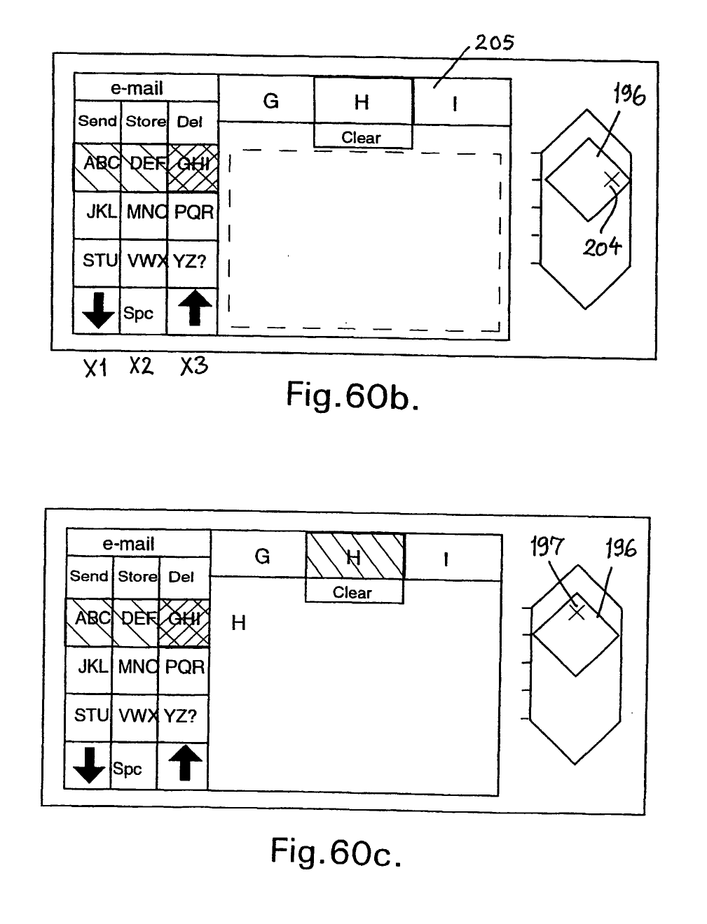

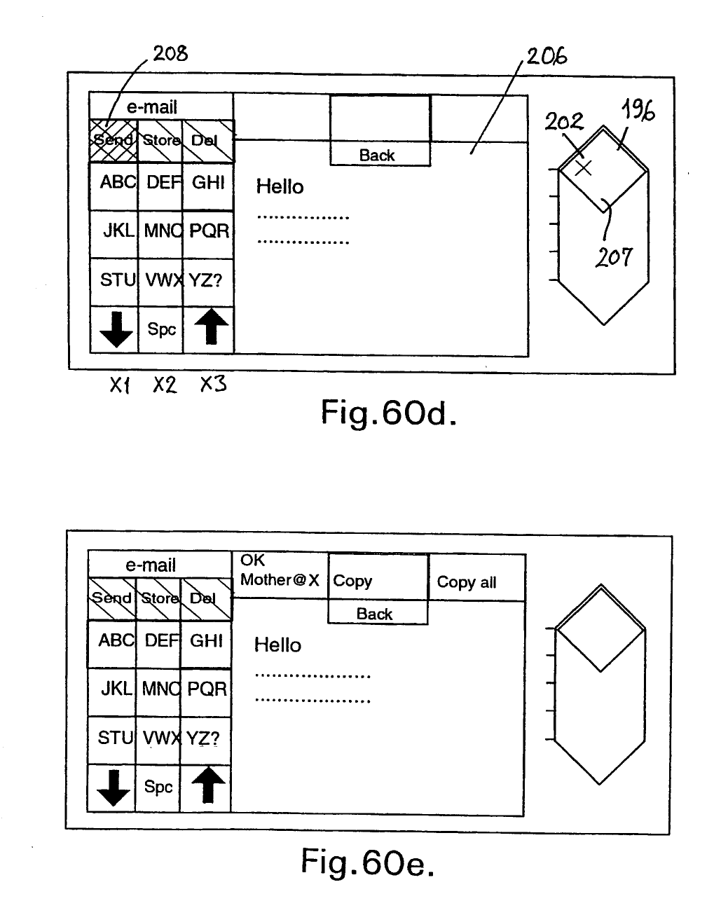

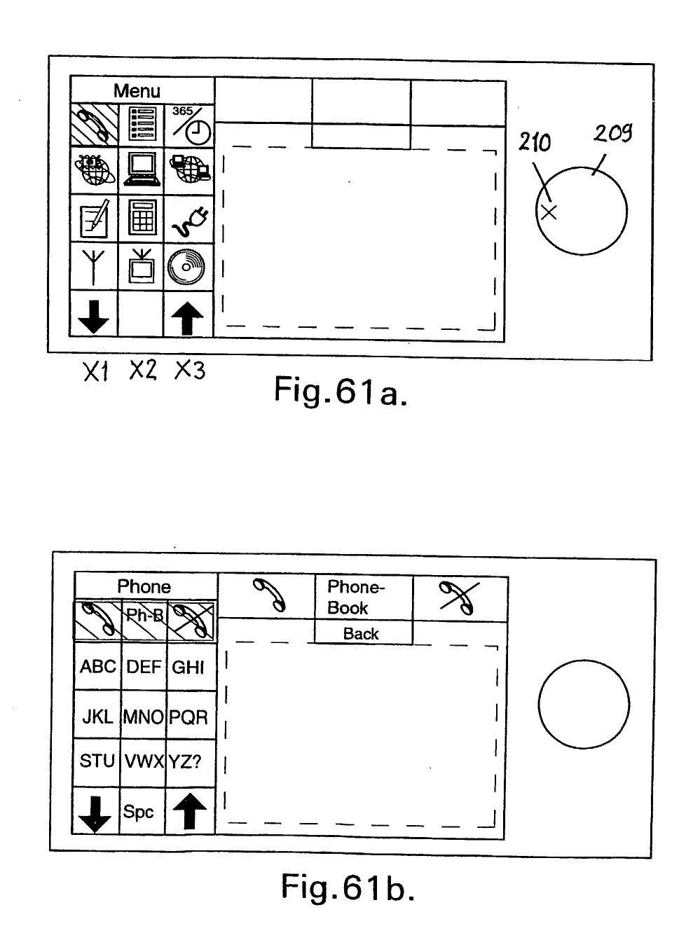

FIGS. 60a-60e show the selection of the e-mail function and the writing of a text message.

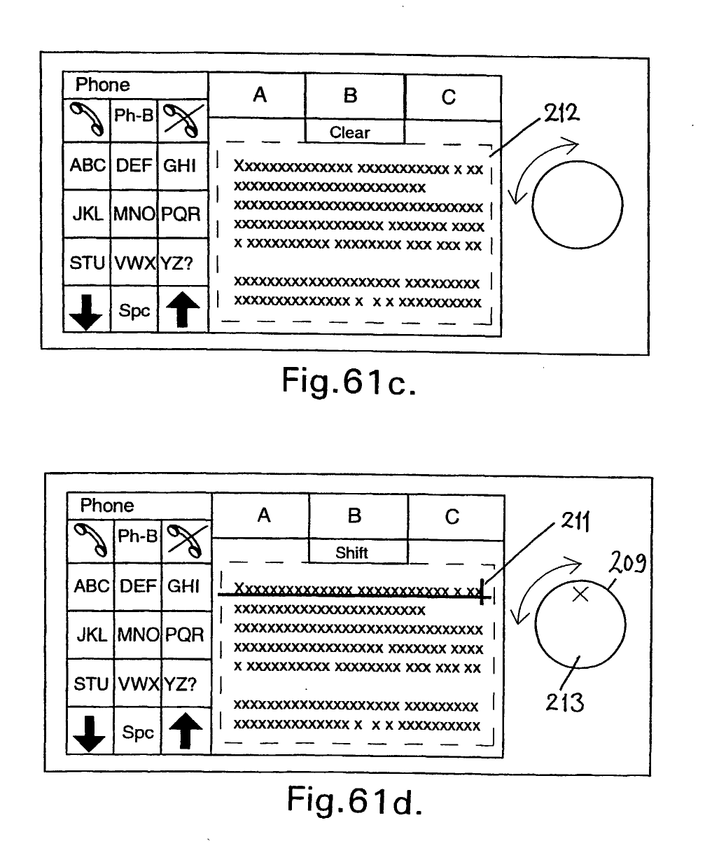

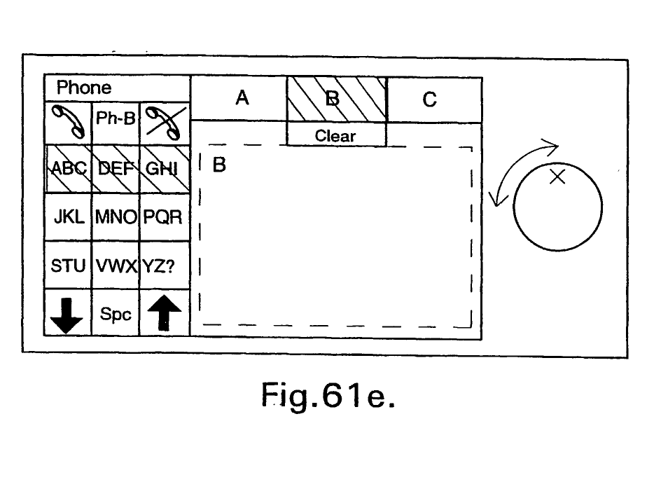

FIGS. 61a-61e show how it is possible to operate a system as shown in FIGS. 58-60, but by using a rotatable switch that has four depression points.

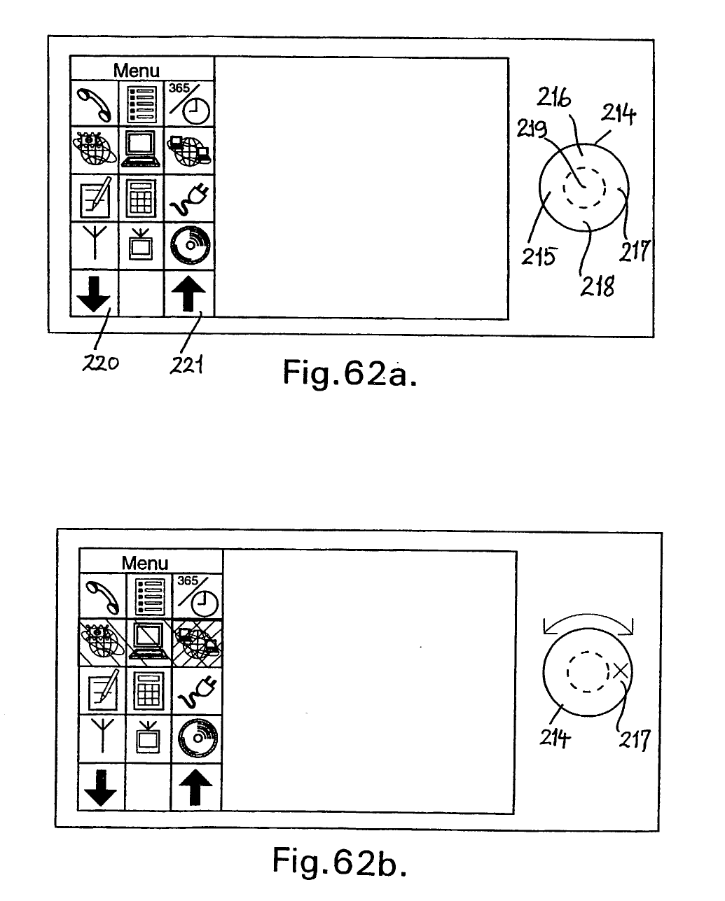

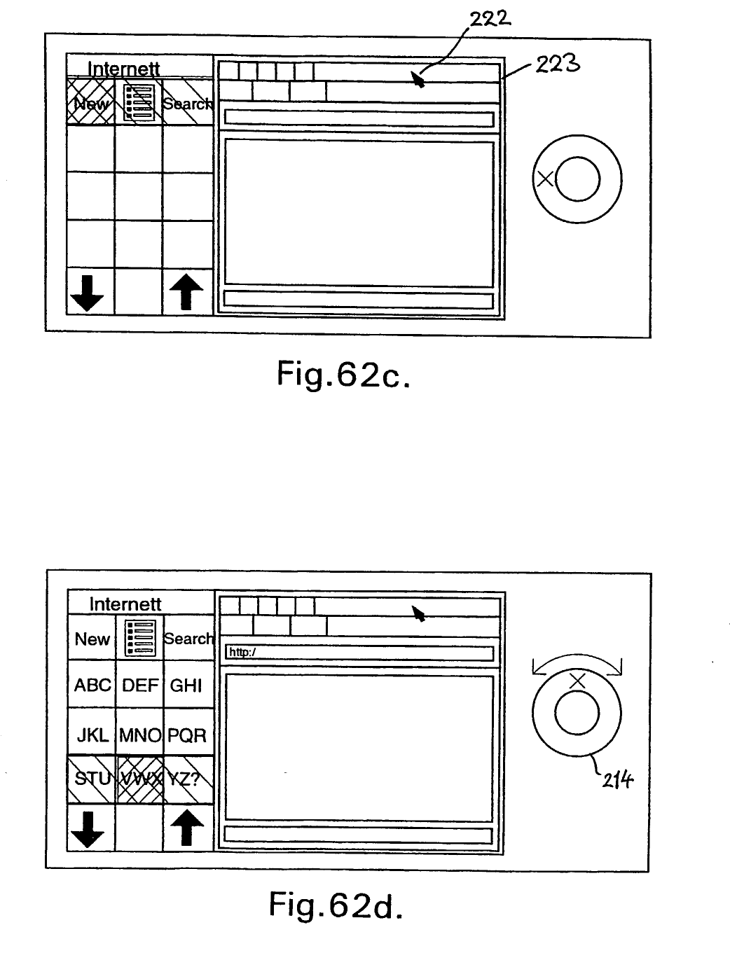

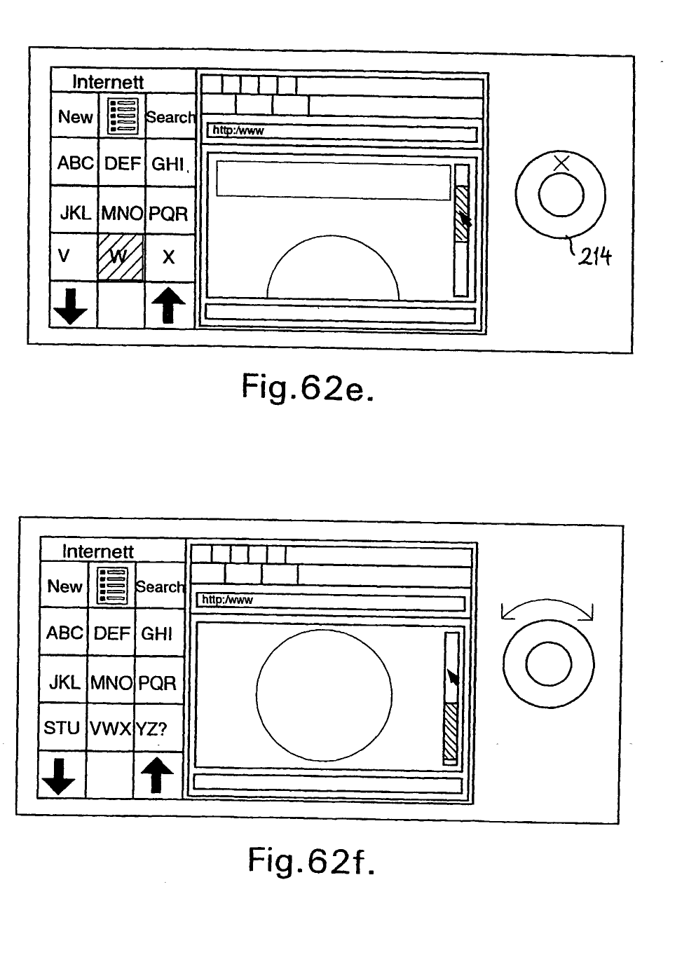

FIGS. 62a-62f show an example of a mini-computer/PDA that has a rotatable switch with four depression points, and a free pointer function switch.

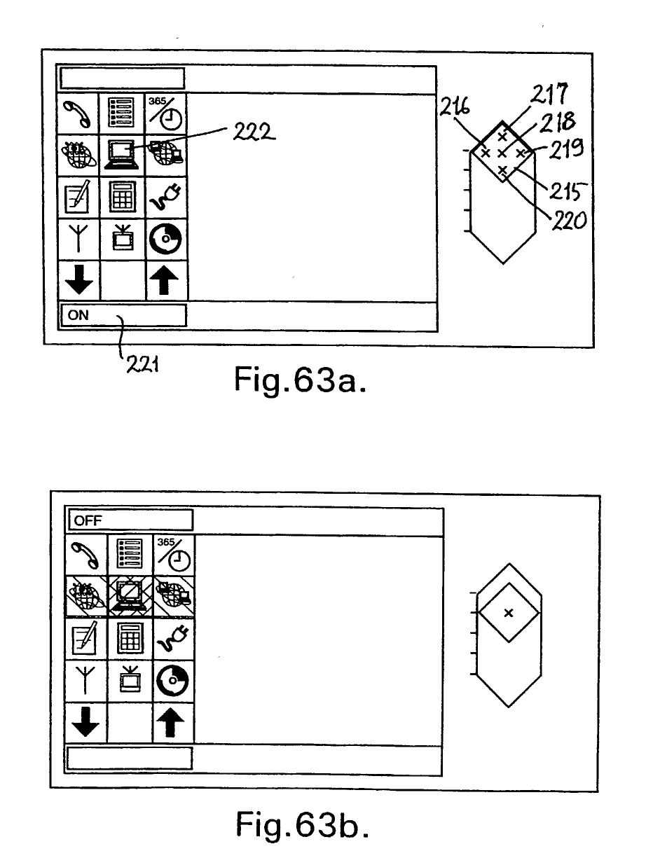

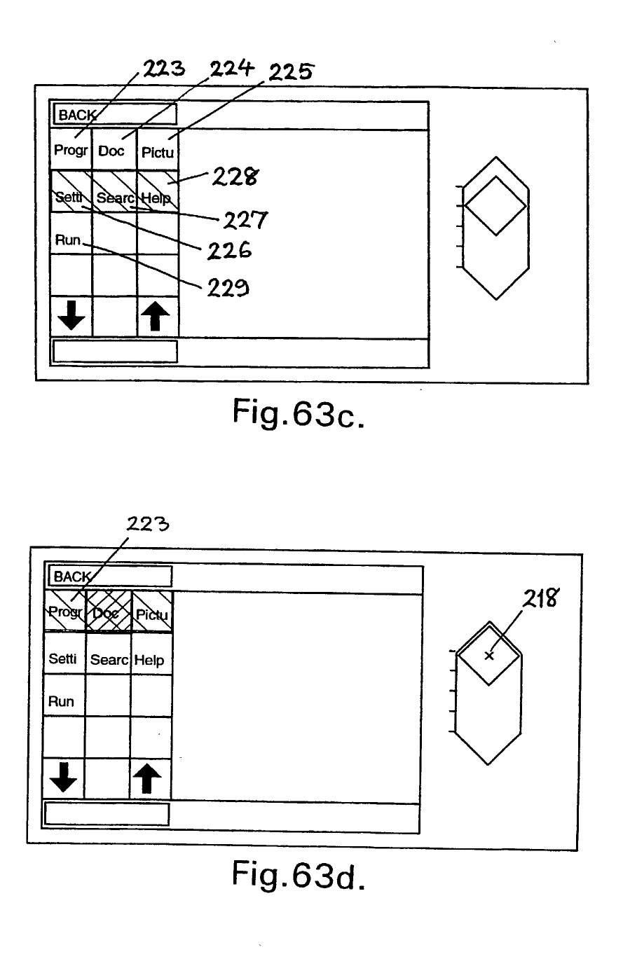

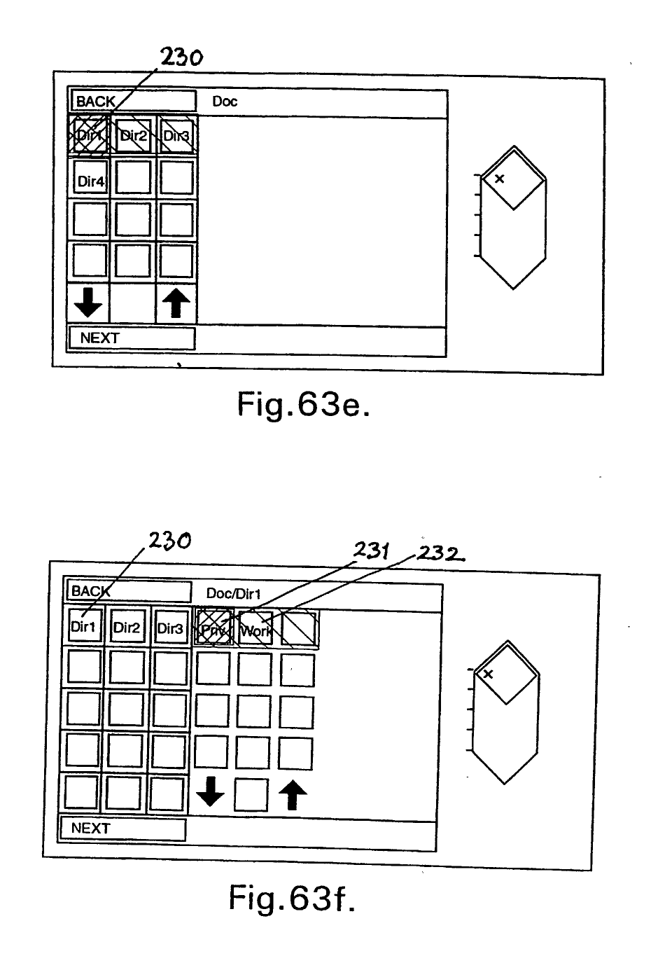

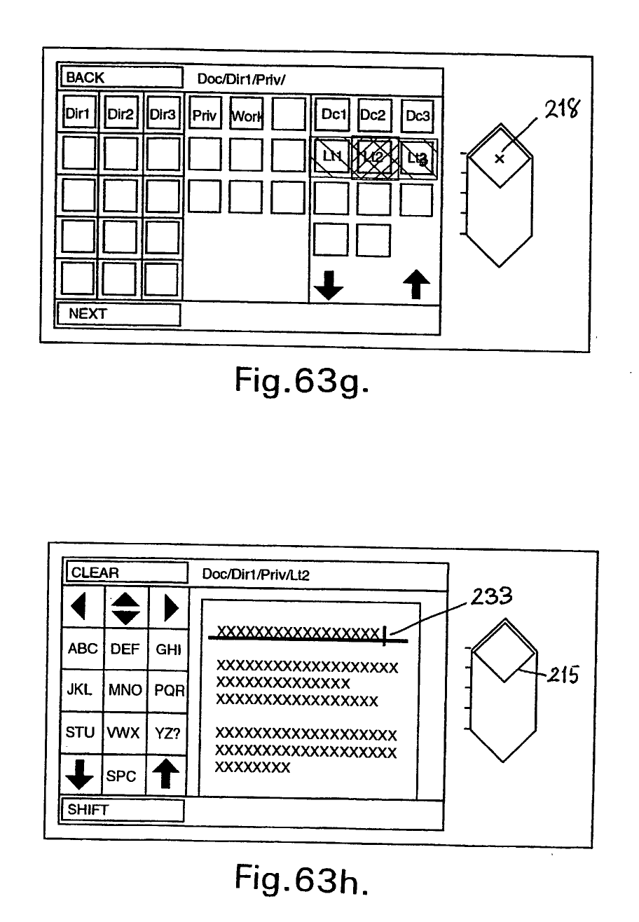

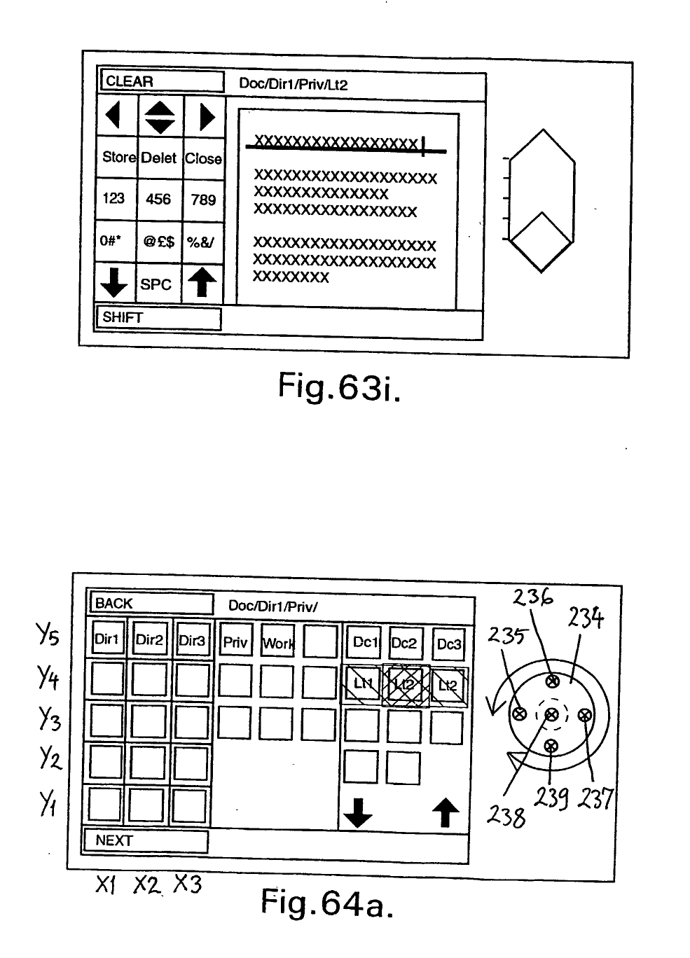

FIGS. 63a-63i show an operating device in the form of a stepwise operating sliding switch that is mounted on a mini-computer, where the switch has five sliding positions and five pressure points, in connection with the retrieval of stored documents and the word processing thereof.

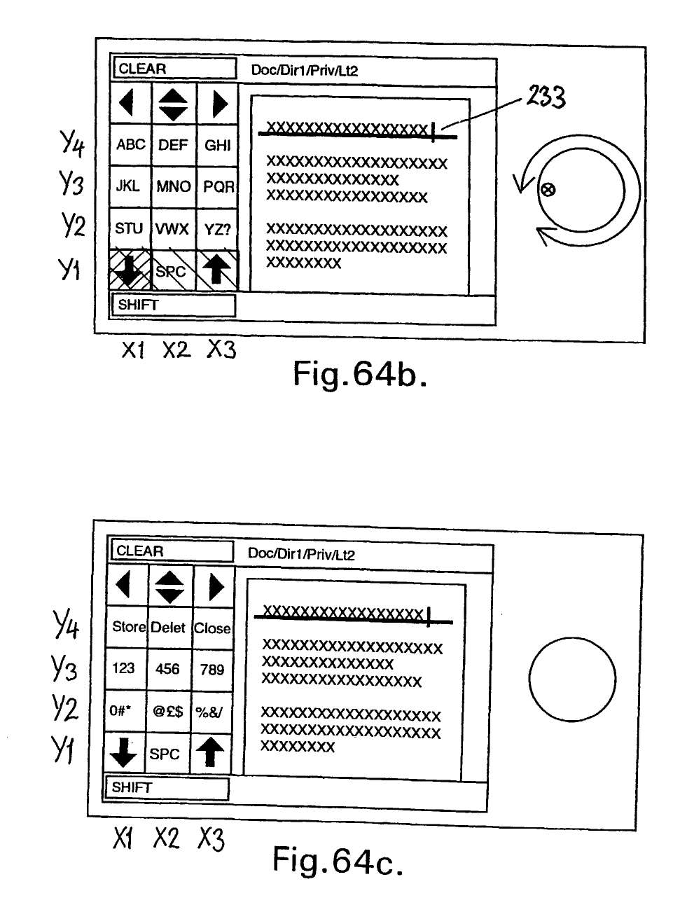

FIGS. 64a-64c show the same as that shown in FIGS. 63 per se, but with the use of a rotatable operating device in the form of a switch having five depression positions.

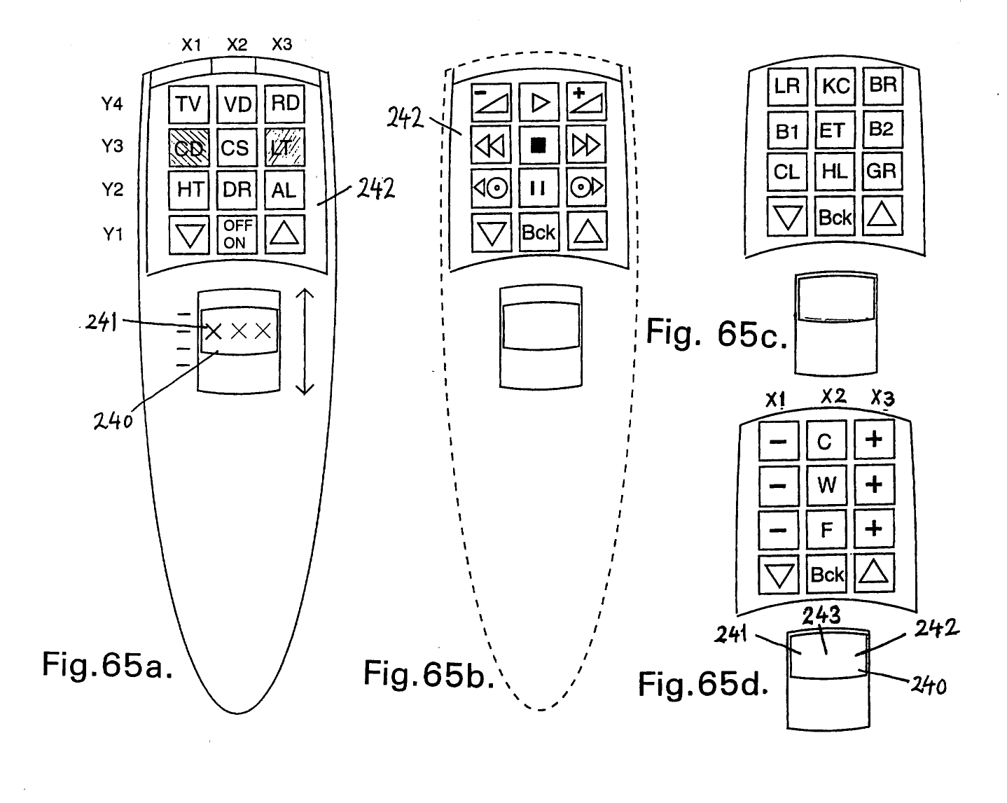

FIGS. 65a-65d show the use of the invention in connection with a remote control device.

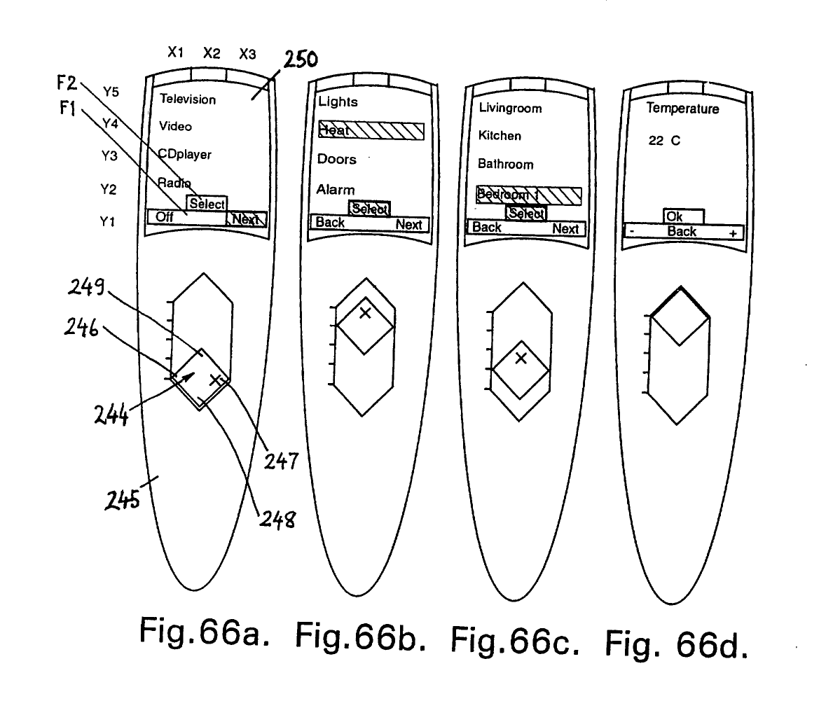

FIGS. 66a-66d show a variant of the embodiment shown in FIGS. 65a-65d.

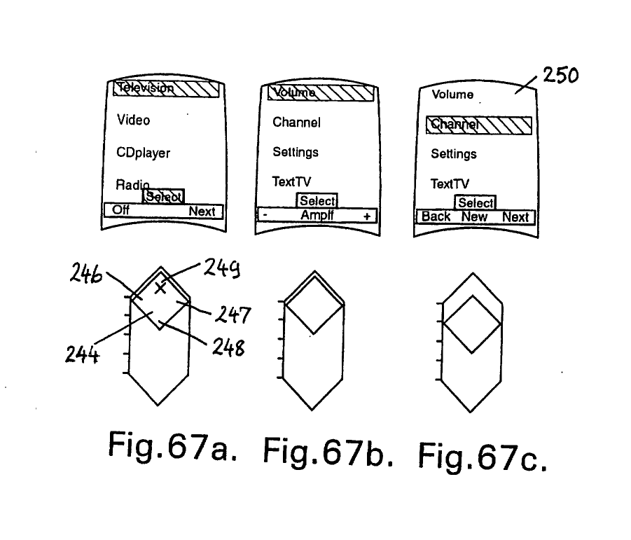

FIGS. 67a-67c show an exemplary embodiment of the device shown in FIG. 66a with an indication of the option of sub-menu selection.

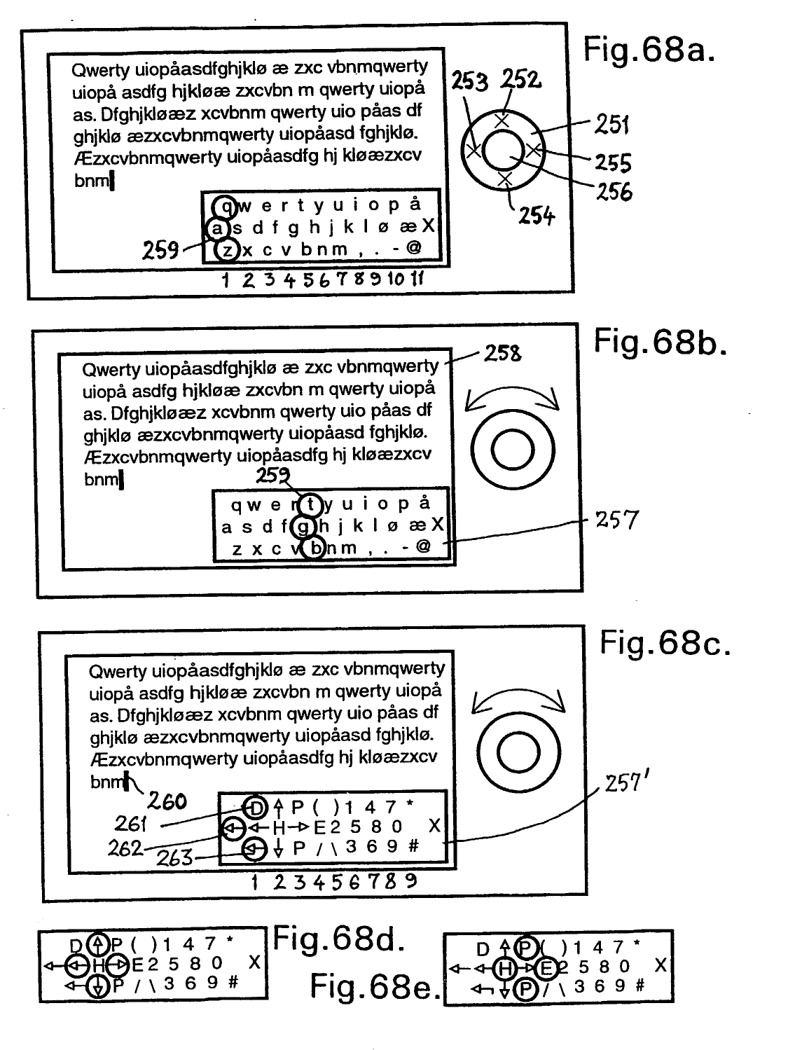

FIGS. 68a-68e show the possibility of manipulating text by using cursor control in a menu field, and use of a rotatable switch having four depression points, and free cursor control in the centre of the switch for mouse control of a text cursor.

The operating devices described in the following description and shown in the drawings and also operating devices of a similar kind are described in detail in, for example, the applicant's International Patent Application PCT/NO99/00373 and Norwegian Patent Applications 19995520, 20000819 and 20003974, and the description and drawings in these applications are included herein by means of this reference, thereby making it unnecessary to further elucidate technical details in the following description and the drawings.

FIG. 1 shows a mobile telephone where the keypad is composed of a total of 19 buttons, of which four, indicated by means of the reference numerals 1, 2, 3 and 4, are navigation switches/arrow keys in connection with the telephone display 5. In a telephone with simple functions, the display 5 can, as shown, optionally be replaced by an array of light-emitting diodes. When turned on, the telephone will normally be in a ringing mode, i.e., ready for the input of a number in order to make a call. To switch to another function, for instance, to read Internet pages, the use of arrow keys, for example, to the right, will take the user into a menu overview, where by further use of an arrow key a desired function can be selected. The system is so constructed that the numbers, letters and functions desired will be presented on the display in, for example, three rows. The number of rows may, however, be increased, but with the proposed keypad design they would have to be increased, if desired, to 3×2-3-4 etc. It is desirable to be able to divide each row into groups of four. This will be most relevant in connection with the keying-in of letters for the input of a text on the display. A more detailed description of this will be given below.

When keying in a number, it is possible to use the ordinary numeric keypad or the arrow keys, the digits being distributed across the display as they appear on the keypad (this solution will be described later where the system is used without a push-button keypad.

As the need for input of text in connection with text messages, e-mail and other Internet services in mobile telephones increases, the use of today's system and keypad will become rather laborious. The system for this keypad solution functions as follows:

As shown in FIG. 1, the display in the text mode will of necessity have to show the whole alphabet split into three columns. Each group of letters is represented under each number key. For example, the user may choose the left-hand column and wish to key in the letter A. In this case, the letter A will be found on the numeric keypad under the number 1. The number key 1 in this case is pressed twice. If the user wishes to key in, e.g., the letter S, he selects the number 3 on the numeric keypad, followed by the number 1. If the user then wishes to enter the letter K, he depresses the number key 2 twice. If the user then wishes to select, e.g., the letter H, he first selects the number 7, and then presses the number key 8. As an alternative to the above, the user may select columns by using the arrow keys. The column the user selects will be highlighted, so that the user will always see which column is activated.

In the solution shown in FIG. 2, the letters may also be assembled in groups of four, distributed in three rows. Here, it is possible to choose whether all the groups should be visible on the display, or whether it is desirable to fetch up three groups at a time. Of course, this depends on the size of the display, here indicated by the reference numeral 5′. This solution will be described in more detail for use with other kinds of keypads, since it is not primarily made for a keypad having many keys.

For navigation in menus and for the Internet (for example, WAP), the four arrow keys will be used for looking through menus and pages on the screen. This is in fact known from today's technology. A large display can be divided into columns and rows in which the user clicks his way forwards, backwards, up and down. Each row is divided into groups that have four sub-functions which the user can easily choose between by using the arrow keys. As the screens are now becoming large and with large resolution, it will be possible to put icons on the screen, as in a personal computer.

As will be appreciated, the method which must be used in connection with the embodiments shown in FIGS. 1 and 2 is cumbersome in practice.

The system according to the invention which will now be described is based on an embodiment of a keypad with a switch that has three or possibly four depression positions, and can also be pushed into, for example, four positions. It will be described below on the basis of a 4×4 position keypad where the keypad or operating device is basically arranged in a 3×4 system, with a fourth additional function for certain tasks, and in this connection reference is made to FIG. 5.

The movement for the sliding positions and the movement up and down on the screen, indicated by the reference numeral 6 in FIG. 3, and the reference numeral 7 in FIG. 4, will be described as the Y-direction, whilst the side positions and movement to the sides of the screen will be described as movement in the X-direction. In the quite mode, the display screen 6, as shown in FIG. 3, will show all numbers in a pattern known from an ordinary push-button keyboard. This mode will also be the ringing mode for the mobile telephone. In this mode, the selection of numbers is controlled by the movement of the control element or the key 8, shown in FIG. 5 in the four Y-positions, Y₁, Y₂, Y₃ and Y₄, and movement of the control element or the key 8 in the X-direction, i.e., in depression position 9, 10, 11 and 12. As an example, in order to dial the eight-digit number 22988890, the following movements of the control element 8 can be made. The control element 8 is moved to the position Y₄ (in FIG. 5 the control element 8 is shown in position Y₃), and the key 9 is depressed with a repetition, which gives the number 22. Subsequently, the control element 8 is moved down to position Y₂ where the control element 8 is pressed at the marking 10, which gives the composite number 229. The control element is then depressed twice at the marking 9, which gives the composite number 22988. Subsequently, the control element 8 is depressed at 10 which gives the composite number 2298889. Next, the control element 8 is moved into position Y₁, whereupon depression of the control element at the marking 9 will give the complete desired number 22988890 Depression of the control element 8 the marking 11 will result in the call being initiated, i.e., the mobile telephone initiates an ordinary dialling function.

The solution shown in FIG. 4 can be used to explain a write mode related to, for example, a mobile telephone. The control mode can be defined as a function selected from a menu that requires the input of a text, for example, telephone book, text message, e-mail, the input of an Internet address etc. In the write mode, the whole of or part of the alphabet will be shown on the display 7. Of course, this will depend on both the size and resolution that the display 7 can provide. According to a proposed embodiment, the alphabet will be divided into three rows having groups each consisting of four letters. For example, to write the word “Her”, the following functions must be performed, and here reference is also made to a control element as indicated in FIG. 5. First, the control element 8 is depressed at the marking 11 to select the middle group in the selected Y-direction. Here, the control element 8 is in the position Y4X2. The user is now in a mode where the markings 9, 10, 11 and 12 represent F, G, H and E respectively. The control element 8 is depressed at the position or marking 11, which gives the letter H. After this, the system returns automatically to the first step. Next, to select E, the marking 11 is pressed first to select the middle group, and then the marking 12 to select the letter E, and HE will become visible on the display. After this, the system again returns automatically to the first step. Movement of the control element to position Y₃ and depression of the marking 11 will result in the position Y3X2 being selected. Selection of the letter R is now desired, and this is done by depressing the marking 9, so that HER is now displayed on the screen.

This principle can, of course, be subjected to variations, as it is possible to add extra keys that alone can provide movements on the display screen, whilst the keying-in takes place by the use of the operating device.

Recently, modern mobile telephones have been equipped with a vast amount of functions, and developments suggest that it is desired to implement even more and more functions into mobile telephones. Mobile telephones will then almost be like small computers with programs, files and folders. To be able to find what is wanted from among all this data, the use of an operating device as mentioned above will be suitable in a system where the main groups in the menu are shown on the display 7 at any given time. Under each main function, sub-functions will be divided into a system of groups of four. The menu may conceivably be built up as follows: Each function will be divided into groups of four that can be selected quickly by depressing the control element 8 at the markings 9, 10, 11 or 12 respectively.

In reality, Internet access for mobile telephones will soon be a fact. Having connected to the Internet, the user can browse through the various pages by using the pressing function 12 and 10, as shown in FIG. 5. The pointer function can be controlled by sliding in the Y-direction and movement in the X-direction by pressing or holding the control element down at the markings 12 or 10. The switch between page function and pointer function can be assigned to the marking on the control element 8 that is indicated by the reference numeral 11. However, confirmation should be assigned to the position on the control element indicated by the reference numeral 9.

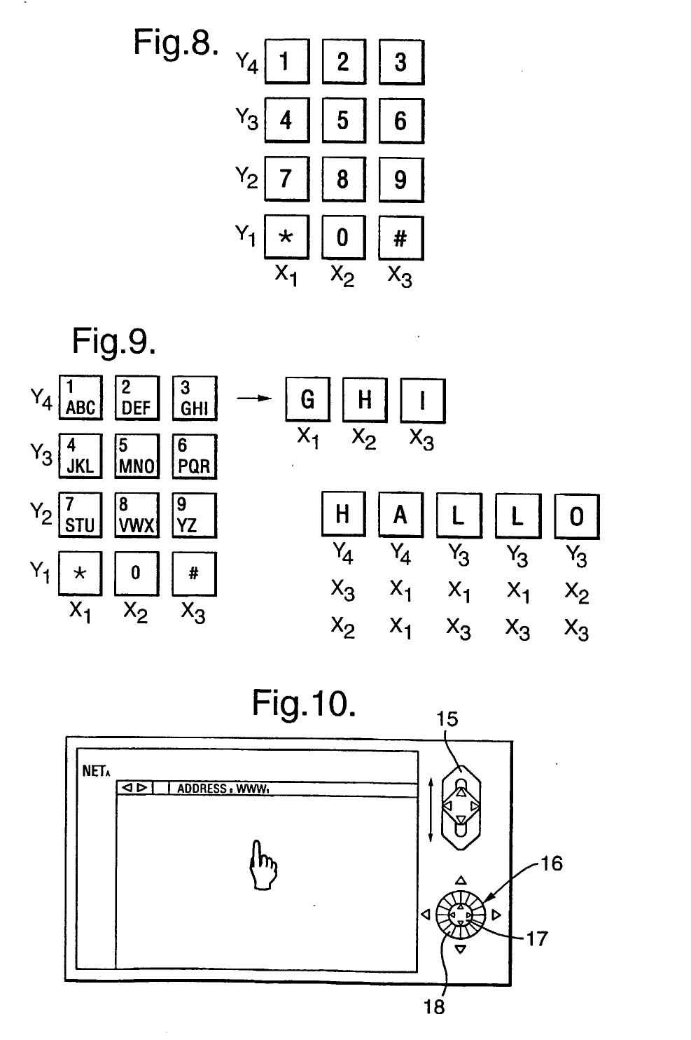

FIGS. 6 and 31 show an operating device 13 having a control element 14 which has been given three X input positions and four Y sliding positions, where the X-positions are indicated by X₁, X₂ and X₃, and the Y-positions are indicated by Y₁, Y₂, Y₃ and Y₄. Connected to this operating device 13 is a light diode array as shown in FIG. 7, where 12 diodes, as shown in FIG. 7, are arranged in a light matrix consisting of three columns and four rows. In each Y-position (sliding position), a marking is made in that all light diodes (in this case 3) will shine faintly. Keying to the right, left or in the middle (X-position) will cause the light diode for the position is question to light up. When using this switch for a mobile telephone, numbers and symbols will be arranged as shown in FIG. 8, and for the keying-in of letters, the alphabet will be arranged as shown in FIG. 9.

When keying in a number, such as 22988894, the control element 14 will be pushed into the uppermost position (Y₄), and the control element is depressed in the centre position which gives a digit 2 for the position X₂, Y₄. The depression is repeated so that the number 22 is generated on the display screen. Next, the control element 14 is moved to the position Y₂ and depression is effected on the right-hand side (X₃, Y₂), so that the number 229 appears. Then the centre portion (X₂, Y₂) of the switch element is depressed, and this depression is carried out twice so that the number 22988 appears first, followed by 229888. Subsequently, the right-hand side of the control element 14 is depressed, which produces the number 9, represented by X₃, Y₂. Then the control element 14 is moved to position Y₃ and depression is effected on the left-hand side of the control element (see X₁, X₃), which gives the digit 4, so that the desired telephone number 22988894 now appears as a result of a long depression at position X₃. A long depression at position X₃, Y₃ will cause the telephone to start to dial chosen number.

In connection with key entry of letters, the system can be opened as shown, for example, in FIG. 9. When a group has been selected, one of three letters is selected by pressing to the right, to the left or on the middle of the control element 14. For example, the word “Hallo” is to be written, since, for example, a text message has been selected. The position Y₄ is selected. The letter group 3 is selected, and the X₃ side of the control element 14 is depressed. The letters G, H, I will then become assigned to X₁, X₂ and X₃ respectively. Depression of the control element 14 for position X₂ will result in the letter H being produced. Then the system returns automatically to “Select letter group”. In this case Y₄ is selected, and then X₁ followed by X₁ again, which gives the letter A, so that HA is now displayed. Next, Y₃ is selected and the control element is depressed at X₁ and then X₃, which gives the letter L, so that HAL now stands on the display. The last operation is repeated so that the letters HALL appear on the display. Then the control element 14 is held down a little longer at position X₃, whereupon the control element is depressed at the X₂ position (centre point) and then at the X₃ position, which gives the additional letter O, so that in the end the word HALLO appears on the screen.

A similar example as now described for FIGS. 9 and 8 respectively in connection with FIGS. 6 and 7 can also be seen from FIGS. 11a, 11b and FIG. 12. It will be seen in these figures that the individual letters or numbers selected may be marked so that it is easier to see which field is referred to or which letter is referred to.

FIG. 10 shows a mobile telephone with two operating devices of different types. These operating devices are indicated by means of the reference numerals 15 and 16 respectively. Operation in connection with an operating device 16 as shown in FIG. 10 will be described in detail in connection with FIGS. 15-18 and 24-26. The operating device 15 can be of the same type per se as that shown in connection with FIG. 5 or 6. The operating device 16 is particularly well suited for functions such as navigation on the display screen, consisting of a central key 17 having four functions, and a rotating wheel or disc 18 which in addition can also be depressed at four positions. The input of numbers, letters and symbols can be carried as described in the above by using the operating device 15.

Navigation in a menu and in the different functions possible in, for example, a mobile telephone will advantageously be effected by the use of the operating device 16, i.e., by the use of the centre key or a first control element 17 and the wheel/disc 18, i.e., a so-called second control element.

The display screen will show the main functions and by using the central key 17 the various functions desired can be selected. The functions will be arranged in a system of groups of four with sub-groups of four, until the user reaches his desired destination. If the user chooses to browse through a list or search up/down/to the right/to the left on the display screen, the rotating wheel 18 can be used.

When using the Internet, a user can by means of a combination of the central key 17 and the wheel 18 navigate a pointer around on the display screen to make his desired choices.

FIG. 12 shows how an operating device as illustrated in FIG. 6 could be used to manoeuvre in a menu.

FIG. 13 shows a display screen 19 in connection with an operating device of the type shown in FIG. 6, and where the control element 14 is shown in its starting position. On depression in the centre of the control element 14, a menu appears as shown in FIG. 13, and at the same time the bottom row is marked. Moving the control element 14 to the position Y₄, as shown in FIG. 13c, will cause the row for Y₄ to be marked. Depression of the control element 14 at the position X₃ will result in the symbol III appearing at the top of the display in the illustrated example, see FIG. 13d. A subsequent movement down to position Y₄ will cause a scrolling of the menu image, as shown in FIG. 13f. The control element can then be moved down to the position for Y₂, as shown in FIG. 13g, where in the illustrated example the numerals XV, XVI and XVII are now marked on the display. Depression of, for example, the control element 14 at position X₃ will result in the symbol for XVII appearing at the top of the display screen 19.

FIG. 14 shows another example for the use of the invention. In FIG. 14a, a menu is selected by a central depression (position X₂) of the control element 14. The menu thus appears, as shown in FIG. 14b, and by a further depression of the control element 14 when it is in position Y₁ and depression in position X, the user will go to the next stage in the menu, as shown in FIG. 14c. On movement of the control element 14 to the position Y₄ and depression thereof at position X₁, a further menu image appears, as shown in FIG. 14d. If this image is not wanted, the user can, for example, in position Y₁ of the control element 14, depress the element at position X₃, which causes a return to the menu image shown in FIG. 14c. On a central depression of the operating device 14 in position Y₁, as shown in FIG. 14e, the menu image will return to the original image, as was shown in FIG. 14a (see FIG. 14f). FIG. 14g shows how the menu image appears after a central depression of the control element 14 in the central position X₂ thereof When the control element is moved to position Y₂, the field 4 in the menu is marked, as indicated in FIG. 14g. In this position, the control element 14 is, for example, depressed at position X₁, which means that the user moves on in the menu as shown in FIG. 14h. By then going to position Y₁ of the control element 14, as shown in FIG. 14i, it is possible to proceed in the menu. The same applies to that shown in connection with FIG. 14j. FIG. 14k shows how the control element 14 is moved to the position Y₄, and where depression of the control element 14 in position X₁ results in the establishment of a connection with, for example, a news page, as shown in FIG. 14l. FIG. 14l also shows that when the control element 14 is moved down into position Y₁ and a central depression of the control element (X₂) is effected, a return is made to the original screen image as shown in FIG. 14a, see FIG. 14m. From -this starting-position, it is possible to move on in the menu, for example, by depressing the control element at position X₁, so that the image in FIG. 14n is established. From that point, it is also possible to go to, for example, a screen image as shown in FIG. 14o.

It will be appreciated that what has been illustrated and described thus far is intended solely as an illustration of the many possibilities of the invention without it thus being understood as in any way defining the limits of the invention.

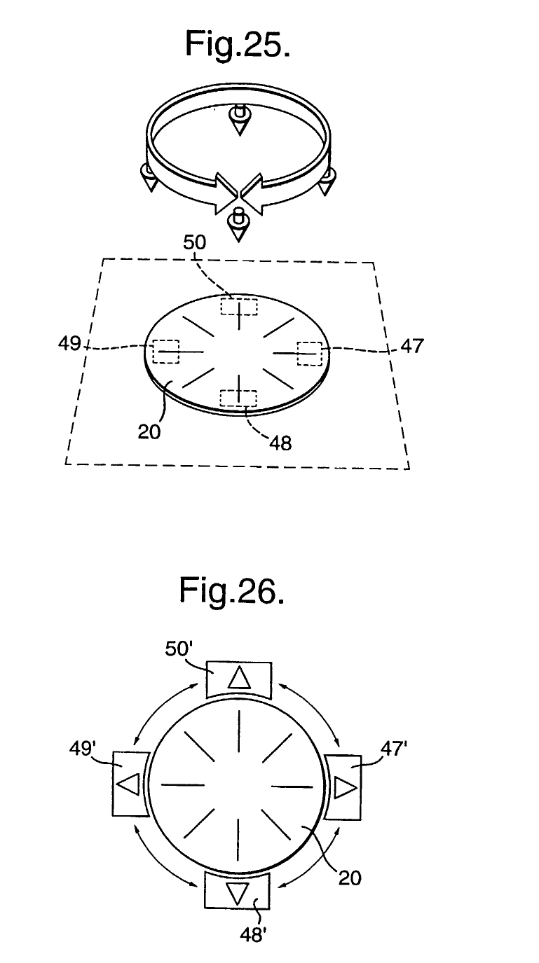

FIGS. 15, 16, 17 and 18 will now be described in more detail in connection with an operating device such as that shown in FIGS. 24 and 25, or 26.

The operating device used in connection with FIGS. 15-18 is based on a control element that is 360°-rotatable, and which at positions, shown in FIGS. 24 and 25 as 3 o'clock, 6 o'clock, 9 o'clock and 12 o'clock, can be depressed to activate switches 47, 48, 49 and 50. The 12 o'clock position will be related to a primary function, as for instance “Clear”. These switches will in turn be able to activate selected functions in a menu. As an alternative, instead of being arranged under the control element 26 at its periphery, the switches 47-50 can be arranged at the periphery of the control element as shown in FIG. 26, and where the switches are indicated by the reference numerals 47′, 48′, 49′ and 59′. That shown and described in connection with FIGS. 15-18 is based on an operating device as illustrated in FIGS. 24 and 25. As shown in FIG. 15, there is a screen image 25. When the control element 20 is rotated, the numbers 1, 2, 3 appear at the bottom. If, for example, the user wishes to dial the telephone number 22988892, he must come to a stop as shown in FIG. 15c and depress the control element 20 twice, so that the switch 48 is activated, and thus causes the number 2 to be selected twice.

Turning the control element 20 further causes another row of numbers 7, 8, 9 to appear, and the control element is now depressed at the switch 47, as shown in FIG. 1 Se, whereby the number 9 appears on the display. Then the control element 20 is depressed at the position shown in FIG. 15, i.e., that the switch 48 is activated, and as a result the digit 8 appears on the display screen 25, as shown in FIG. 15f This depression is repeated twice, as shown in FIGS. 15g and 15h respectively, to produce the digit 8 two more times. Then the control element 20 is depressed at the position shown in FIG. 15i, so that the digit 9 is produced on the screen. This causes the switch 47 to be activated. Then the control element 20 is turned to produce the row of numbers shown in FIG. 15b, whereupon the control element 20 is depressed at the position shown in FIG. 15k. As shown in 15k, the digit 2 will thus appear so that the complete telephone number 22988892 appears on the display 25. The control element 20 is then rotated until the option for “Call”, “Menu” or “Store” appears at the bottom of the display screen 25, as shown in FIG. 15l. If “Call” is desired, the control element 20 is depressed at the position indicated in FIG. 15m (“Call”), i.e., activation of the switch 49, whereby a call is initiated.

35 After the call has been made, as indicated in FIG. 15m, a screen image as shown in FIG. 15n will appear with the option of choosing, with the aid of the control element 20, between + or − volume adjustment during the call, hang-up or back to menu.

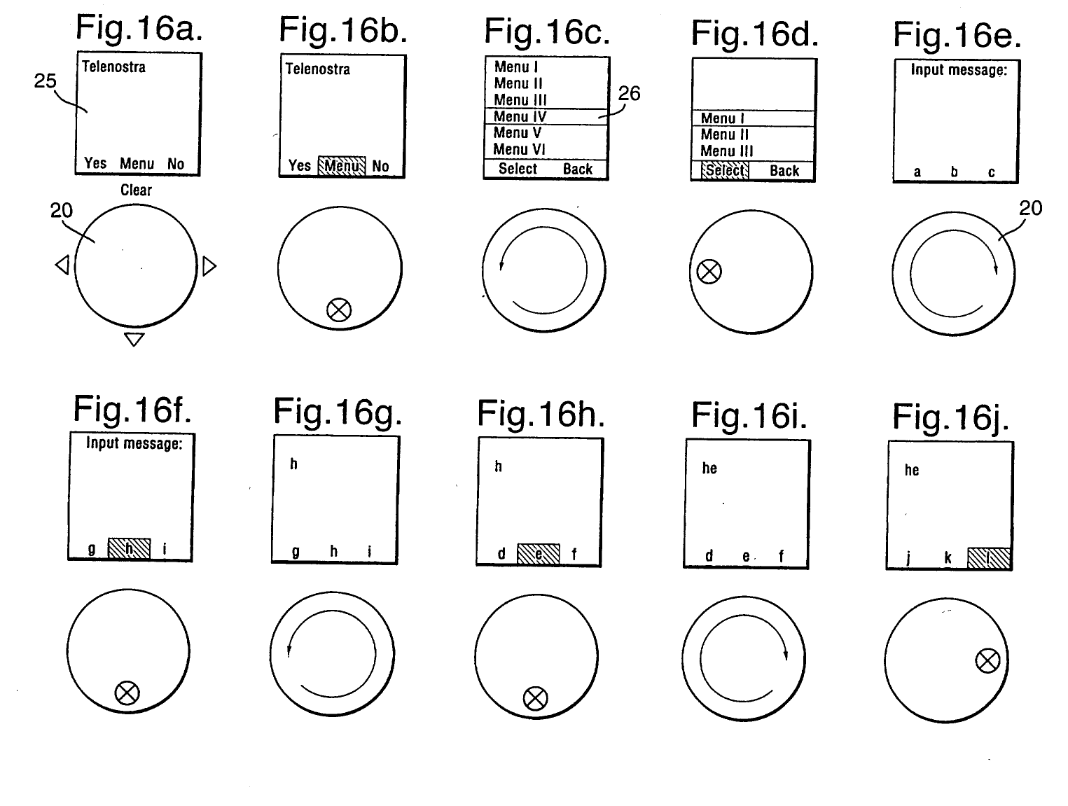

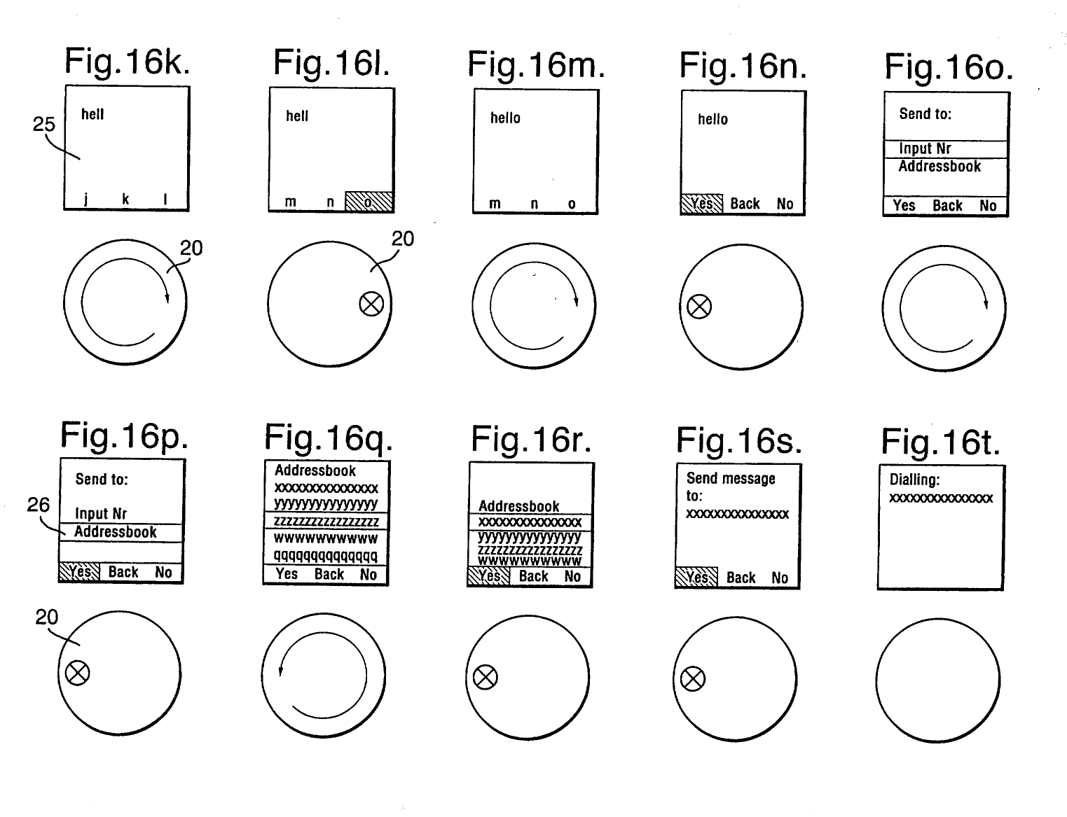

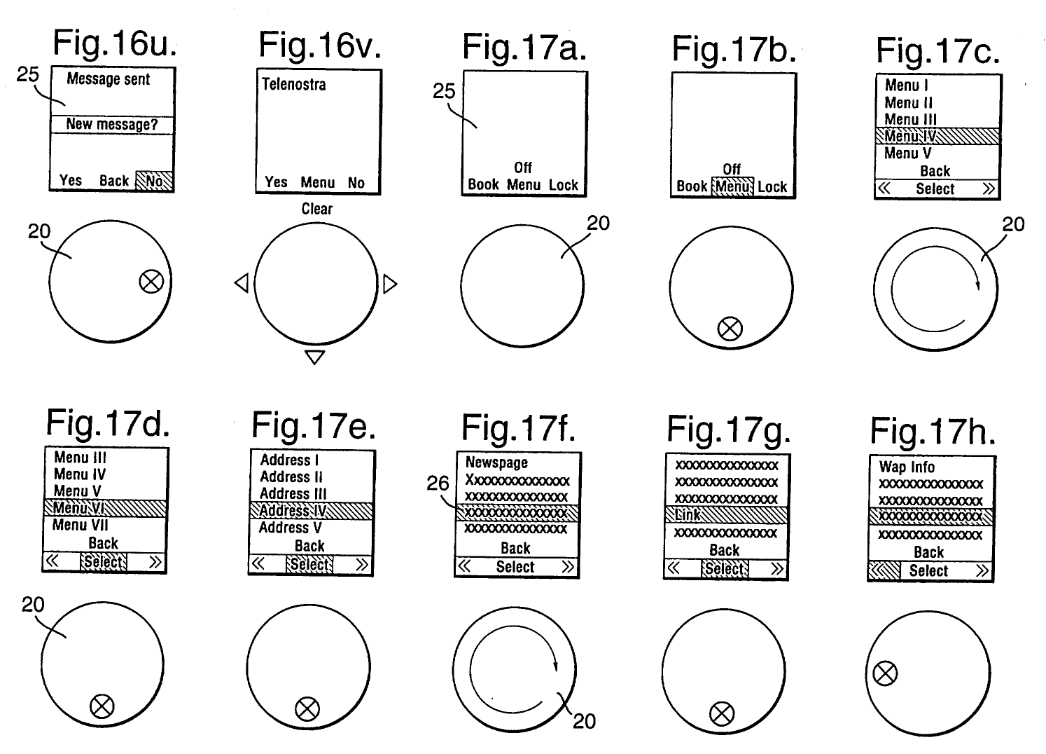

With reference to FIG. 16, there will now follow a brief explanation of how a control element as shown and described in connection with FIGS. 15 and 19, can be used to establish, for example, a text that is to be sent.

FIG. 16a shows a starting position corresponding to that seen in FIG. 15a. Depression of the control element 20 at the position shown in FIG. 16b, i.e., switch 48 with reference to FIG. 19, will cause the menu to be activated. A menu image thus appears as shown in FIG. 16c, and by turning the control element 20, as shown in FIG. 16c, it is possible to allow the cursor 26 to move up or down on the screen 25. Placing the cursor 26, for example, on menu I and depressing the control element as shown in FIG. 16d, i.e., activation of the switch 49, will cause an image, for example like that shown in FIG. 16e, to appear. In the present example, the word “hello” is to be written. This means that it is necessary to move forward in the alphabet in relation to the letters A, B, C, that are shown in FIG. 16e. This is done by rotating the control element 20 as indicated in FIG. 16e, until the sequence of letters G, H and I appears, as shown in FIG. 16f. Depression of the control element 20 at the position shown in FIG. 16f will cause the letter h to be marked and appear as selected on the screen 25, as can be seen in FIG. 16g. Then the control element 20 is rotated again, preferably in the opposite direction, to get to the row of letters D, E, F, as shown in FIG. 16h, where the letter e is marked and the control element 20 is depressed at the position shown, whereby switch 48 is activated and the letter e thus appears on the display, as FIG. 16i shows. Then the letter I is to be written twice, which means that the control element must be rotated again to be able to move forward in the alphabet, so that the letters J, K and L appear, as shown in FIG. 16j. In the position shown in FIG. 16j, the control element 20 is depressed twice to activate the switch 47 twice, thus causing the letter I to appear twice on the display, as FIG. 16k indicates. Then the control element 20 is rotated again a short step so that the row of letters M, N and O appear, and the control element 20 is depressed at the position shown in FIG. 16l, i.e., activation of switch 47, whereby the letter o appears as the last letter of the desired word, as FIG. 16m shows. If message is to be sent, the control element 20 must be rotated again until the option as shown in FIG. 16a appears at the bottom of the screen. The selection of “Yes” and the depression of the control element 20 at the position for the switch 49 will cause the image shown in FIG. 16o to appear. Here, rotation of the control element 20 will cause either the text or the cursor 26 to move up or down on the screen. As shown in FIG. 16p, a affirmative selection of address book is made by depressing the control element 20 in the position shown, i.e., activation of the switch 49. The address book then appears with several alternative addresses and by turning the control element 20, the cursor can be placed on the desired address, as shown in FIG. 16r. The control element 20 is depressed is this position as shown in FIG. 16r, i.e., activation of the switch 49, which causes the appearance of a question regarding the sending of the message to the addressee (it being assumed that the mobile telephone knows the addressee's telephone number). Selection of the affirmative, i.e., depression of the control element 20 as shown in FIG. 16f (activation of the switch 23), will result in the addressee's telephone number being dialled, as shown in FIG. 16t. After the message has been sent, a message for the user to that effect appears with a question regarding any new message. Three options are given, and in the illustrated example, the user has selected “No” by depressing the control element 20 at the position for the switch 47, whereby the display on the screen 25 returns to that shown in FIG. 15a.

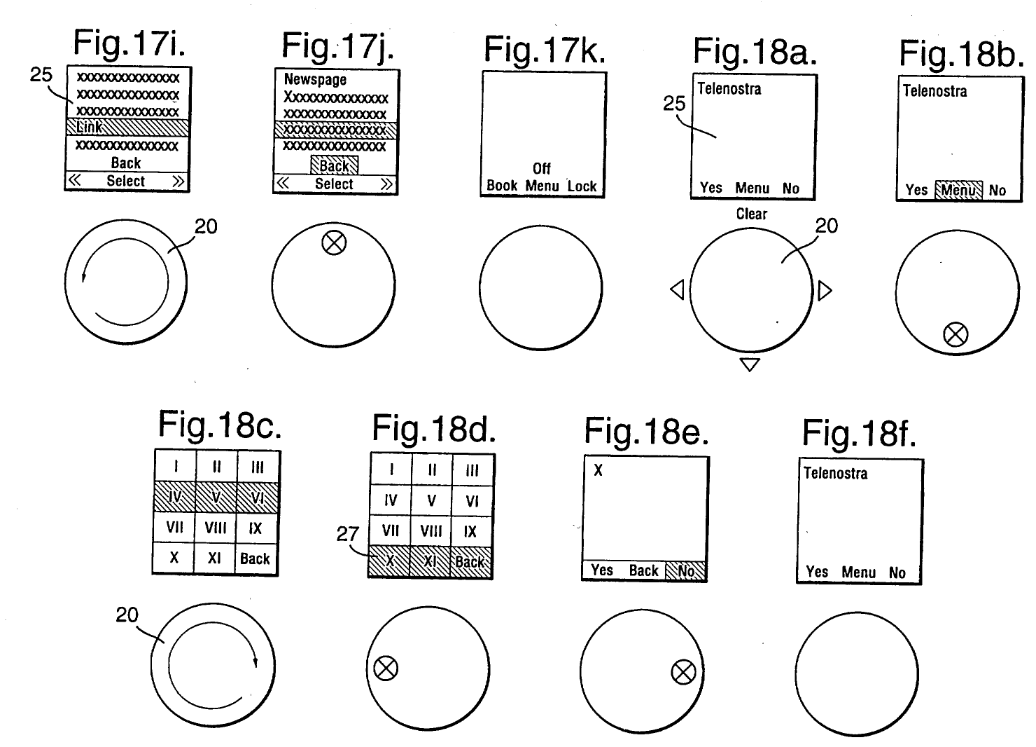

Something similar to that shown and described in connection with FIG. 16 can be seen from FIG. 17. The explanation given in connection with FIGS. 16a and 16b also holds good for FIGS. 17a and 17b. As shown in FIG. 17c, the control element 20 is turned until the cursor lies on, e.g., menu IV. As shown in FIG. 17d, this menu can be selected by depressing the control element as shown in FIG. 17d, i.e., activation of switch 48. A sub-menu as shown in FIG. 17e thus appears, and the cursor will naturally remain at the same place as in FIG. 17d, since the control element 20 has not been rotated further. Further depression of the control element 20 at the position shown in FIG. 17e, i.e., activation of the switch 48, will cause the address IV to be selected, whereby there appears, as shown in FIG. 17f, for example, a news page with options. If the user wishes to select the connection “link”, the control element 20 is turned until the marker 26 lies on this connection. Here, this connection is selected, as shown in FIG. 17g, by depressing the control element 20 as shown, whereby there appears in FIG. 17h a display “WAP info”. If the user does not want this, or wishes to go back to the last screen image, return can be selected, i.e., by depressing the control element 20 at the position shown in FIG. 17h, whereby the user can return to a screen image as shown in FIG. 17g, which is identical with that shown in FIG. 17i. By turning the control element 20, it is possible to browse through the news page, so that the screen image that appears in FIG. 17j will be the same as that shown in FIG. 17f If this is not wanted either, the control element 20 can be depressed at the position shown in FIG. 17j, i.e., “Back” (see FIG. 17a), whereby the screen image shown in FIG. 17a reappears.

In the additional embodiment exemplified in FIG. 18, the menu is selected by depressing the control element 20 at the position that can be seen in FIG. 18b (activation of switch 22). The menu shown in FIG. 18c thus appears. If the user wishes, for example, to select X, the control element 20 must be turned so that the cursor 27 moves down to the row in the menu image in which X appears. Depression of the control element at the position shown in FIG. 18d causes the Roman numeral X to be selected. This Roman numeral can optionally represent an addressee, a telephone number or the like. In the illustrated example, the user has chosen not to go on and has therefore depressed the control element 20 at the position shown in FIG. 18e, whereby the screen image shown in FIG. 18a appears and is like that shown in FIG. 18f.

Although the use of Roman numerals is shown in FIG. 18c by way of example, entirely different symbols or text can of course be used.

Of course, that shown and described above in connection with FIGS. 3-18 and 24, 25 will merely serve to help the understanding of the principles of the invention with regard to a substantially simpler manoeuvring on a display screen than has been possible hitherto by operating a large number of keys, as is commonly known.

In FIG. 26 it is shown how the switches 47′-50′ can be used in connection with a control element 20 instead of switches 47-50 that are under the face of the actual control element 20. However, the mode of operation is the same.

FIG. 27 shows how, as an alternative, there may be a first control element SI and a second control element 52, where the first control element is made non-rotatable, but tiltable to one of four possible positions for associated activation of switches 53, 54, 55, 56. However, to make it possible to browse through a menu, the other control element 52 is provided, which is 360°-rotatable and, like the control element 20, is preferably stepwise rotatable. Detecting of the rotation of the control element 20 may, for example, be done by means of optical reading. The same applies to the control element 52. However, electromechanical devices to detect the rotation of these control elements are also conceivable.

The menu control shown and described in connection with the preceding figures and with particular reference to the type of operating device that can be seen from, for example, FIG. 5, and FIGS. 24-27, will also be carried out with the aid of an operating device as shown schematically in FIG. 28, consisting of a so-called touch pad 57 or a touch screen, for example, in connection with a display screen. A division of the touch pad or touch screen into fields that can be defined as X and Y coordinates will allow movements in the menu to be made easily. The actual technology related to such touch pads or touch screens is known per se and does not need to be described in more detail.

FIG. 19 shows the use of another operating device which has a number of features similar to those of the operating device shown in FIGS. 13 and 14, but which is tiltable in several directions, here shown having four possibilities, at the same time as the control element 28 of the operating device is movable along a path and with a stepwise movement.

FIG. 19a shows by way of example a screen image 29 where there are options for writing an SMS message, e-mail or using the “notepad”.

Depression of the control element as indicated in FIG. 19a effects, for example, the selection of SMS. If, for instance, the letters Ab are to be written, a screen image as shown in FIG. 19b will appear first. A short depression on the marked spot for ABC will cause the letter field for the letters abc as shown in FIG. 19c to appear. The letter A is chosen here by using the control element 28 to effect a long depression (as opposed to a short depression if a were to be chosen instead), whereby the letter A appears on the screen as shown in FIG. 19d. Then the control element 28 is depressed briefly at the marked spot, as shown in FIG. 19d, whereby the letter b appears on the screen. If, for example, a space is required between letters, for instance, when several words are written, the control element 28 can be depressed at the indicated spot, as shown in FIG. 19e (indicated by dotted lines), whereby, also by way of example, a screen image as shown in FIG. 19j will appear with the options of returning to the last image or moving forwards or backwards in the text to make spaces between letters or words. The screen image shown in FIG. 19j also gives the option of sending the message by depressing the control element 28 as indicated in FIG. 19j when the control element has been moved to the bottom position. On depression as shown in FIG. 19j, a question-will appear with regard to the telephone number to which the text message (SMS) should be sent, a screen image as shown in FIG. 19k appearing. The text message as shown in FIG. 19j is Ab, and this will now be described in connection with FIGS. 19f-19i.

It will thus be understood that when only one letter field, e.g., abc, is shown, slight pressure on the marked spot on the control element will produce a lower-case letter, e.g., b, whilst prolonged pressure will produce an upper-case letter, e.g., A, although in the letter field only lower-case letters appear. This is made possible by pre-setting the apparatus in which the invention is used.

In FIG. 19f, on selection there appears a letter field ABC DEF GHI and below an additional field containing numbers and letters. The capacity to show letters in a first transverse field and numbers/characters/“non-current” letters or the like in a second transverse field is made possible by pre-setting in a setting program for the apparatus in which the invention is used. It will be obvious to the skilled person to understand how this can be done and therefore it not described in more detail here.

By pushing the control element against spring action about half a movement step (marked by short dashes), it is possible by repeated movements of this kind to switch between the first and the second field. When the top field (containing letters) is selected in this way, a double letter field for the letters abc and ABC will appear at the indicated spot on the depression of the control element 28. In FIG. 19g the letter A is selected by a long depression as indicated. This letter then appears on the screen 29. Brief pressure on the control element 28 in the indicated direction will cause the cursor, as indicated by the reference numeral 30, come to rest in the field containing the letters abc, as shown in FIG. 19h, and the letter b will be activated. After this, a screen image as shown in FIG. 19i appears.

If the text message Ab is to be sent, the control element 28 can, for example, be moved to a position as shown and explained in connection with FIG. 19j, and depression of the control element can be effected as shown there. As a result, a screen image as shown in FIG. 19k will appear. From there, it is possible to move on, as will be explained in connection with FIG. 20 (from and including FIG. 20b), for example by keying in a telephone number and sending the SMS message to that number.

Alternatively, it is possible to return to a first screen image as shown in FIG. 19l (and in FIG. 20a), and actuate the control element 28 as shown, whereby a menu appears as shown in FIG. 19m. Selection of, for example, a phone book will result in the appearance of an address list/list of subscribers, as shown in FIG. 19n.

Additional aspects of the invention can be seen from FIG. 20. Initially, the screen image may be as shown in FIG. 20a. The display here is indicated by the reference numeral 31, whilst the control element is indicated by the reference numeral 32. However, it will be understood that the operating device of which the control element is an integral part could be identical with the operating device shown in FIG. 19.

In the chosen example, moving the control element 32 closer to the display 31 will cause a screen image as shown in FIG. 20b to appear. If, for example, the user wishes to select the telephone number 22 98 88 92, the operating device 32 is depressed at the position shown in FIG. 20c. It must be depressed twice to generate the number 22 on the display 31. When the number 9 is then to be selected, the control element is moved to a position which in FIG. 20b is marked as 35, whereafter the control element 32 is depressed at the point indicated in FIG. 20e, whereby the number 9 appears on the screen. Next, the control element is depressed three times whilst still in the same position to produce three 8s, as indicated in FIGS. 20f and 20g, whereafter the control element is depressed at the position shown in FIG. 20h to produce the number 9. Then the control element 32 is moved to the position 33 to produce a last digit in the telephone number, i.e., 2, the control element at this position being depressed at the point indicated in FIG. 20i.

Subsequently, the control element 32 is moved to the bottom position or the position 37 where the options of “Call”, “Menu” or “Store” appear. Here, it is possible to press on the control element at the position shown in FIG. 20j to initiate a call. As an alternative, the control element 32 can be depressed at the spot shown in FIG. 20k, whereby cancellation takes place. The last action according to FIG. 20k will cause the main menu to reappear, as shown in FIG. 20l. FIG. 20m shows how the menu can be selected, whereby a screen image appears as shown in FIG. 20n. By allowing the control element to remain in the bottom position, it will be the bottom option of those shown that is marked. If the control element 32 is moved to the top position, it will be the top alternative in the menu that is marked and can be selected. This is shown in FIG. 20o. In FIG. 20p the option to move on in the main menu is selected, whereby there appears an option for accessories, for example, in connection with a mobile telephone. If the control element 32 is depressed at the point shown in FIG. 20q, the screen image shown in FIG. 20r will appear, which will be the same as that shown in FIG. 20o.

In FIG. 21 it is shown how a simple telephone number, for example, 22 98, can easily be produced. A screen image as shown in FIG. 21a will be the starting point. Depression of a control element 38 at the point marked as in FIG. 21b and a repetition of this depression will cause, for example, the number 22 to appear. Subsequently, the control element 38 must be moved two position notches away along a movement path to position 35, whereby the numbers 7, 8 and 9 appear on the screen. Then, the number 9 is selected by pressing on the control element 38 as shown in FIG. 21d. This is followed by a depression of the control element as shown in FIG. 21e. This last operation will cause the whole number 22 98 to appear on the display screen.

Of course, that now shown and described in connection with FIGS. 19-21 is included here to illustrate the versatility of the system according to the present invention. It will also be understood that operating devices other than that shown in these figures could quite easily be used.

Furthermore, it will be understood that by using a single control element as shown, it will be possible, via the display that takes place on the display screen, to carry out all necessary operations without having to resort to indications in connection with buttons on a keypad. This makes the individual operations that have to be carried out easier and faster to carry out than when using a traditional keypad. An additional advantage is, for example, that both lower-case and upper-case letters, as indicated in FIG. 19g, can be displayed and selected, simply by using the control element.

FIG. 22 shows an operating device 40 that is a variant of the operating device shown in FIGS. 19-21. In this case, the control element can consist of two parts 41 and 42, each of which may have three tilting points, so that in actual fact there are six options in connection with a control element of this kind, in addition to the stepwise positions of the control element.

FIG. 23 shows yet another embodiment of the present embodiment wherein a control element 23 is used that is preferably stepwise movable along a path 44. That shown on the screen has a direct relation to that which has otherwise been shown and described in detail in connection with FIGS. 6, 13, 14 and 31. The control element 43 is connected to a switch function that is activated by depression of the control element. This possible depression is indicated by x in FIG. 23a. Along the path of movement 44 of the control element 43 there are push buttons 45 and 46 which are connected to their respective switch functions. As shown in FIG. 23a, depression of the control element 43 will cause a menu to be selected. A screen image as shown in FIG. 23b will thus appear. If it is desirable to move on in the menu, the key 45 can be depressed. A new screen image as shown in FIG. 23c then appears. If the sub-menu 4 is to be selected, the key 45 is depressed again, whereupon the screen image as shown in FIG. 23d appears. If this is not wanted, the key 46 can be depressed, whereby the option “Back” is selected, as indicated in FIG. 23d, so that the menu as shown in FIG. 23c and repeated in FIG. 23e appears. If this is not wanted either, the control element can be maintained in the bottom position and depressed, whereby the image shown in FIG. 23e is cleared via the clear function, whereby the screen image as shown in FIG. 23a will reappear.

The screen in FIG. 23 is indicated in general by the reference numeral 47.

As will be understood, the present invention can be used with many different types of operating devices without the choice of operating device being perceived as defining the limits of the use of the invention. It will also be appreciated that the possible variations that exist in connection with the present invention as regards screen image and options within the screen images can virtually be “programmed” and thus “tailored”, depending on the area of use or the functional equipment in which the invention is to be used.

Some of the operating devices that may conceivably be used in conjunction with the present invention have already been described in connection with FIGS. 24-28. A further possible operating device is shown in FIGS. 29 and 30. The operating device here consists of a first control element 58 and a second control element 59. The first control element 58 is depressible and displaceable relative to a central position thereof, so that in reality it can be used as a control device for a cursor 60. The cursor 60 can, for example, be used to initiate functions connected to icons 61, 62, 63, as shown by way of example in FIG. 30. The second control element 59 is stepwise rotatable through 360° and is depressible at positions 64, 65, 66 and 67 to activate respective switches 68, 69, 70 and 71.

It will be understood that the second control element 59 as shown in FIG. 29 could be used to browse through menu alternatives and optionally to select from the individual menu alternatives by means of depression in connection with positions 64-67 in order to activate respective switches 68-71. Within the various menu alternatives, the first control element can either be used as an ordinary push-button (without the possibility of controlling the cursor), or whilst within other menu alternatives where, for example, icons 61-63 are present, it could be used for cursor control.

FIG. 31 is a perspective view of the operating device that is exemplified in FIGS. 13 and 14. The control element 14 is initially movable as indicated by arrows 72, i.e., depressible centrally and to the sides, and also stepwise movable along a slideway.

FIG. 32 shows an alternative to the operating device shown in FIG. 31. In this figure, there is also a control element, indicated by the reference numeral 73, that has the same possibilities of movement potential, as indicated by the arrow 74, as shown and described in connection with FIGS. 13 and 14. Common to all the control elements that are slidable along a movement path is that the open space in the movement path can successively increasingly or decreasingly be covered by lamellae 75, 76, 77 as exemplified in FIG. 32. Similar use of lamellae will, for example, be relevant with that shown in connection with FIG. 31 and FIGS. 13, 14 and 19-23.

FIGS. 33-41 show yet more embodiments of operating devices that may be suitable for use with the present invention. The use of the operating devices to wander through menus is not described in any detail in connection with these embodiments, as the same or similar wandering in menus as shown and described in connection with FIGS. 13-23 or variants of these could also be carried out using the embodiments shown in FIGS. 33-41.

In general, in the embodiments according to FIGS. 33-41 a display screen is indicated by the reference numeral 78 and may be of any suitable type, for example, like the display screens previously shown and described or variants thereof.

In the embodiment shown in FIG. 33 there is a control element 79 consisting of a first central part 80, plus a second part 81 and a third part 82. The second part 81 and the third part 82 are located on their respective opposite sides of the first part 80. All the parts 80-82 are depressible and are connected to a switch function. The first part is depressible as indicated by the symbol 83 or downwardly tiltable as indicated by the symbols 84 and 85. At its ends that are indicated by the reference numerals 84, 85 and at the central position as indicated by the reference numeral 83, the first part 80 will be capable of actuating a respective switch.

In connection with the variant shown in FIG. 34, the control element is generally indicated by the reference numeral 86. The control element consists of a first part 87, a second part 88, a third part 89, a fourth part 90 and a fifth part 91. The first part 87, the second part 88 and the third part 89 are arranged in succession in a first direction (y-direction) and the fourth part 90, the second part 88 and the fifth part 91 are arranged in succession transverse to the first direction (the y-direction), i.e., in the x-direction. In reality, the parts 87, 88 and 89 replace the functions connected to the respective areas 84, 83, 85 on the first part 80 shown in FIG. 33. Control element parts 87-91 are each connected to a switch function for activating, when depressed, a respective switch (not shown) so as to initiate functions in an operation menu.

FIG. 35 shows a control element 92 that consists of a first central part 93, plus a second part 94 and a third part 95 that are located on their respective opposite sides of the first part 93. The parts 93-95 are depressible and connected to a respective switch function. As shown in FIG. 35b, the first part is displaceable forwards and backwards relative to the central position thereof, the central position being shown in FIG. 35a. In this way, the first part will be able to actuate switch functions that become operative when the first part is moved away from its central position, as indicated by the reference numerals 96 and 97.

FIG. 36 shows a control element 98 that consists of a rotatable wheel 99. The wheel is stepwise rotatable and will be connected to a detector 100 to detect the stepwise rotation of the wheel, which can be used, for example, to browse through a menu. As shown in FIG. 36b, the wheel is connected to switch functions, where switches are symbolically indicated by the reference numerals 101, 102 and 103, for detecting respectively sideways tilting of the wheel 99 and depression thereof.

In FIG. 37 the control element is indicated in general by the reference numeral 104. It consists of a rotatable wheel 105, and in connection with the stepwise rotation of the wheel there may be provided a detector, such as the detector 100 to detect rotation. The wheel is preferably centrally depressible to initiate a respective switch function, such as the activation of a switch 103 in connection with the embodiment shown in FIG. 36c. However, in the embodiment shown in FIG. 37 it is proposed that the wheel 105 should not be tiltable sideways, but that the switches 101 and 102 that are shown in FIG. 36b should instead be replaced by switches 106, 107 that are adjacent to respective side faces of the wheel 105.

FIG. 38 shows a control element 108 consisting of a stepwise rotatable roller 109. There is a detector 110 for detecting the stepwise rotation of the cylinder. The roller 109 is centrally depressible and also sideways depressible at its respective axial ends so as to actuate a respective switch 111, 112. On central depression of the roller 109, both switches 111, 112 can be activated.

In the embodiment shown in connection with FIG. 39, the control element is indicated generally by the reference numeral 113. The control element in this figure consists of a stepwise rotatable roller 114 that is connected to a detector similar to the detector 110 for detecting the rotation. The roller is centrally depressible so as to initiate a respective switch function, such as the activation of switches 111, 112 or a single switch (not shown) that detects the central depression of the roller. Adjacent to respective axial ends of the roller 114 there is provided a depressible key 115, 116 that is connected to a respective switch function, symbolised by the switches 115′ and 116′.

FIG. 40 shows a control element 117 consisting of a stepwise movable, continuous belt that runs over rollers 119, 120. The control element 117 has means 121 for detecting the stepwise movement of the belt, and a switch means 122 is provided in connection with the belt for detecting central depression of the belt. As indicated in FIG. 40b, the control element 118 is not only centrally depressible, but also sideways tiltable and in this connection switches 123, 124 can be provided to be activated when the control element 117 is tilted to one side or the other. Of course, it is also conceivable that the control element 117 at its longitudinal, respective ends can be depressible so as to initiate a switch function, exemplified by switches 125, 126 (see FIG. 40c).

In FIG. 41 the control element is indicated by the reference numeral 127 and consists of a stepwise movable, continuous belt 128 that runs over rollers at respective ends thereof, as outlined in connection with FIG. 40c. Here too, the control element has means for detecting the stepwise movement of the belt, as for instance the means 121. Also in this case, the belt part 128 of the control element 127 will be centrally depressible so as to be able to initiate a switch function, as shown and described in connection with FIG. 40. It is of course also conceivable that the belt-shaped part of the control element can be depressible at its longitudinal respective ends, in order to initiate a switch function there, as symbolised by the switches 125, 126 in connection with FIG. 40c. Along respective longitudinal sides of the belt-shaped part there is arranged a depressible key 129, 130 to enable activation of a respective switch 129′, 130′. The switch 129′, 130′ thus in fact replaces the switches 123, 124, described in connection with FIG. 40b.

All the solutions shown and described have one thing in common, namely that the user needs only concern himself with that shown on the display screen to be able to control the operating device. Thus, manipulation of the operating device and the functions activated thereby will at all times be represented on the display. It is thus possible to avoid a large number of function switches, as known from apparatus such as mobile telephones, to be able to enter a text and/or dial a telephone number. All functions and the options permitted by the invention will be shown on the display screen, and marking on the operation panel will therefore be unnecessary. Normally, when the operating device is activated, a display screen will be illuminated, making it possible to operate the operating device in a straightforward and practical manner without having to take into account marking on the switch panel, as is known and where such marking can be difficult to read in poor lighting.

The invention will also be usable in connection with the overriding of a system for displaying on a display panel information that the piece of functional equipment is preprogrammed to interpret as more important than the operations and functions effected by manipulation of the operating device. In this connection, reference can be made to that taught in the applicant's Norwegian Patent Applications Nos. 20000834 and 20003579.

In connection with that shown and described, it is possible in a further development of the invention to incorporate, for example, in connection with letter combinations generated by successive input of letters, a word list, so that in actual fact it is not necessary to key in all the letters to produce, for example, the addressee's name. Several mobile telephone manufacturers have started to use a system known as “T9” supplied by the company Tegic which functions in the same way when texts are entered.

On an ordinary mobile telephone keypad a key usually has groups of three letters. If, for example, the keys def and tuv are pressed, the system will guess at the word “det” for instance. If tuv, def and jkl are chosen, the word “tel”, for example, is guessed. When three keys are pressed, the system thus has 27 possible combinations to guess the right word from. The system merely guesses words with same number of letters as key presses. A weakness of this known system is that assumptions are made when the system does not know the word that is to be keyed in. This means that the user must use the “clear” key to carry on, which will entail a great number of key presses in total.

In one aspect of further development of the present application, letters and characters can be placed in groups of three as before. Each letter is selected by using the operating device and by depressing it to the left, the right or in the middle, optionally with the use of a device as shown in FIGS. 24, 25, 26, 27 or 28, or optionally with a device according to FIGS. 29-32. It is proposed, according to the invention, to make the system in such a way that when words that are not already in the word list are entered, they are stored and assigned a priority number. All the words in the word list will be capable of being assigned priority/points in relation to how many times the word is used. The system will begin to guess at words as the letters are entered. If the system makes a wrong guess, the user simply continues to key in the word. A space will confirm the word so that it can also be stored.

For example, the words TELENOSTRA, TELENOR and TELEFON are found in the word list. The user starts to key in TEL. The system will in this case guess the whole word TELENOSTRA if that word has most points. However, the system will guess TELEFON if the word “telefon” is used most The same would happen if the word TELENOR had most points. To proceed, the user continues to key in TELEN. In this case, the system would guess the right word, namely TELENOSTRA, if this word had more points than the word TELENOR. Otherwise TELENOR would of course have been chosen.

Basically, with a system of this kind it is possible to save many key presses, i.e., in the example above the user simply keys in TEL and gets TELENOSTRA, if this last word is the one most used or has greatest priority or most points for use.

In the known solution in connection with the said system “T9” it is necessary to have a key press for each letter. With a system that guesses at words, the user will thus save considerable time if the system make the right guesses.

The known system “T9” works best with short words, but will have some obvious shortcomings with words it does not know, and also it will not be able to guess at words that have more letters than those entered. A user must thus have used the system extensively without having to resort to the “clear” key. By using the “clear” key each time the system guesses wrong means that the input of text cannot possibly be particularly efficient.

The proposed solution, according to the invention, is based on the words that are used and according to priority guesses words independent of the length of the word. If the system guesses wrong, the user simply continues with the next letter, and the system can, if necessary, guess again. Combined with the use of operating devices, as shown for example in FIGS. 5 and 6 and 19-22 which will be easier to use than a conventional keypad for input of text, the solution proposed here clearly has an advantage over the prior art.

FIG. 42 shows a sliding switch 131 that has five sliding positions Y1, Y2, Y3, Y4 and Y5, and five tilting/pressing positions 132-136. The switch 131 relates to the display 137 which is divided into four horizontal fields F1, F2, F3 and F4. The F4 “clear” function relates to the pressure point 133 and F1 “shift” relates to the pressure point 136, regardless of the Y-position. The pressure points 132, 135 and 134 are related to menu bar/command lines F2 and F3, where 132 activates X2 and 134 activates X3. In FIG. 42b only the menu bar/command line F3 is shown. It will not always be necessary to show both these fields F1 and F2, as it is easy to switch between them during use. This can, however, be made as an option that the user himself can set according to his level of proficiency. Preferably, but not necessarily, the figures will, in the interest of simplicity, generally show both fields.

FIGS. 42c, 42d, 42e and 42f show how the switch buttons or control elements can physically be divided up, but function in relation to a display in the same way as indicated in connection with all figures relating to a switch with five pressure points. In FIG. 42c, the control element is divided into three parts where a first part 138 has a pressure point 138′, where a second part 139 has a pressure point 139′, and where a third part 140 has respective pressure points 140′, 140″ and 140′″. In the embodiment shown in FIG. 42d the control element is divided into a first part 141 and a second part 142. The part 141 has four pressure points 141′, 141″, 141′″ and 141″″. In FIG. 42e, the control element is indicated by the reference numeral 143 and consists of five separate pressure points, 144, 145, 146, 147 and 148. The control element that is shown in FIG. 42f is divided in the same way as shown in FIG. 42c, except that it has a slightly different design as regards appearance. FIG. 43 shows how a menu/display will work or look when another type of switch that is rotatable, like the switch shown and described in connection with earlier FIGS. 15-18, is used. The switch or control element, here indicated by the reference numeral 149, has a total of five depression points 150, 151, 152, 152 and 154. In this case, the rotation of the control element 149 will replace the sliding positions shown in connection with FIG. 42, the rotation providing navigation in the Y-direction with regard to the fields F2 and F3. In FIG. 43b only the field F3 is shown. In FIG. 43c, the control element or switch consists of an outer rotatable part 155 and a fixed, non-rotatable central part 156. This solution is expedient when it is desirable to have a control element or switch that also includes the possibility of free cursor control, a so-called mouse function. This possibility is also provided by allowing the pressure point 142 in FIG. 42d to include a possibility for free cursor control or mouse function. Reference is also made in this connection to that shown and described in connection with FIGS. 29 and 30.

FIG. 44 shows a rotatable switch 157 in addition to two ordinary pressure switches 158, 159 which are also shown in FIGS. 44c and 44d, the switch 157 being not only rotatable but can also be depressed in the centre and can be tilted to the right and the left. The switches 158 and 159 will control the fixed functions F1 and F4.

FIG. 45a shows how a control element of the type shown in FIG. 42a is intended to work in connection with showing functions on a display. By way of example, it may be imagined that a number is to be keyed in order to make a call from a telephone. Here, there may be, for example, two main menus that it is possible to switch between by using F1. The F1 and F4 fields (“shift” and “clear”) will always be accessible, irrespective of the Y-position the user is in. In a solution of this kind, it will, for example, be possible to key in a number like the number 22 98 88 92 by using the same technique per se as that shown and described in connection with FIG. 20. By, for instance, pressing on the control element or the switch 160 at the position 161, it is possible to select a subsequent menu or command line where by selecting pressure point 162 it is possible to initiate the dialling of the number entered. The device illustrated in FIG. 20 operates according to exactly the same principle, the only difference being that the depression points are selected in a slightly different manner. When a connection has been established, the menu bar will change appearance, so that it is, for example, possible to select the adjustment of volume. If the volume is to be adjusted, this can be done whilst the connection is present without having to break it. Furthermore, the said “clear” function can switch to an “on/off” option during a call and connection.

However, FIG. 45a will now be described in more detail in connection with the other FIGS. 45b-45g. A sliding switch 160 has been chosen here, and it can be seen that by pressing on the control element or switch 160 at the pressure point 161, a marked action bar will be altered to enable entry into a menu, and by depressing the centre point 162 a menu selection, for example as shown in FIG. 45c,-is obtained, where it is possible to choose between SMS messages, settings and addresses. FIG. 45d shows how letters can be divided into groups. FIG. 45e indicates how the switch or control element 160 can be moved into the Y-position Y3 where the letters at the end of the alphabet are shown in groups of three. Selection of the group stu by depressing the switch 160 at the pressure point 163, i.e., at X1, will cause the letters to spread out as follows: s1, position X1; t, position X2, u, position X3. By pressing in the associated positions, it will be possible to select the letter required, so that, for example, on depression at the pressure point 163, the letter s is selected. To select upper-case letters, it is necessary to hold the position in a little longer, i.e., a “long” depression, see FIG. 45g.

FIG. 46a shows how it is possible to generate more letters and symbols. In this case, the switch or control element 160 has five Y-positions, i.e., Y1, Y2, Y3, Y4 and Y5. At position Y1, there may, for example, be located a command line for further options, here indicated by X1 for numbers, X2 for symbols and X3 for language. In the illustrated case, symbols are chosen by depression of the switch 160 at pressure point 162. Grouping and splitting of these prior to selection can be effected in a way previously shown. In order to exit the function, the switch must be pressed at the pressure point 161 (“shift”), thereby switching the command line from F3 to F2, which gives options, here shown by a “back” function at position X3, see FIG. 46e, whereby it is possible to return to the main menu or the display as shown as the starting point in connection with FIG. 45a, i.e., that can now be seen in FIG. 46f The initiation of the “back” function is effected by depressing the switch 160 at depression point 164.

FIG. 47 indicates in a block diagram the means which in the main are included in the system according to the invention. Block 264 indicates a display panel (“Display”) that communicates with a microprocessor 265 (μP) The microprocessor 265 has either a one-way or two-way connection to an operating device (MD) 266 which may be of any one of the types referred to in this description and shown in the drawings. An auxiliary unit 267 (AUX) can be connected to the microprocessor 265 and represent, for example, a wireless transmitter or other functional equipment, as discussed in the introductory portion of the description and the preamble of the independent claims.

FIG. 48 shows the system according to the invention in connection with the use of a switch or a control element 149 that rotates and has five depression points 150-154. FIG. 48a shows all these pressure points. The positions will be located at the same fixed points, even when the switch 149 is rotated. In this case, an active command line F3 is shown on the display 165. It will be seen that the display has the same design as that used with the first switch type, i.e., the sliding switch. FIGS. 48b.48k show the keying-in of a telephone number, where in FIG. 8b it will be seen that only the command line F3 taken from FIG. 48b will be the active command line and will be shown. The keying-in, for example, of the telephone number 22 98 88 90 will be effected partly by depression of selected depression points on the switch 149 and partly by the turning of the switch, as indicated in FIGS. 48c and 48f Once keying-in is completed, the user chooses to switch command line, as shown in FIG. 48h. In FIG. 48i, it is shown how new options thus appear on the command line, corresponding to the command line F2 as shown in FIG. 48a. It will also be noted how the function F4 (“clear”) has changed function. This is because in connection with certain functions it will be expedient to have other commands. It will also be seen from FIG. 48j how the menu bar/command line has changed function when the number is connected to the recipient. Here the options “Next”, “Menu” and “Back” are shown. In the envisaged case, “Next” and “Back” can switch between several incoming calls. In this case “Shift” is shown as a function to produce, for example, volume adjustment, as can be seen from FIG. 48k.

FIGS. 49a-49g show the system in connection with the invention when using a switch consisting of a rotatable, depressible and tiltable switch 157, and two separate, depressible switches 158 and 159 as shown and described in connection with FIG. 44. The depressible switches 158 and 159 control the “clear” and “shift” functions respectively, whilst the rolling and tilting switch 157 handles the functions F2 and F3. The switches 158 and 159 will replace the pressure positions 133 and 136 in connection with FIG. 42a and the pressure positions 151 and 154 in connection with the switch design shown in FIG. 43a. The switch 157 will operate with the switch/command fields F2 and F3. By rotating the switch 157, the user will be able to choose from a menu as shown in FIG. 5c or continue looking through a menu or list/row of numbers, letters, symbols and the like in the fields F2 and F3. By pressing the switch 159 it will be possible to switch between the fields F2 and F3. In addition, it will be seen that the presentation on the display 166 is similar to that shown in connection with FIG. 45. FIG. 49g shows the selection of upper-case letters by holding the switch 157 depressed at the point 157′ a little longer, a so-called long “click”.

FIGS. 50a-50n show a rotatable, depressible and tiltable switch 167 that is assisted by means of just one extra switch 168. The switch 168 controls functions such as “clear” and “off”. In the illustrated example, the system according to the invention will not have two main menus, but the user will have to go to a menu bar by rotating the switch 167, see, for example, FIGS. 50a and 50m. In reality, the switches 167 and 168 together have a function like a previously described sliding switch or rotary switch that has four possible points of depression, the switch 167 having a possible point of depression at the centre point 167′, at a first end point 167″ and at a second end point 167′″, in addition to the fourth pressure point represented by the switch 168.

FIGS. 51a-51p show how it is possible to operate individual functions by simply having a rotatable, depressible and tiltable switch 169 which has pressure points indicated by the reference numerals 169′, 169″ and 169′″. The illustrated example indicates the keying-in of a telephone number, in the chosen example, the telephone number 22 98 88 92. The input can be carried out following the same pattern as previously described in connection with the other figures described. Of course, the same also applies to the input of letters. In the illustrated solution only one menu bar/command line has been shown. By rotating the switch 169, the user can rotate to options and confirm selection by pressing the switch at one of the said pressure points 169′, 169″ or 169′″.

The options that are given in the example, but which should in no way be understood as defining the limits of the invention, can be seen in FIG. 51a. The menu shown in this figure is only given as an example to illustrate normal functions in a functional apparatus in which the solution according to the invention may be integrated. By selecting “Menu” the user brings up additional functions which he can choose between by moving a cursor 170, see FIG. 51p, by rotating the switch 169. “On”, “clear” and “off” will be accessible at all times by means of a “long” depression at position X1 (on/yes), X2 (clear) and X3 (off). A “long” depression or “click” is created in that the is signals are controlled via a microprocessor which takes the time of or measures the volume of the impulse. In certain functions, the screen 171 will show options which are only of interest in certain cases, as for instance the adjustment of volume during a conversation, see FIG. 51o. Clearly, it will also be understood that in the systems shown and explained in this document it will also be possible to use existing push-button keypads with only moderate modifications.

FIGS. 52a-52l will serve to illustrate how it is possible to use a keypad that is conventional per se in order to perform the tasks that have been shown to be performable using a sliding switch, a rotary switch or a combination of a rotatable/tiltable/depressible switch and optionally using one or two auxiliary depression switches. FIG. 52 has been included to show the possibility of splitting letter and symbol groups. FIG. 52a shows a system where the primary information is shown on the keys themselves (for example, by silk screen printing). The display shows two lines that reflect two of the options in the Y-direction. DY1 shows options in the Y-direction and DY2 shows the main menu. As can be seen from, for example, FIG. 52e, it is possible to bring up additional options for the switches other than those with which they are marked. FIG. 52j shows further option alternatives that it is possible to fetch by using, for instance arrow keys. Here, the option is shown on the switches themselves, whilst only one of these will be shown on the screen. By means of a mapping system as described in connection with FIGS. 54 and 55, it is quite conceivable that marking on the switches themselves or of a key area will be able to change during use. By going into a menu or another list of options, the user will be able to navigate a cursor across a screen by using arrow keys in a known way.

FIGS. 53a-54o show the input of letters in connection with the facility for setting up a text message. In this case, by pressing the key 1/ABC in FIG. 53, it will be possible to display a splitting of the field DY1. Then, by pressing the key 3/GHI, as shown in FIG. 53f, the user will produce the letter C. Similarly, to produce the letter O, the user will first press on the key 5/MNO and then on the key 6/PQR. Similar operations are carried out as shown in FIGS. 53i, 53j, 53k, 53l. When the user comes to the stage shown in FIG. 53m, the telephone number can be keyed in a shown earlier.

FIG. 54 shows how it is possible to use a system having a keypad which in itself changes characters, numbers, letter or symbols according to what is necessary at any given time in order to make the right entries and initiate the tasks that an apparatus in which the is invention is used is to perform. In the example illustrated in this figure, the apparatus in which the invention is intended to be used has by way of example has a screen 172 of relatively minimal size. Thus, the system in this case will function in that the keypad itself functions in effect as a screen, i.e., it shows options, but not the results thereof This can be done in that each key in the keypad is itself a small screen, or that the whole of the key area has a touch screen. Such touch screens are commonly known art, and it is also known that such touch screens can change appearance, depending on what the screen is to be used for. Another way, of course, would be to use a combination of light and templates which shows numbers/letters/symbols that are relevant at given times. As indicated, an apparatus that uses such a system will not need screen space to show options on the input of data, and will thus manage with a fairly small screen or display 172. The input of numbers and letters shown in FIGS. 54 and 55 is effected in the same way as shown in connection with FIGS. 52 and 53. By making use of the switches that are generally intended to be used and that are described in the present application, it is possible, as already mentioned, to control all or most of the functions that are associated with hand-held electronic apparatus. Although a wide range of other applications are of course possible, in the interest of simplicity the present invention is related in most examples to the control of a mobile telephone. This should in no way be understood as defining the limits of the present invention. Examples will also be given in the description to show how an adapted menu system can make use of sliding and rotary switches to determine the functions of an apparatus, such as a mini-computer or a so-called PDA. Such apparatus has relatively large displays or screens (at least when compared with today's mobile telephones) so that it is possible to show many/all of the positions and functions that are available.

FIGS. 56a-56c and also FIGS. 57a-57c show the control of a system on a mini-PC/PDA (with mobile telephone functions) by using a sliding switch. The sliding switch, here indicated by the reference numeral 173, has five sliding positions and four pressure points, where the pressure points are indicated by the reference numerals 174, 175, 176 and 177. The pressure points 174, 175 and 176 correspond to the coordinates X1, X2 and X3. The pressure point 177 will have a general (global) function. The input of letters, numbers and symbols is effected in the same way as taught earlier, but here it is possible to show several alternatives directly on the screen. The alternatives shown, which are simply indicated here by examples, are telephone 178, contacts 179, diary/planner 180, Internet 181, PC function 182, e-mail 183, connections, optionally wireless, 184, calculators 185, notebook 186, MP3/on-line music 187, TV 188 and radio 189.

FIGS. 58a-58f show how the system according to the invention can function when the user looks through a telephone list whilst in telephone mode. The menu in this case is illustrated by icons that reflect the most common functions in functional equipment of this kind. A frame 190 can be moved down a list of stored telephone numbers. By moving the switch 191 in the Y-direction, the user can, by pressing on the switch 191, choose one of three digits in the X-direction. The switch 191 has pressure positions 192, 193, 194 and 195. The application of pressure at pressure point 195 will cause the function “back” to be activated, i.e., it is possible to return to the screen image as shown in FIG. 58a. By moving the switch down to the position shown in FIG. 58d, the user can continue to browse through the list. FIG. 58f shows how the screen image can change if the user is connected to a telephone number, here shown by the option for adjusting volume.

FIG. 59 shows how its is possible to set up a system where the user has a list of all his contacts. Moving the switch 196 to switch position Y4 and choosing X2 by pressing the switch 196 down at pressure point 197, causes the list of contacts, indicated by the reference numeral 198, to be divided into private X1, indicated by the reference numeral 199, emergency X2, indicated by the reference numeral 200 and business contacts X3, indicated by the reference numeral 201. The depression of the switch 196 at pressure point 202 will result in a list of private contacts appearing on the display, as can be seen in FIG. 59c. In FIG. 59d the switch 196 has been pushed up to the top position, position Y5, and position X1 “wife” is selected by depressing the switch 196 at the pressure point 202. Here, “all” data about that person's work and private situation can be stored and retrieved. In the illustrated example the data are divided into “home”, “work” and “mobile”. In this case “Work” is selected by depressing the switch 196 at pressure point 197, as shown in FIG. 59e. FIG. 59f shows how data under this definition can in turn be divided up. Here, a direct connection, i.e., direct dialling, is chosen by depressing the switch 196 on the pressure point 201. A display image then appears as shown in FIG. 59g. By pressing the switch 196 again at pressure point 202, a telephone connection can be established.

FIGS. 60a-60e show a selected e-mail function, as indicated by reference numeral 203. Here, it will be seen that the switch 196 is in the position Y4, and with depression of the switch 196 on pressure point 204. Letter groups thus appear in the left-hand field, as shown in FIG. 60b. Here, position Y4, X3 is chosen with the aid of the switch 196 which is depressed at pressure point 204 when the switch 196 is in position Y4. The letter group GHI will thus be split up and shown in a right-hand field 205. Pressing on the switch either in pressure point 197, 202 or 204, will cause one of the three letters to be selected. If the letter H is to be selected, the switch 196 must be depressed at pressure point 197, whereby the letter H is generated on the screen. Input of additional letters in the desired text is effected in the same way as described earlier, so that, for example, the word “hello”, and any additional text is set out on the screen 206. It is noted that the “clear” function will always be present at pressure point 207 on the switch 196 during input. As indicated in FIG. 60d, the switch 196 is pushed into position Y5, and X1, i.e., pressure point 202, is selected in order to send a message, the field indicated by reference numeral 208 being marked as indicated. Confirmation of address appears as shown in FIG. 60e and can be selected or corrected. It is also possible to select copy to one or more other recipients.

The system is based on the same principles also when the user looks through documents and when operating various programs. The system can thus to some extent be compared with the applicant's interactive system using a similar switch mounted, for example, on the steering wheel of a car. It will also be appreciated that the system taught and described in connection with a car can be directly transferred to a mini computer, if, for example, two multi-function switches are mounted on the apparatus. The sliding switches that are shown may have more or fewer gliding positions. The same switch can also have so-called “toggle” positions, as described earlier, and this will then be a position that is not fixed. The position can be assigned to one or both ends of the Y axis. It will be expedient to program this position to control, for example, the “shift” command in order to “jump” forward in menus or switch between functions and/or options.

FIG. 61 shows how it is possible to operate a system as shown in preceding FIGS. 58, 59 and 60, whilst here a rotatable switch with four depression points is used. It will be understood that the rotatable function of the switch replaces the sliding function of a sliding switch, and that in some cases it will not be necessary to install arrow functions to move up and down a list. The multifunction switch as shown in FIG. 61a is indicated by the reference numeral 209. Pressing the switch at position 210, i.e., position X1, causes input of a text for a text message to be selected. FIG. 61d shows how it would be possible to move a cursor 211 in a text field 212 with X/Y navigation by rotating the switch 209. Here, it will be seen that a “shift” function has been added. This is at the same point as “clear”, i.e., a pressure point at a position as indicated by the reference numeral 213. By means of, for example, a short depression it is possible to switch between navigation by rotation in a menu field and a writing field. By means of a prolonged depression the “clear” function can be operated in the write mode at the same time as it is possible to return to navigation by rotation in the menu field. Switching between X navigation and Y navigation in the text field can quite simply be effected in that the user alternates between them using short presses.

FIG. 62 shows an example of a mini-computer/PDA with a rotatable switch 214 that has four depression points indicated by the reference numerals 215, 216, 217 and 218. There is also a free pointer function switch 219. The pointer function switch 219 may be mounted in the centre of the switch 214 are be a fixed function of the switch. In this connection reference is made to FIGS. 29 an 30. The menu field shown in FIG. 62a is the same as that shown in FIG. 56a. The menu field also has functions associated with arrows 220, 221 to be able to move to further menu options, or to be able to return to the starting point. FIG. 62b shows that by turning the switch 214, the fields shown in the menu field in the Y-position will successively be highlighted. In the chosen example, Y4 is selected and the switch 214 is pressed down at pressure point 217, i.e., position Y4,X3, whereby Internet is selected.

The pointing function can be made active in connection with the functions where this is expedient, such as the Internet. A pointer, here shown in the form of an arrow 222, will be visible on the screen 223. This can be used on the screen image in question for the function. It will be possible to use the pointer in a known way on + and − icons to enlarge or reduce and thus use the whole screen area for the function. However, this is not shown in any detail in FIG. 62c. The pressure position as indicated by the reference numeral 218 in FIG. 62a will at all times have an overriding function as on/off in addition to the selected function, i.e., “clear” in the write mode, “shift” in the pointing mode where it is desirable to switch between control of the various sections of the screen. FIGS. 62d and 62e show how the use of the switch 214 reflects the input of letters in the system for web addresses. When the page required comes up, the user can by means of the pointer function click on the icon in order to scroll the page up or down to activate the rotation of the switch to control the manoeuvring. Any selection of input of text on the page will result in the system being taken back to a write mode where the input of text is effected in the way already described several times in the present description.

The switch shown in FIGS. 58-60 will also be capable of functioning in a similar way with a centre-implemented pointer function as represented by the reference numeral 219 in FIG. 62a.

FIG. 63 shows a sliding switch mounted on a mini-computer, where the sliding switch in the chosen example has five sliding positions and five pressure points. The sliding switch is indicated by the reference numeral 215 and the pressure points are indicated by the respective reference numerals 216, 217, 218, 219 and 220. The switch system for the switch 215 is based on that shown and described in connection with FIGS. 42, 45 and 46. These figures show a system where there are two global main functions represented by the pressure points 217 and 220. The pressure point 217 will control main functions like “off”, “no”, “clear” and “back”. The pressure point 220 will control functions like “next”, “shift” etc. When an apparatus in which the invention is present is switched off, this function can also act as an on-switch, i.e., as switch “on” indicated by the reference numeral 221. In FIG. 63a it is shown that PC functions as indicated by the reference numeral 222 are selected, related to the switch position Y4X2. FIG. 63b shows an example of a menu of main functions, where the said PC function is marked and thus selected. FIG. 63c shows how the selected PC function can be divided into, for example, programs 223, documents 224, pictures 225, setting 226, search 227, help 228 and run 229. It will be appreciated that these are only examples and should not be understood as exhaustive in connection with that described here. FIG. 63d shows that the switch has been moved to position Y5, and coordinate X2 is selected there, i.e., the position 224 for documents. In this case the switch 215 will be depressed at the pressure point 218.

It should be noted that the pressure point 217 on the switch 215 is now connected to the function “back” which means that the user can simply return to the starting point. The pressure point 220 on the switch 215 is linked to the function “next” which means that it is possible to obtain additional options in the displayed menu, if such exist. FIG. 63e shows a list of directories, and where Dir 1 in the illustrated example is selected. The content of Dir 1, indicated by the reference numeral 230 to which reference is made, discloses folders connected to private 231 and work 232. The folder “Priv” 231 is selected by using the depression point 216 on the switch 215, as shown in FIG. 63f. As shown in FIG. 63g, this results in an additional juxtaposed image on the screen where the documents Dc1, Dc2, Dc3, Lt1, Lt2, Lt3 are shown. In the chosen example the document Lt2 is selected and opened by a central depression of the switch 215 at pressure point 218. During the whole operation the user can by means of the pressure points 217 and 220 on the switch 215 move back and forth between the options “next” and “back”. FIG. 63h shows an opened file which in this case is shown as a character document. In this case, there will be an opened document in the program in question for further word processing. The word processing can be done by manipulating the switch 215, as already shown and described in connection with the various exemplary embodiments.

In connection with FIGS. 63h and 63i, it will now be described how it is possible to use the switch 215 for input of text and editing of a document. As shown in FIG. 63h, positions Y5X1 and Y5X3 will control the X-direction of cursor 233. Position Y5X3 will control the Y-direction of the cursor/line. The direction is changed by pressing on pressure point 220 on the switch. When the cursor is at the desired place, input of letters, numbers, and/or symbols is effected in the described manner by using the switch 215 in one or more of the positions Y2, Y3 and Y4. For additional letters, numbers and/or symbols and possibly functions, the switch is moved to position Y1X1. Spaces in the text are provided by using the position Y1X2. By using combinations of “long” clicks and “short” clicks” it is possible to make double functions for the pressure points 217 and 220. For example, it may be expedient to assign the functions shown in FIGS. 63h and 63i in position Y4 to a “long” click on the pressure point 220. “Long” clicks are made in that the signals are controlled via a microprocessor that takes the time or measures the volume of the impulse.

By integrating a pointer control in the switch, it will be possible to control a pointer and a cursor on the screen. By allowing the pressure point 220 to control a “shift” function, it is possible to switch between allowing the switch to function as a pointer control and as an input means as described above.

FIGS. 64a-64c show rotary switch 234 with five pressure positions 235-239. This rotary switch will function according to the same principles and will also control the menu display according to the same principles as described above in connection with FIG. 63. The rotation function will control navigation in the Y-direction in a similar way as for up and down movement of the sliding switch 215. Many of today's mini-computers/PDAs/multicommunicators (mobile telephones) employ a system involving the use of a touch-sensitive screen, a so-called touch screen. Usually, the screen is accompanied by a “pen” which the user points and writes with directly on the screen. However, this technology requires the use of two hands or somewhere to put the apparatus whilst it is in use. This will not be necessary, however, with the use of the systems that are described in the present patent specification. It will be understood immediately that the touch screen technology can easily be combined with the technical solutions described above.

FIG. 65 shows examples of menus/displays when using a multifunction switch with, for example, four Y-positions and three X options, as can also be seen, for example, from FIGS. 5, 6 and 31. The embodiment shown in FIG. 65 is intended for use in connection with a remote control unit, although this should not be understood as limiting for the present invention. The remote control can in a known way transfer signals via a cable or wirelessly, for example, using infra-red technology or ultrasound or via a radio connection (blue tooth) to the apparatus that is to be controlled. FIG. 65a shows an example of a main menu, but should not be understood as defining the limits of the present invention. However, a main menu of this kind will typically be suitable for a remote control unit for use in the home. In the main menu as shown in FIG. 65a, there are options for television (TV), video (VD), CD player (CD) cassette player (CS), lights (LT) heating (HT), doors (DR) and alarm (AL). Y1X1 and Y1X3 are positions for obtaining additional options in the menu. As shown, Y1X2 will function as an on/off switch in a start.

FIG. 65b shows the selection of CD player (CD) by depressing the multifunction switch 240 at pressure point 241. This represents the position Y3X1. The functions for control of the CD player will then be displayed on the display screen 242 as shown in FIG. 65b. Here, the selection of position Y1X2 (back) will take the user back to the main menu. The system is intended to function so that it is possible to have on and control several functions. If, for example, the user is playing music in the CD mode, he should be able to exit the CD menu in order to operate other functions without the previously started function stopping as a result. In this connection, reference is made to FIGS. 65c and 65d where light (LT, FIG. 65a, position Y3X3) has been selected. FIG. 65c shows the room options such as living room (LR), kitchen (KC), bathroom (BR), bedrooms (B1, B2), entry (ET), cellar (CL), hall (HL) and garage (GR). FIG. 65d shows the actual room selected where X1 causes dimming of the lighting when the switch 240 is pressed down at pressure point 241, whilst X3 on depression at pressure point 242 causes the lighting to be increased. Y2X2, Y3X2 and Y4X2 indicate which lamps in the room are to be controlled. For instance, C can represent ceiling lamps, W can represent wall lamps and F can represent standard or floor lamps. It is, of course, possible to depart from a division of rooms and lamps and equip the remote control with a sensor that registers which room it is in. Another solution would be to equip all lamps with their own receiver, which means that when controlling the lighting the remote control unit must be pointed in a particular direction to be able to control the required light source.

FIG. 66 shows an example of a menu/display for the use of a multifunction switch which has, for example, five Y-positions and three X options. Here too, as in FIG. 65, the multifunction switch, indicated by the reference numeral 244 in this figure, is intended to be used in connection with a remote control unit 245. As described in connection with FIG. 65, a remote control unit can be used to control apparatus and functions wirelessly. FIG. 66 shows an alternative layout of the screen image for the remote control unit. The depression positions 246, 247 and 248 on the switch 244 correspond to field F1 (Y1) on the remote control unit. Pressure point 249 on the switch 244 has a global function such as “Select”, “OK” or “Clear” (in the write mode) etc., which corresponds to field F2 that switches between various main functions. The choice of apparatus or functions to choose between is in reality restricted only by the limitations of the imagination of the skilled person. By selecting, for example, pressure point 247, as in FIG. 66a, it will be possible to move down the menu list by activating the function “Next”. By way of example, “Heat”, which in this case represents the adjustment of heating, is selected in FIG. 66b. Pressing down on the switch 244 at pressure point 249, causes this adjustment of heating to be selected, whereupon a list of the rooms where it may be relevant to adjust the heating appears, as indicated in FIG. 66c. FIG. 66c shows chosen rooms such as living room, kitchen, bathroom, bedroom I etc. Here, it is possible, if so desired, to move on in the menu to fetch more room alternatives. It is also conceivable that the remote control unit itself can find out which room it is in and adapts the choices that will thus be made to that room, as for instance shown in FIG. 66d.

FIG. 67 shows how it is possible to control, for example, a television set by using the system solutions that the invention provides. FIG. 67a shows the selection of television by pushing the switch into position Y5 and choosing “Select” by applying pressure at pressure point 249 on the switch 244. This will give a signal to the television to connect to the active position. At Y5 volume can be controlled by pressing on the switch 244 at pressure point 246 or 247, depending on whether the volume is to be decreased or increased. An additional option of sound can be placed at pressure point 248. The channel selection is shown by the selection of Y4, i.e., the switch 244 is moved down a notch from the position shown in FIG. 67b, i.e., to the position shown in FIG. 67c. Here, it is possible to select channels by continuing to look though the options by depressing either pressure point 246 or pressure point 247, or optionally choosing pressure point 248 to enter a new menu of channel options which will then be shown on the display 250. A program may also be selected for searching for or tuning in new channels. In connection with the function and control of a television, the functions controlled can be shown directly on the television screen, as is often usual today, or the whole screen image from the remote control unit can be shown directly on the television screen.

As mentioned, the remote control unit can effect the control of a large number of apparatus and functions by means of the interplay between switch and display. By using the solution described, it is possible to customise the remote control system as desired. This can be done, for example, by choosing between or combining the switch solutions with menu and display systems that have been disclosed and illustrated previously and which must be considered the most expedient. In connection with the invention, it should also be pointed out that all the apparatus that can be controlled by means of the various switch and menu combinations will also be able to have a function that allows the user to program the positions at which the various functions are to be located. For instance, in a remote control unit it would be possible to make a personal priority list of main functions. As an example, a person for whom it is not natural to have TV as the first option could for instance have radio as first available option. The same could also apply to the positions chosen for + and −, and the field F2. Here, the user will have the opportunity to program the unit according to whether he would like the field F2 to be controlled by pressure point 249 or 248.

FIG. 68a shows an alternative system which makes use of a rotatable switch 251 that has four depression points 252, 253, 254 and 255. There is also a central cursor controller that is freely mounted in the centre of the switch and indicated by the reference numeral 256. In reality, this cursor controller operates like a computer mouse.

FIG. 68b shows the alphabet as laid out on a conventional keyboard, q w e r t y, in a menu field 257 which expediently lies within the actual writing field 258. A cursor field 259 corresponds to the depression positions on the switch 251, i.e., the depression positions 252, 253 and 254. In the illustrated example in FIG. 68a, the letters q, a and z correspond to the depression positions or pressure points 252, 252 and 254. On rotation of the switch 251, the cursor field 259 will be moved to the group of letters it is desirable to use, i.e., in the X-direction. In all positions the application of pressure at pressure point 255 in this mode will function as “space” when writing.

Menu fields can be switched by using a “long” click or depression at the pressure point 255, so that, for example, a new menu 257′ appears, as shown in FIG. 68c. Here, there will be additional options. In position 2, as shown in FIG. 68 it will be possible to navigate the text cursor 260 freely by using all of the four available positions or pressure points 252, 253, 254 and 255. In position 3 it will be possible to browse page by page in the same way (page up/page down/home/end). The cursor field 259 will also have three corresponding options by using the pressure points 252, 253 or 254 on the switch 251. In the end positions, see position 11 for the field 257 in FIG. 68a and similarly position 9 in the field 257 in FIG. 68c, it will be possible by pressing on pressure point 255(X) to close the whole menu field, thereby causing the whole screen to be free.

The design with regard to the menu field should by no means be understood as limiting, as what is important in this connection is that any layout of menu field or the like should at all times be reflected by the options and positions on the multifunction switch used.

The centre button 256 is a pure cursor control device that can be navigated freely across the screen. By touching the centre button the user can move the cursor which may be as shown by the reference numeral 260, or optionally have the appearance of an arrow or another suitable shape. When a selected position has been found, the button 256 can be released and initiate the selection. In FIG. 68c the reference numeral 261 denotes “Delete” and the reference numeral 262 denotes “Back” or “Clear”. The reference numeral 263 indicates, for example, line shift. In FIG. 68d the indicated arrow directions, i.e., to the left, the right, up and down, will be related to respective pressure points 252-255, as shown in FIG. 68, whereby it will be possible to effect navigation of the text cursor. In FIG. 68e, the cursor field has been moved one step to the right from that shown in FIG. 68d, and there will then be four indications H (Home) top P (Page up) and bottom P (Page down). It will thus be understood that the present invention provides enormous potential for fast and simple navigation in a menu image and allows editing to be carried out as required.

1. A system for displaying and assisting manipulative movements when manipulating an operating device for electronic functional equipment, the operating device having control element means being actuatable by a finger of a system user to execute at least three function commands, the system comprising
a display panel,
means for displaying on said display panel a first selection of a plurality of function related items in a column and row format on said display panel with at least three discrete fields in a row or column, said items electable from the group of letters, numbers, symbols, icons, functions, designations, characters or the like,
means for converting a first manipulation of the operating device to initiate a first election of one of said items,
means for converting a second manipulation of the operating device to initiate a second election among at least three optional sub-items provided through said first election of said one item, said sub-items electable from the group of letters, numbers, symbols, icons, functions, designations, characters or the like.
means for making use of the elected function related item or sub-item in or by means of the apparatus;
processor means for coordination of the functions of said means and said display panel, and
said operating device being elected from one of the group of:
a) said control element means being a control element detectably movable stepwise along a path and at individual stepwise positions capable of a tilting movement or depression movement,
b) said control element means being a control element which detectably is stepwise rotatable through an angle selected from an angle region of 360° and capable of selectively activating at least one switch of a minimum of three switches and a maximum of five switches, said switches located under the control element or at predetermined spaced part locations at an edge area of the control element, by depression of the control element centrally or at an edge of its surface at said locations,
c) said control element means comprising a first control element and a second control element that surrounds the first control element, said first control element being non-rotatable and selectively capable of activating a centrally located switch or one of a maximum of five of switches located beneath a peripheral area of the first control element when depressing the control element at predetermined, spaced apart switch locations related to a peripheral area of its surface, and said second control element being capable of a detectably stepwise rotational movement through an angle region of 360°,
d) the control element means being a control element which in a detectable manner is stepwise rotatable 360° as well as movable or tiltable relative to a central position thereof, and depressible at said central position to initiate a switch function, respectively
e) the control element means consisting of a first, central control element, plus second and third control elements provided at respective opposite sides of the first control element, said first control element being displaceable backwards and forwards relative to a central position thereof to initiate a switch function at such position away from the central position, and said first, second and third control elements being depressible to initiate respective switch functions,
f) the control element means consisting of a rotatable wheel with stepwise rotation thereof being detectable, the wheel being centrally depressible and sideways tiltable so as to actuate a respective switch function,
g) the control element means consisting of a rotatable roller with stepwise rotation thereof being detectable, the roller being centrally depressible and tiltable through depression at its respective axial ends, so as to actuate a respective switch function,
h) the control element means has an endless belt that runs over rollers at respective ends thereof and with stepwise movement of the belt being detectable, switch means being operable upon at least one of central depression of the control element means, sideways tilting movement of the control element means and depression at its longitudinal end areas,
i) the control element means has an endless belt that runs over rollers at respective ends thereof and with stepwise movement of the belt being detectable, the control element means beings centrally depressible to initiate a switch function, and the respective longitudinal sides of the control element having therealong a depressible key for activating a respective switch function,
j) the control element means consisting of a first control element in the form of a key that is depressible for initiating a switch function and stepwise movable along a path, and second and third control elements extending along adjacent respective sides of the key path and each being depressible for initiating a switch function, and
k) the control element means consisting of a first, central control element linearly or rotatably movable in a detectable, stepwise fashion, plus second and third control elements provided at respective axial ends or along opposite longitudinal sides of the first control element, said first control element being tiltable or depressible to actuate a respective switch function in a tilted position, in addition to actuating a switch function when depressed at a central position thereof, and said second and third control element parts being depressible to initiate a respective switch function.

2. A system as disclosed in claim 1, wherein the stepwise movement of the control element means is related to a number of available steps in a column, and wherein a tilting movement, depression movement or axial displacement of the control element means is related to electable row items or sub-items at each column step.

3. A system as disclosed in claim 1, wherein the stepwise movement of the control element means is related to a number of available steps in a row, and wherein a tilting movement, depression movement or axial displacement of the control element means is related to electable column items or sub-items at each row step.

4. A system as disclosed in claim 1, wherein the elected control element means is of type c) and has its second control element arranged to activate at least one of a plurality of switches located beneath the second control element by depressing the second control element.

5. A system as disclosed in claim 1, wherein the elected control element means is of type f) or g), and wherein along at least one axially directed side of said means there is provided a depressible key that is arranged to initiate a respective switch function related to the rotational position of said control element means.

6. A system for displaying and assisting manipulative movements when manipulating an operating device for electronic functional equipment, the operating device having control element means being actuatable by a finger of a system user to execute at least three function commands, the system comprising
a display panel,
means for displaying on said display panel a first selection of a plurality of function related items in a column and row format on said display panel with at least three discrete fields in a row or column, said items electable from the group of letters, numbers, symbols, icons, functions, designations, characters or the like,
means for converting a first manipulation of the operating device to initiate a first election of one of said items,
means for converting a second manipulation of the operating device to initiate a second election among at least three optional sub-items provided through said first election of said one item, said sub-items electable from the group of letters, numbers, symbols, icons, functions, designations, characters or the like,
means for making use of the elected function related item or sub-item in or by means of the apparatus;
processor means for coordination of the functions of said means and said display panel, and
said operating device being elected from one of the group of:
a) the control element means having a non-rotatable control element displaceable relative to a central position thereof so as to control a cursor on the display panel for movement of the cursor to one of said discrete fields, said control element being depressible to initiate a switch function,
b) the control element means having a first non-rotatable control element and a second 360° stepwise rotatable control element surrounding the first control element, the first control element being displaceable from a central position thereof so as to control a cursor on the display panel for movement of the cursor to one of said discrete fields, and the second control element being depressible at a plurality of switch positions for selectively activating a respective switch function thereat, and

7. A system for displaying and assisting manipulative movements when manipulating an operating device for electronic functional equipment, the operating device having control element means being actuatable by a finger of a system user to execute at least three function commands, the system comprising
a display panel,
means for displaying on said display panel a first selection of a plurality of function related items in a column and row format on said display panel with at least three discrete fields in a row or column, said items electable from the group of letters, numbers, symbols, icons, functions, designations, characters or the like,
means for converting a first manipulation of the operating device to initiate a first election of one of said items,
means for converting a second manipulation of the operating device to initiate a second election among at least three optional sub-items provided through said first election of said one item, said sub-items electable from the group of letters, numbers, symbols, icons, functions, designations, characters or the like,
means for making use of the elected function related item or sub-item in or by means of the apparatus;
processor means for coordination of the functions of said means and said display panel, and
said operating device being elected from one of the group of:
a) the control element means consisting of a first, central control element, plus second and third control elements provided along opposite longitudinal sides of the first control element, said first control element being depressible at its axial ends to actuate a respective switch function thereat, in addition to actuating a switch function when depressed at a central position thereof, and said second and third control element parts being depressible to initiate a switch function, the elected depression location on the first control element being related to available three fields in a column or a row,
b) the control element means consisting of a first control element part, a second control element part, a third control element part, a fourth control element part and a fifth control element part arranged in a cross-like fashion, said first, second and third control element parts being located along a first axis, and said fourth, second and fifth control element parts being located on a second axis transverse to the first axis and with the second control element part at an intersection of said first and second axes, nd said control element parts each capable of activating a respective switch function when depressed, said first and third control element parts for stepwise movement of a cursor or marker in opposite directions, respectively along said first axis on the display, and said fourth, second and fifth control element parts for electing one of three available items or sub-items located in fields at an elected cursor or marker step,
c) the control element means is a touch screen with a plurality of touch fields, at least some of the touch fields being adapted to selectively display said functional items and sub-items, and
d) the control element means is a touch pad.

8. A system according to claim 1, 6 or 7, wherein
said converting means converts at least a third manipulation of the operating device to initiate an election among a plurality of optional further sub-units provided through said second election of said sub-items.

9. A system according to claim 1, 6 or 7, wherein
said converting means converts at least a further manipulation of the operating device to initiate another election among a plurality of optional further sub-items provided through a previous election of sub-items.

10. A system according to claim 1, 6 or 7, wherein
the system includes means for separately displaying on the display panel elected items and sub-items.

11. A system according to claim 1, 6 or 7, wherein
the items and sub-items are assigned specific coordinate positions on the discrete fields and/or sub-fields showing the minimum three elections that the operating device can initiate.

12. A system as disclosed in claim 8 or 9, wherein
means are provided for returning, after said second or another election, the system to an initial or previous selection or menu for a further first election and successive further elections associated therewith.

13 A system as disclosed in claim 1, 6 or 7, comprising
means for returning the system to an item or sub-item menu associated with a previous selection option.

14. A system as disclosed in claim 1, wherein
the system includes display means for displaying a cursor or marker on the control panel, movement of the cursor controllable by said operating device.

15. A system as disclosed in claim 1, 6, 7, 8 or 9, wherein
the system has means for displaying and executing through manipulation of the operating device a menu operation elected from the group of SHIFT, CLEAR, SELECT, CALL, MENU, SEND, BACK, NEXT, ON, OFF, YES, NO, OK and STORE.

16. A system as disclosed in claim 1, wherein
manipulation of the operating device translates into movement of a cursor on the display panel in order to position it on an item or sub-item to be elected; and
means is provided by which upon positioning of the cursor on an elected item or sub-item, e.g. an icon, initiation of the election thereof is made.

17. A system as disclosed in one of claims 1, 6, 7, 8 or 9, comprising
means for providing, by manipulation of the operating device, related movement in a specific direction on the display panel of successive sets of function related items or sub-items.

18. A system as disclosed in claim 17, wherein means are provided to let items or sub-items have either added thereto at selected positions on the display panel menu-related images or switching availability between items and/or sub-items, the selection of item and/or sub-item being effected by said manipulation in said specific direction, and a maximum of two switch function-related depressions of a control element on the operating device.

19 A system as disclosed in claim 17, wherein
a maximum of two switch function related depressions of a control element on the operating device is required for election of selectable items or sub-items.

20. A system as disclosed in claim 1, 2, 6, 7, 8 or 9, wherein
each item or field is dividable into two or more sub-items or sub-fields

21. A system as disclosed in any one of claims 1-14, wherein
each item or each sub-item displays at least two designations or characters.

22. A system as disclosed in one or more of claims 1-21, wherein
the system is designed to display on the display panel, in addition to said discrete items and/or sub-items, an elected function and any instruction related to such function through use of the operating device

23. A system as disclosed in claim 7, wherein
the control element means of type b) enables through depression of one of the first or third control element parts stepwise control or marking of three fields at a time in a direction related to the first axis, and at a particular step position related to the first axis enables through depression of the fourth, second or fifth control element part election of a respective one of said three fields extending in a direction parallel to the second axis and which field contains a function related item or sub-item.

24. A system according to claim 1, 6 or 7, wherein
the electronic functional equipment is elected from the group of a telephone, a mobile telephone, a remote control unit, a text and/or character transmitter, a calculator, an electronic planner, a portable, hand-held or stationary computer (e.g., PC or mini-PC), a music centre, a camera, game equipment, alarm equipment, admission control equipment, and control equipment.

25. A method for displaying and assisting manipulative movements when manipulating an operating device for electronic functional equipment, the operating device having control element means being actuatable by a finger of a system user to execute at least three function commands, the method comprising the steps of:
a) displaying on a display panel in a first selection of a plurality of function related items in a column and row format with at least three discrete fields in a row or column, said items being electable from the group of letters, numbers, symbols, icons, functions, designations, characters or the like,
b) converting a first manipulation of the operating device to initiate a first election among said items shown on the display panel,
c) converting a second manipulation of the operating device to initiate a second election among at least three optional sub-items provided through said first election of said one item, said sub-items being electable from the group of letters, numbers, symbols, icons, functions, designations, characters or the like,
d) making use of the elected function related item or sub-item in or by means of the functional equipment,
e) said steps b)-d) including coordinating an operation of said control element means and said panel , and
said method further comprising
either
f) to base said operation of said control element means on a stepwise, detectable movement of the element means to move a cursor or marker over or scroll through at least three function related items at a time, and selectively applying a depression or tilting action on the control element means to initiate switch function related to election of an item or sub-item,
or
g) to base said operation of said control element means on displacement of the element means from a central position thereof to cause a movement of a cursor or marker to a field having an item or sub-item to be elected, and electing said item or sub-item,
or
h) to base said operation of said control element means on depression of the element means at specific locations thereof to cause movement of a cursor or marker on the display panel in order to position it on at least three fields at a time, said fields each having a function related item represented by an icon, a designation and/or character that is to be selected, and initiate the selection of such item at one of said at least three fields through depression of the element means at another location thereof.

26. A method as disclosed in claim 25, further comprising
returning the system, after said second election or at least one successive election, to an initial or previous selection of items or sub-items, and repeating step b) and/or steps c) and d).

27. A method as disclosed in claim 25 or 26, further comprising
after completion of step d) returning the system to system options related to step a), b) or c).

28. A method as disclosed in one or more of claims 25-27, wherein
the display on the display panel reproduces the number of depression positions associated with the operating device.

29 A method as disclosed in one or more of claims 25-28, wherein
an item or sub-item is electable through a maximum of two depressions of the operating device.

30. A method as disclosed in any one of claims 25-29, comprising
displaying in each field or sub-field at least two items or sub-items in the form of designations or characters.

31. A method as disclosed in claim 30, wherein
the number of designations or characters in each field or sub-field is related to the number of possible operations of the operating device in a particular position thereof.

32 A method as disclosed in any one of claims 25-32, wherein
on the display panel, in addition to said function, instructions are provided for making an adjustment of a function via the operating device.

33. A method as disclosed in any one of claims 25-32, wherein
on the display panel at least three fields are displayed, at least one of these being divided into at least three sub-fields.

34. A method according to claim 25, wherein
the method further comprises stepwise controlling or marking three fields at a time in a direction related to a first axis, and electing a respective one of said three fields extending in a direction 90° to the first axis to thereby elect a function related item or sub-item contained in said elected field.

35. A method as disclosed in any one of claims 25-34, wherein
the electronic functional equipment is elected from the group of: a telephone, a mobile telephone, a remote control unit, a text and/or character transmitter, a calculator, an electronic planner, a portable, hand-held or stationary computer (e.g., PC or mini-PC), a music centre, a camera, game equipment, alarm equipment, admission control equipment, and control equipment.
